(19) United States
(12) Patent Application Publication
(10) Pub. No.: US 2002/0002474 A1
(43) Pub. Date: Jan. 3, 2002

(54) Systems and methods for selecting and recruiting investigators and subjects for clinical studies

(76) Inventors: Leslie Dennis Michelson, Beverly Hills, CA (US); Leonard Rosenberg, Moorestown, NJ (US); Lance Converse, Blue Bell, PA (US)

Correspondence Address: ARNOLD & PORTER, IP DOCKETING DEPARTMENT; RM 1126(b), 555 12TH STREET, N.W., WASHINGTON, DC, 20004-1206, US

(21) Appl. No.: 09/923,385

(22) Filed: Aug. 8, 2001

Related U.S. Application Data
(63) Continuation of application No. PCT/US01/02936, filed on Jan. 29, 2001.
(60) Provisional application No. 60/178,634, filed on Jan. 28, 2000.

(51) Int. Cl. G06F 17/60

(52) U.S. Cl. 705/3

(57) ABSTRACT

The present invention is directed to an integrated on-line interactive forum that promotes exchange of information among clinical study sponsors, clinical study investigators, and potential clinical study subjects. The forum includes an investigator database that contains information suitable for identification of qualified investigators for clinical studies and a subject database that contains information suitable for identification of eligible subjects for clinical studies. An extranet is coupled to the investigator database and the subject database. The extranet allows sponsors and investigators to exchange securely documents required to start a clinical study. The forum also optionally includes one or more web pages that provide information describing clinical studies to potential clinical study subjects and permit potential clinical study subjects to register for inclusion in the subject database. A therapeutic incidence area database is also optionally integrated into the forum

### CROSS-REFERENCE TO RELATED APPLICATION

The present application claims priority to U.S. provisional application No. 60/178,634, filed Jan. 28, 2000, entitled “Method and System for Creating And Managing Databases for Clinical Trials,” the contents of which are hereby incorporated herein in their entirety by reference

### FIELD OF THE INVENTION

The present invention relates to a novel integrated on-line interactive forum that promotes exchange of information among clinical study sponsors, clinical study investigators, and potential clinical study subjects. In addition, the present invention relates to novel systems and methods for selecting and recruiting subjects and investigators for clinical studies

### BACKGROUND OF THE INVENTION

The increase in the breadth and specificity of research and development for the purposes of identifying and qualifying new drugs and devices for a wide variety of therapeutic areas has resulted in an increase in the specificity and number of subjects and qualified investigators needed by medical and pharmaceutical companies to participate in clinical studies.

Recruitment of a number of clinical study subjects sufficient to establish the safety and efficacy of a drug or device on specific clinical subject populations is essential for the success of clinical study, and therefore for the obtaining of the regulatory approvals necessary for marketing the drug or device on a world wide basis. Recruiting clinical subjects has been complicated by, among other things, the specificity of the new therapies, the increase in the number and breadth of clinical studies required by regulatory authorities, and the globalization of the clinical trial process.

The increased complexity of therapies, primarily the result of advances in the application of biotechnology and combinatorial chemistry, has resulted in increased requirements for additional clinical studies from regulatory agencies. In addition, the requirements of managed care companies for more additional outcome information results in a growing demand for clinical studies. This, in turn, increases the pressure to identify adequate numbers of clinical subjects and qualified clinical investigators. Where traditionally a large number of the clinical studies in a particular therapeutic area were conducted by a small number of clinical investigators, the increase in demand makes it necessary for additional physicians to become trained in the conduct of clinical trials, new means to be developed to recruit subjects, and a broadening of the scope of the search for qualified clinical investigators.

The increased complexity of therapies has been marked by a trend away from the mass treatment mentality of the past, toward treatment of an individual based on the individual's specific characteristics. For example, new therapies are being developed that are specifically designed to interface with an individual's genome. This necessitates the use of clinical subjects that share certain genetic characteristics. This means that the pool of clinical subjects is naturally smaller, and creates a need to draw from a broader base of individuals in order to identify sufficient numbers of eligible participants to complete a clinical study. Handling of the sensitive information identifying an individual's potential genetic propensities implicates certain privacy issues, and add an additional layer of complication to the clinical study recruitment process. Many subjects are concerned that if, for example, they are found to have a particular genetic for certain diseases in the course of a study that they may have difficulty obtaining health coverage.

The result of the foregoing has been an increase in the number of clinical studies, and hence the need to identify qualified investigators and eligible individuals, in geographic locations other than the country wielding regulatory authority. The ability to advance a clinical study simultaneously in many locations, and locating qualified investigators and eligible subjects, increases the likelihood that the clinical study will be completed with minimal delays. Delays are extremely costly to clinical study sponsors because each day a new drug is delayed from reaching the market results in lost revenue and, potentially, lost exclusivity and a later market entry. Delays and the high costs associated with launching a clinical study are some of the biggest obstacles to bringing a new drug to market.

Thus, there exists a need to provide a global means to facilitate the identification and communication between clinical sponsors, clinical investigators and eligible clinical subjects to expedite the process of launching clinical studies in an efficient and cost-effective manner.

### SUMMARY OF THE INVENTION

The present invention is directed to an integrated on-line interactive forum that promotes exchange of information among clinical study sponsors, clinical study investigators, and potential clinical study subjects. The forum includes an investigator database that contains information suitable for identification of qualified investigators for clinical studies sponsored by the sponsors, and a subject database that contains information suitable for identification of eligible subjects for clinical studies sponsored by the sponsors. An extranet is coupled to the investigator database and the subject database. The extranet permits the secure exchange between sponsors and investigators of documents required prior to the start of a clinical study. The forum also optionally includes one or more web pages that provide information describing clinical studies to potential clinical study subjects and permit potential clinical study subjects to register for inclusion in the subject database. A therapeutic incidence area database is also optionally integrated into the forum.

The present invention is also directed to a method for recruiting a person to participate as a subject in a clinical study. One or more web pages are presented that allow the person or a caregiver associated with the person to register with a database by submitting registration and permission information to the database. The registration information includes, for example, a user id, a password, preferred contact information (i.e., an electronic mail address or telephone number), zip code, first name or preferred name, gender, date of birth, whether the person or caregiver is interested in clinical study information, and whether the person or caregiver is interested in new medical therapies. The permission information includes whether the person or caregiver is interested in receiving notice of clinical studies. The person or caregiver is automatically registered with the database upon receipt of the registration and permission information. Next, an automatic determination is made, in accordance with the permission information and the registration information, as to whether to provide the person or caregiver with notice of a given clinical study associated with a disease condition of interest to the person. The person or caregiver is provided notice of the given clinical study only if the system automatically determines that such notice should be sent. A questionnaire associated with the given clinical study may also be provided automatically to the person or caregiver, if the person or caregiver indicates interest in the clinical study in response to the notice. Answers submitted by the person or caregiver to the questionnaire are then stored in the database. The stored questionnaire answers, along with other information stored in the database, may be accessed to determine whether the person should be pre-screened for participation as a subject in a clinical study different from the given clinical study.

In another embodiment, the present invention is directed to a further method for identifying subjects eligible to participate in a clinical study. A computer database that stores information about a plurality of persons is accessed. For each person listed in the database, the database includes a geographic location of the person, an age and a gender of the person, medications taken by the person, and disease conditions of interest to the person. A query is submitted to the database. The query includes criteria that reflect eligibility characteristics for persons suitable for use as subjects in the clinical study. De-identified data records of persons likely to be subjects eligible for the clinical study are selected based on the query. The feasibility of the clinical study may next be evaluated based on the de-identified data records returned from the query. The feasibility of the study can then be further explored by modifying the criteria used to query the database and repeating the above steps using the modified criteria. is. The present invention also includes a method for identifying a qualified investigator to perform a clinical study. At least one computer database that stores a geographic location of each of a plurality of investigators is accessed. The at least one database also stores an incidence or a prevalence of each of a plurality of disease conditions in each of a plurality of different geographic locations. At least one query that includes information representing a selected disease condition associated with the clinical study is submitted to the at least one database. The qualified investigator is identified from the at least one database based on the query and in accordance with the incidence or prevalence of the selected disease condition in the geographic location of or proximate to the qualified investigator.

The present invention includes a further method for identifying a qualified investigator to perform a clinical study. In this further method, at least one computer database stores a geographic location of each of a plurality of investigators is accessed, wherein the database also stores a geographic location of subjects proximate to each of the plurality of investigators. A query that includes information representing a selected disease condition associated with the clinical study is submitted to the at least one database. The qualified investigator is identified from the at least one database based on the query and in accordance with the geographic location of subjects proximate to the qualified investigator. The at least one database also optionally stores an incidence or a prevalence of each of a plurality of disease conditions in each of a plurality of different geographic locations, and the qualified investigator is identified from the database based also on the incidence or prevalence of the selected disease condition in the geographic location of the qualified investigator.

The present invention is directed to a still further method for identifying investigators qualified to perform a clinical study. A computer database that stores information on a plurality of investigators is accessed. A data record is stored for each investigator listed in the database and includes information corresponding to the prescription writing history of the investigator with respect to a plurality of medications. The database also optionally stores information that associates each of the medications with one or more disease conditions. A query that includes information representing a selected disease condition associated with the study is submitted to the database. A given investigator is identified from the database based on the query and in accordance with the given investigator's prescription writing history.

The present invention is directed to a still further method for identifying investigators qualified to perform a clinical study. A computer database that stores information on a plurality of investigators is accessed. A data record is stored for each investigator listed in the database and includes information corresponding to the history of laboratory procedure requests made by the investigator. The database also optionally stores information that associates each of the laboratory procedure requests with one or more disease conditions. A query that includes information representing a selected disease condition associated with the study is submitted to the database. A given investigator is identified from the database based on the query and in accordance with the given investigator's history of laboratory procedure requests.

The present invention is directed to a still further method for identifying investigators qualified to perform a clinical study. A computer database that stores information on a plurality of investigators is accessed. A data record is stored for each investigator listed in the database and includes information corresponding to past participation of the investigator in clinical studies. A query that may include information representing a selected disease condition associated with the study is submitted to the database. A given investigator is identified from the database based on the query and in accordance with the given investigator's past participation in clinical studies.

The present invention is directed to a still further method for identifying investigators qualified to perform a clinical study. A computer database that stores information on a plurality of investigators is accessed. A data record is stored for each investigator listed in the database and includes information corresponding to a medical specialty of the investigator. The database also optionally stores information that associates each medical specialty of an investigator with one or more disease conditions. A query that includes information representing a selected disease condition associated with the study is submitted to the database. A given investigator is identified from the database based on the query and in accordance with the given investigator's medical specialty.

The present invention is directed to a still farther method for identifying investigators qualified to perform a clinical study. A computer database that stores information on a plurality of investigators is accessed. A data record is stored for each investigator listed in the database and includes information corresponding to the experience of the medical staff of the investigator. A query that includes information representing a selected disease condition associated with the study is submitted to the database. A given investigator is identified from the database based on the query and in accordance with the experience of the medical staff of the investigator.

The present invention is directed to a still further method for identifying investigators qualified to perform a clinical study. A computer database that stores information on a plurality of investigators is accessed. A data record is stored for each investigator listed in the database and includes information corresponding to how many clinical studies have been performed by the investigator. A query that includes information representing a selected disease condition associated with the study is submitted to the database. A given investigator is identified from the database based on the query and in accordance with how many clinical studies have been performed by the investigator.

The present invention is directed to a still further method for identifying investigators qualified to perform a clinical study. A computer database that stores information on a plurality of investigators is accessed. A data record is stored for each investigator listed in the database and includes information corresponding to a hospital affiliate of the investigator. A query that includes information representing a selected disease condition associated with the study is submitted to the database. A given investigator is identified from the database based on the query and in accordance with the given investigator's hospital affiliation.

The present invention is directed to a still further method for identifying investigators qualified to perform a clinical study. A computer database that stores information on a plurality of investigators is accessed. A data record is stored for each investigator listed in the database and includes information corresponding to claims data of the investigator. The database also optionally stores information that associates claims data of the investigator with one or more disease conditions. A query that includes information representing a selected disease condition associated with the study is submitted to the database. A given investigator is identified from the database based on the query and in accordance with the given investigator's claims data.

The present invention is directed to a still further method for identifying investigators qualified to perform a clinical study. A computer database that stores information on a plurality of investigators is accessed. A data record is stored for each investigator listed in the database and includes information corresponding to the number of beds in the hospital affiliate of the investigator. A query that includes information representing a selected disease condition associated with the study is submitted to the database. A given investigator is identified from the database based on the query and in accordance with the number of beds in the hospital affiliate of the given investigator.

The present invention is directed to a still further method for identifying investigators qualified to perform a clinical study. A computer database that stores information on a plurality of investigators is accessed. A data record is stored for each investigator listed in the database and includes information corresponding to the insurance provider affiliations of the investigator. A query that includes information representing a selected disease condition associated with the study is submitted to the database. A given investigator is identified from the database based on the query and in accordance with the insurance provider affiliations of the given investigator.

The present invention is directed to a still further method for identifying investigators qualified to perform a clinical study. A computer database that stores information on a plurality of investigators is accessed. A data record is stored for each investigator listed in the database and includes information corresponding to any Institutional Review Board (“IRB”) affiliation of the investigator. The database also optionally stores information that associates each IRB. A query that includes information representing a selected disease condition associated with the study is submitted to the database. A given investigator is identified from the database based on the query and in accordance with the mandated IRB relationships of the given investigator.

The present invention is directed to a still further method for identifying investigators qualified to perform a clinical study. A computer database that stores information on a plurality of investigators is accessed. A data record is stored for each investigator listed in the database and includes information corresponding to FDA or other regulatory agency audits of the investigator. A query that includes information representing a selected disease condition associated with the study is submitted to the database. A given investigator is identified from the database based on the query and in accordance with regulatory agency audits of the investigator.

The present invention is directed to a still further method for identifying investigators qualified to perform a clinical study. A computer database that stores information on a plurality of investigators is accessed. A data record is stored for each investigator listed in the database and includes information corresponding to any Primary Research Facility (“PRF”) affiliation of the investigator. The database also optionally stores information that associates each PRF affiliation. A query that includes information representing a selected disease condition associated with the study is submitted to the database. A given investigator is identified from the database based on the query and in accordance with the PRP affiliations of the given investigator.

The present invention is directed to a still farther method for identifying investigators qualified to perform a clinical study. A computer database that stores information on a plurality of investigators is accessed. A data record is stored for each investigator listed in the database and includes information corresponding to equipment available to the investigator. The database also optionally stores information that associates various pieces of equipment with one or more disease conditions. A query that includes information representing a selected disease condition associated with the study is submitted to the database. A given investigator is identified from the database based on the query and in accordance with the equipment available to the given investigator.

The present invention is directed to a still further method for identifying investigators qualified to perform a clinical study. A computer database that stores information on a plurality of investigators is accessed. A data record is stored for each investigator listed in the database and includes information corresponding to the practice setting of the investigator. A query that includes information representing a selected disease condition associated with the study is submitted to the database. A given investigator is identified from the database based on the query and in accordance with the practice setting of the given investigator.

The present invention is directed to a still further method for identifying investigators qualified to perform a clinical study. A computer database that stores information on a plurality of investigators is accessed. A data record is stored for each investigator listed in the database and includes information corresponding to the investigator's city and state of practice. A further database also optionally stores information that associates the investigator's city and state of practice with one or more disease conditions. A query that includes information representing a selected disease condition associated with the study is submitted to the database. A given investigator is identified from the database based on the query and in accordance with the investigator's city and state of practice.

The present invention is also directed to a method for developing a permission based online database. One or more web pages are presented that allow a person to register with a database by submitting registration and permission information to the database. The registration information includes name information and contact information and the permission information indicates whether the person wishes to receive notice of one or more clinical studies. The person is automatically registered with the database upon receipt of the registration and permission information. Permission is obtained to send the person marketing information about drugs, medical devices or medical therapies. The database is added to by repeating the above steps for a plurality of persons. Next, a list is generated for use in marketing drugs, medical devices and medical therapies to subjects by querying the database using criteria associated with the drugs, medical devices and medical therapies.

The present invention is also directed to a method of maintaining the confidentiality of clinical study information associated with a plurality of clinical study sponsors. Clinical study information is received from a plurality of clinical study sponsors, and stored in a database. Each sponsor is permitted full access in the database to clinical study information submitted by that sponsor. Each sponsor is permitted limited, de-identified aggregated access to information submitted by other sponsors. The clinical study information submitted by each sponsor optionally includes any combination of: investigator information, sponsor identification, protocol information, drug indication information, drug class information, clinical study enrollment goal information, actual clinical study enrollment information, and information on the number of clinically evaluable subjects.

### BRIEF DESCRIPTION OF THE DRAWINGS

FIG. 1A is a block diagram showing the connection over a computer network of additional computers to the integrated, on-line interactive forum of the present invention.

FIG. 1B is a block diagram showing the components of the integrated, on-line interactive system of the present invention.

FIGS. 2A and 2B depict an exemplary Internet web page used for registering persons in a database used for identifying eligible subjects for a clinical study, in accordance with the present invention.

FIG. 3 depicts an exemplary web page used by a person to submit geographic and contact information to a database used for identifying eligible subjects for a clinical study, in accordance with the present invention.

FIGS. 4A, 4B and 4C depict an exemplary web page through which a person submits one or more disease conditions of interest to a database for identifying eligible subjects for a clinical study, in accordance with the present invention.

FIGS. 5A through 5F depict an exemplary web page which conveys to a registered user information about clinical studies, in accordance with the present invention.

FIGS. 6A through 6N depict a series of exemplary web pages through which a person can search clinical studies and opt to receive information about clinical studies in one or more selected therapeutic areas, in accordance with the present invention.

FIGS. 7A, 7B and 7C depict an exemplary web page that provides a questionnaire that may be completed by an investigator interested in conducting a clinical study, in accordance with the present invention.

FIGS. 7D to 7G depict flow diagrams showing processes for registering subjects and investigators, in accordance with alternative embodiments of the present invention.

FIG. 8 is a flow diagram showing the steps performed by a sponsor using the professional site to recruit subjects, investigators, and take steps necessary to start a clinical study.

FIG. 9 is an exemplary web page used by a sponsor to enter study parameters into the system.

FIG. 10 is an exemplary web page used by a sponsor to enter criteria necessary to initiate an investigator search.

FIGS. 11A and 11B depict an exemplary web page showing the search results from an investigator search performed using the present invention.

FIGS. 12-13 are exemplary web pages showing an extranet for creating, sending and tracking documents necessary to start a clinical study.

FIGS. 14 is an exemplary electronic mail notification used for contacting a potential subject for a clinical study.

FIGS. 15A through 15F is an exemplary study-specific subject questionnaire used for prescreening a subject for a clinical study.

FIG. 16 is a process flow diagram showing the steps of a method for identifying persons to participate in a clinical study, in accordance with a further embodiment of the present invention.

FIG. 17 is a process flow diagram of a method for identifying eligible investigators for a clinical study, in accordance with one embodiment of the present invention.

FIG. 18 is a process flow diagram showing the steps of a method for identifying eligible investigators for a clinical study, in accordance with an alternate embodiment of the present invention.

FIG. 19 is a process flow diagram depicting the steps of a method for identifying eligible investigators for a clinical study, in accordance with a still further embodiment of the present invention.

FIG. 20 is a process flow diagram showing the steps of a method for recruiting a person to participate in a clinical study, in accordance with the present invention.

FIGS. 21A-21Q show the steps of various methods of recruiting investigators in accordance with alternative embodiments of the present invention.

FIGS. 22A through 22F depict an exemplary data structure for implementing an investigator database, in accordance with the present invention.

FIGS. 22G-K depict use of a disease incidence search on a TIA database to assist in performing investigator and subject selection, in accordance with the present invention.

FIG. 23 is a screen shot showing sponsor access limitations to study data.

FIGS. 24A through 24D depict an exemplary data structure for implementing a subject database, in accordance with the present invention.

FIG. 25 depicts an exemplary data structure for implementing a study listings database, in accordance with the present invention.

FIG. 26 depicts an exemplary data structure used for implementing the sponsor access limitations shown in FIG. 23.

FIG. 27 is a flow diagram of a method for performing permission-based electronic mail marketing to consumers, in accordance with the present invention.

### DETAILED DESCRIPTION OF THE PREFERRED EMBODIMENTS

For purposes of the present invention, each of the terms set forth below shall be defined in accordance with the corresponding definitions set forth below:

“Clinical Investigator” or “Investigator” shall mean the Person with regulatory responsibility for conducting a Clinical Study.

“Clinical Study(ies)” shall mean studies designed to distinguish the effect(s) of a drug or a medical device on humans from other influences—for example, a spontaneous change in disease progression or in the effect of a placebo (an inactive substance that looks like the test drug).

“Clinical study sponsor” or “sponsor” shall mean any person responsible for conducting or overseeing a clinical study or trial, including, without limitation, pharmaceutical companies, clinical research organizations, biotechnology companies, medical diagnostic companies, medical device companies or other entities.

“Clinical Subject” or “Subject” shall mean the human subject of a Clinical Study or a potential human subject of a Clinical Study.

“Clinical trials” shall mean those clinical studies required to achieve regulatory approval.

“Consent Information” shall mean that information required by applicable law and/or regulation in order to properly consent to the disclosure of confidential subject information.

“Contract Research Organization” or “CRO” shall mean an organization that receives services relating to conduct of clinical studies.

“Disease Condition” means any human disease or condition for which a Clinical Study may be conducted, including without limitation, a physiological, physical, psychological, psychiatric, surgical or post-surgical condition, whether or not manifest by symptoms. It also includes conditions definable by the existence or omission of a particular genotype, phenotype, or other genetic structure or ordering of genetic material.

“Electronic data capture” or “EDC” shall mean a company in the business of providing software that collects data through the conduct of a clinical study.

“Extranet” shall mean a web application that works over the Internet for sharing data with specific users. Access to the application is protected by the use of passwords, encryption and other security mechanisms.

“Identifying Information” shall mean any individually identifiable health information transmitted in the course of recruiting clinical subjects that relates to an individual's physical or mental health or condition, and/or the provision or payment of care, and that identifies the individual or creates a reasonable basis to believe the information can be used to identify the individual.

“De-identified Data” shall mean data in which identifying information has been removed or hidden by removing, coding, encrypting, or otherwise eliminating or concealing the information such as name, address, birth date, name of relatives or employers, telephone numbers, email address and other unique identifying numbers, characteristics or codes that the covered entity had reason to believe may be used by an anticipated recipient of the information to identify the individual.

“IRB” shall mean “Institutional Review Board”. Other countries may have equivalent such ethics boards under International Health Commission (“IHC”) guidelines.

“Investigational Drug or Device” shall mean any drug or device that is the substance or object being tested in a Clinical Study; including without limitation, drugs or devices designed for the cure, prevention, control, monitoring of treatment or treatment of a Disease Condition.

“Laws” shall mean all applicable laws, statutes, rules, regulations, ordinances and other applicable pronouncements having the effect of law whether federal, national, multinational, state, provincial, county, city or other political subdivision, domestic or foreign which pertain to and are applicable to the disclosure of confidential subject information including subject identity.

“Permission Information” shall mean optional information submitted by a user of a database in order to convey the user's agreement to receive data or information or to have personal and/or confidential information provided by the user disclosed under certain defined circumstances.

“Person” shall mean any individual, corporation, partnership, association, unincorporated organization or government or political subdivisions thereof

“Primary research facility” or “PRF” shall mean the location at which the investigator conducts a clinical study.

“Regulatory Approval” shall mean, with respect to a country, all authorizations by the appropriate governmental entity or entities necessary for commercial sale of a drug product in that country including, without limitation and where applicable, approval of labeling, price, reimbursement and manufacturing. “Regulatory Approval” in the United States shall mean final approval of a new drug application pursuant to 21 C.F.R. §314, permitting marketing of a drug product in interstate commerce in the United States.

### System Architecture

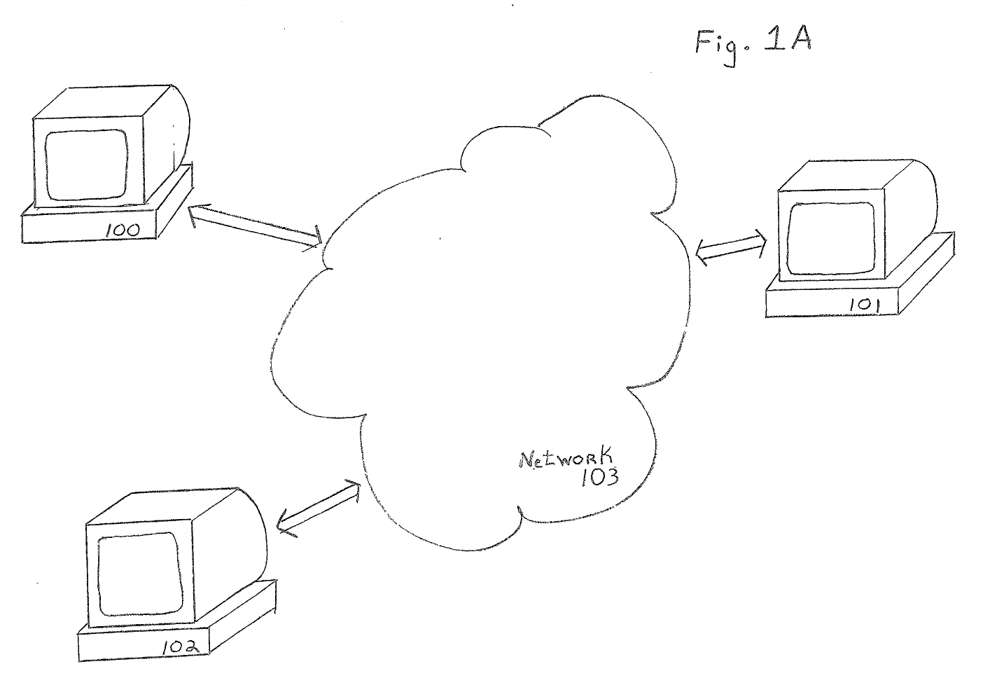

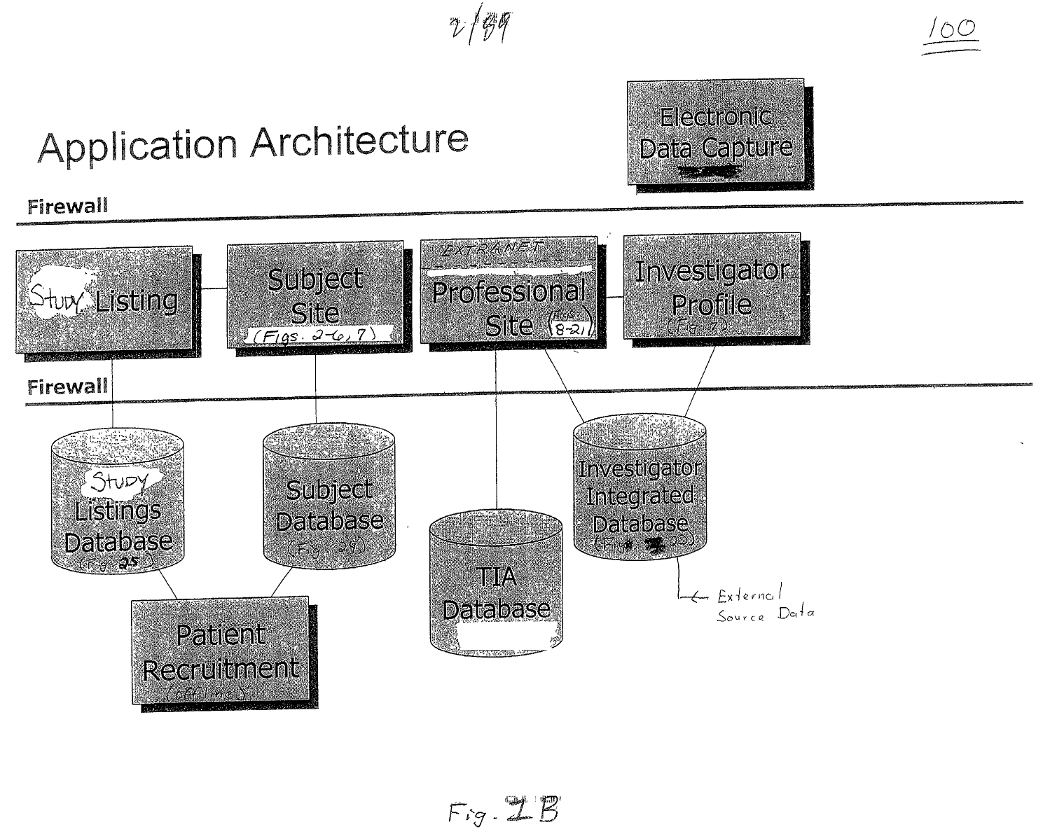

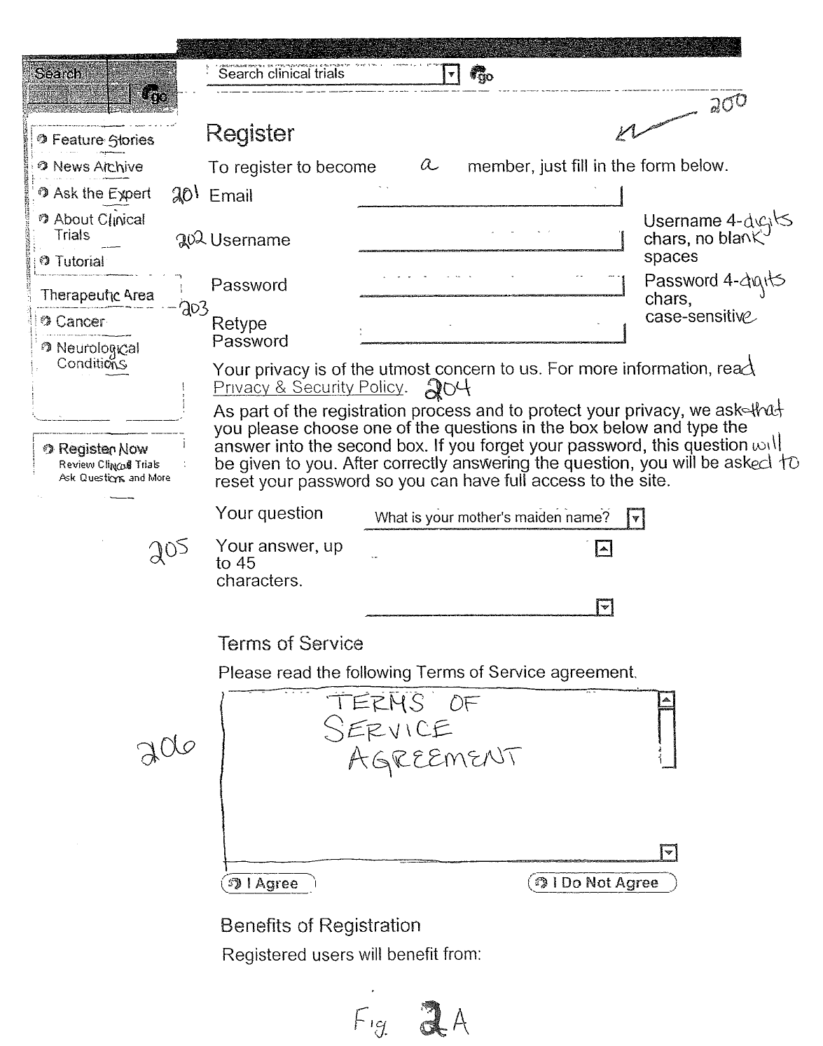

Referring first to FIG. 1A, in that figure is depicted computer network 103 operatively connecting computer system 100 to more or more additional computer systems represented here as computer systems 101 and 102. Computer system 100, described in more detail below, may be any of a number of commercially available computer systems, including a conventional server or workstation. Such systems may include, for example, one or more microprocessors, computer memory, conventional communication circuitry (e.g., a modem) and other commonly available peripherals. Computer systems 101 and 102, and other computers that interface with network 103, may also be such workstations or servers, or may comprise any type of commercially available personal computers capable of communicating over a computer network. Those of ordinary skill in the art will recognize that network 103 may connect to any number of additional computers. Network 103 represents a public or private computer network. The Internet is one example of such a network, though other types of networks are possible within the scope if the inventions described herein.

Referring now to FIG. 1B, there is shown a block diagram of an integrated online system 100 that promotes exchange of information among clinical study sponsors, clinical study investigators, and clinical study subjects, in accordance with the present invention. The clinical study sponsors, investigators and subjects may access system 100 using computers such as computers 101, 102. Among other things, system 100 serves to integrate the now fragmented clinical study system by bringing clinical study sponsors, clinical study investigators, and subjects together in a common environment. The system 100 also serves to integrate the clinical study system by bringing the clinical study sponsors, clinical study investigators and subject's data together in a secure environment. In addition, and as discussed more fully below, system 100 includes specialized databases and collaboration tools that allow clinical study sponsors and investigators to take the steps necessary to start a clinical study more quickly, including assessing the feasibility of a study, locating qualified investigators, communicating with investigators, completing all required preliminary documentation necessary to enroll investigators in the study, locating qualified and interested subjects, communicating with interested subjects, and directing interested subjects to appropriate investigator sites to perform the physical assessment and complete the necessary documentation to enroll the subjects in the clinical study.

System 100 contains several databases, that function in combination to facilitate the start of a clinical study. By way of an overview, system 100 includes a subject database that includes information about persons that may potentially qualify as eligible subjects for a clinical study. Demographic information about each registered person is stored in the subject database. In addition, information about disease conditions of interest to persons in the subject database and information about clinical studies of interest to such persons is stored in the subject database. As a potential subject interacts with system 100 over time by, for example, attempting to qualify for participation in various clinical studies, system 100 collects and stores additional information about the persons represented in the subject database. In accordance with this aspect, individual subjects or their caregivers will enter information about themselves into system 100 when they attempt to qualify for a given clinical study. This information may be limited to what is sought in the registration questionnaire, or it may take the form of responses to one or more different questionnaires designed to assess eligibility for a given clinical study. Irrespective of whether the subject is ultimately selected for participation in the study, upon obtaining appropriate consent from the subject, the information entered by the subject during any pre-screening for the clinical study will be added to the registration information and stored as part of the subject database. Over time, as a given individual attempts to qualify for further clinical studies, still further information will be collected about the individual in connection with the screening for the further clinical studies. This further information will also be stored in the subject database. Thus, over time, the information in the subject database will grow more detailed and complete as the same individual provides additional information to apply for additional studies using system 100. As discussed more fully below, the subject database is used by clinical study sponsors to identify potential subjects to participate in clinical studies. As the information stored in the subject database becomes more detailed and complete over time, the utility of the subject database will be further enhanced from the point of view of clinical study sponsors because the sponsors will be able to identify more rapidly, accurately and with higher confidence potential subjects for their clinical studies.

In system 100, potential clinical study subjects submit data (later stored in the subject database) through the subject site. The subject site is, for example, an internet website that is accessible to the general population. Further details of the subject site are shown in FIGS. 2 through 6, and discussed below. By way of overview, the subject site includes content about new medical therapies and current clinical studies. This content is typically of interest to chronically ill persons, persons who are newly diagnosed with a particular illness, caregivers for persons with a particular illness, and other persons in the general population who might be interested in participating as subjects in a clinical study. The content is preferably available for free to the users. However, when viewing the content, users are requested to register with the subject site. During the registration process, a given user will enter demographic information about himself or herself, and will be given an opportunity to indicate areas of new medical therapies or clinical studies that are of interest to the individual. All such information entered by the user is stored in the subject database. As discussed more fully below, if a registered user wishes to attempt to qualify for participation in a clinical study, the individual may submit answers to a questionnaire tailored to the clinical study via the subject site. (In one embodiment, the questionnaire answers are received from the subject or caregiver on a secure page of the subject website.) These questionnaire answers are then used for at least three purposes. First, the answers are used to pre-screen the individual for the given clinical study for which they are attempting to qualify. Second, with appropriate consent from the individual, the questionnaire answers are stored in the subject database and used to assess more accurately whether or not the given individual would be appropriate for consideration in a later clinical study. Third, the questionnaire answers are used to assess the feasibility of subsequent studies. Fourth, the answers may be used to lock-out people once they are in a study.

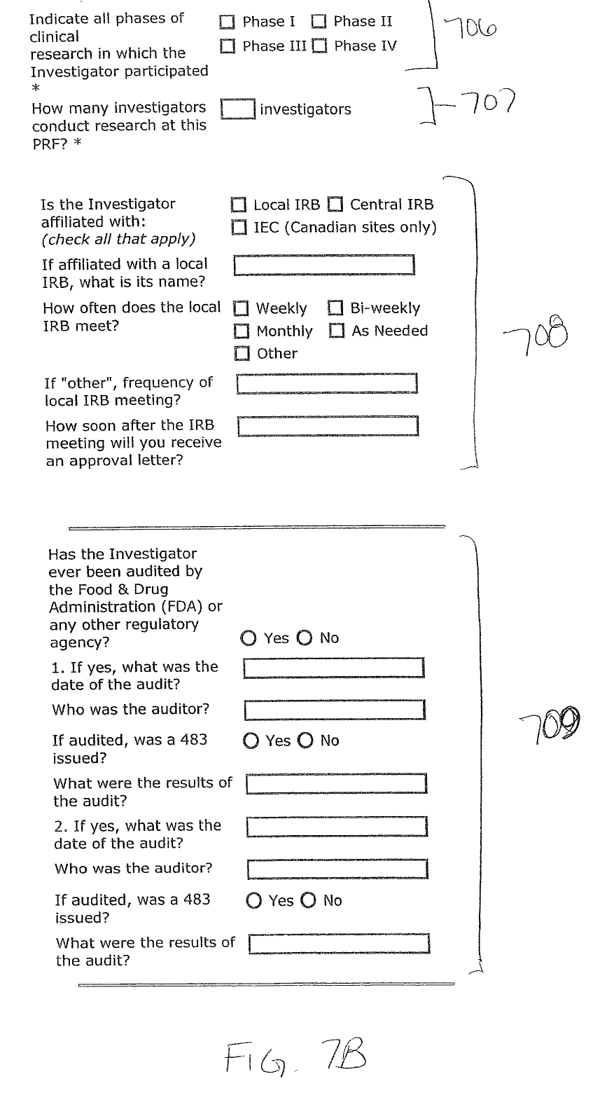

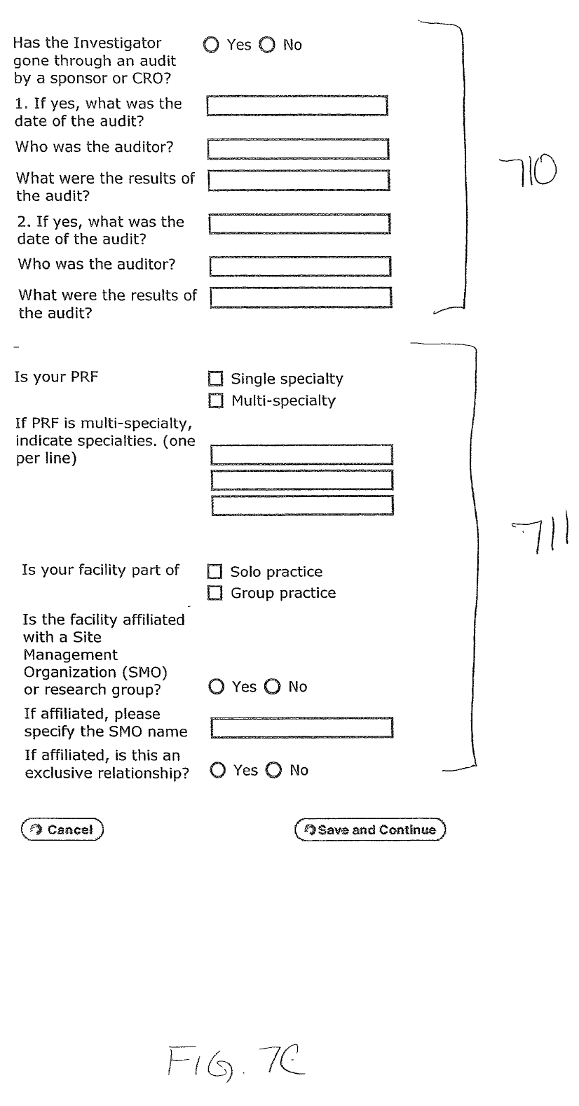

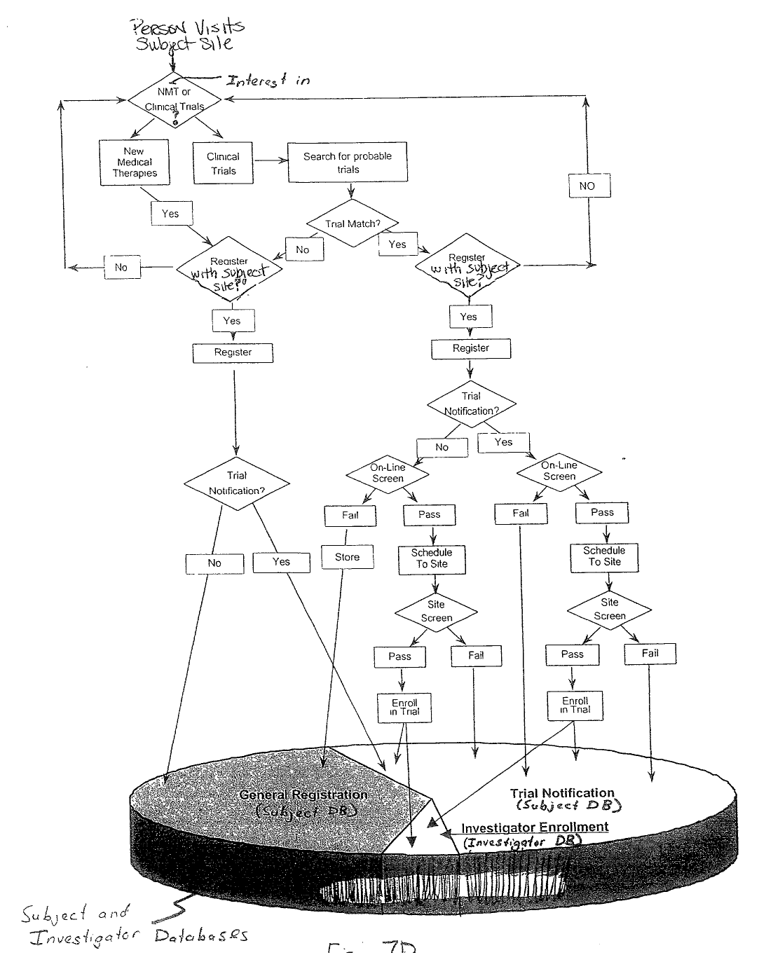

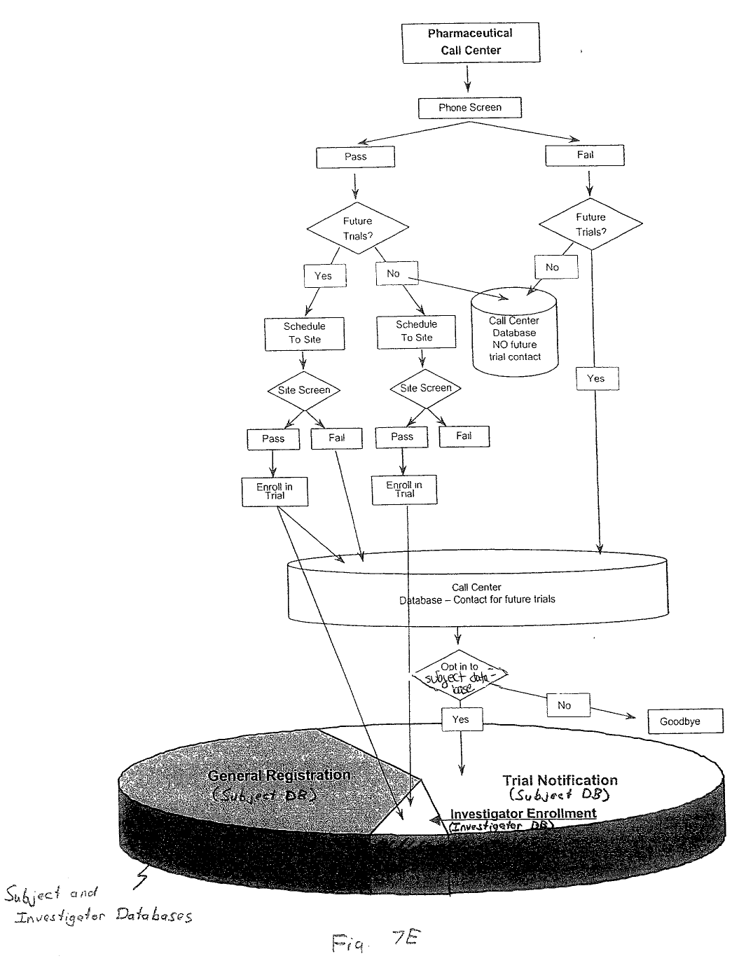

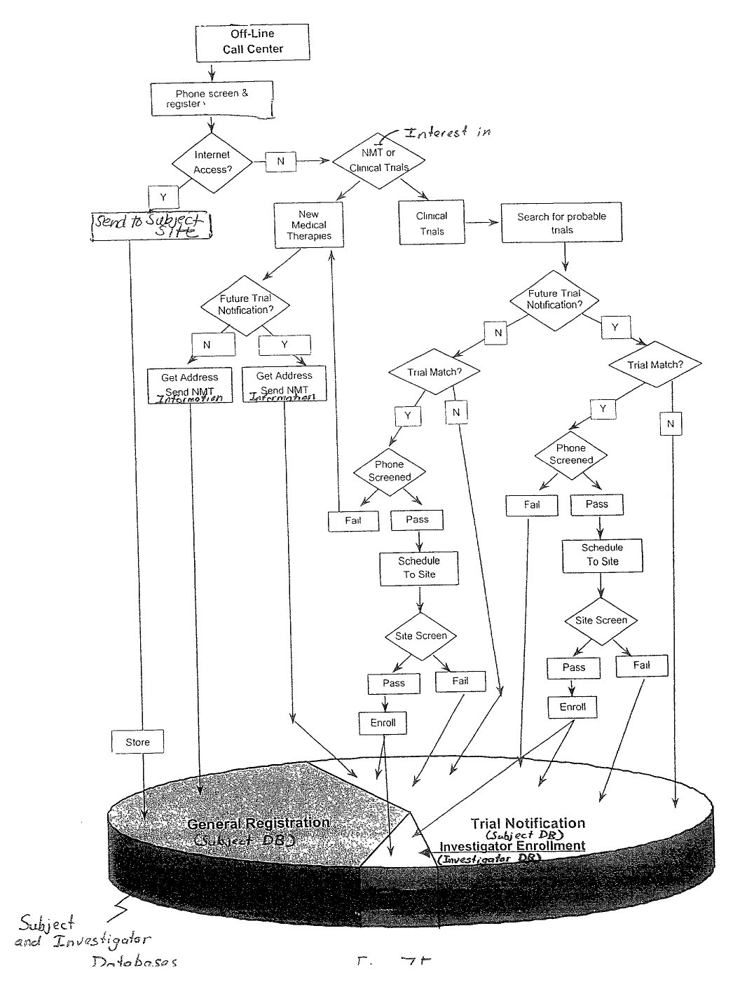

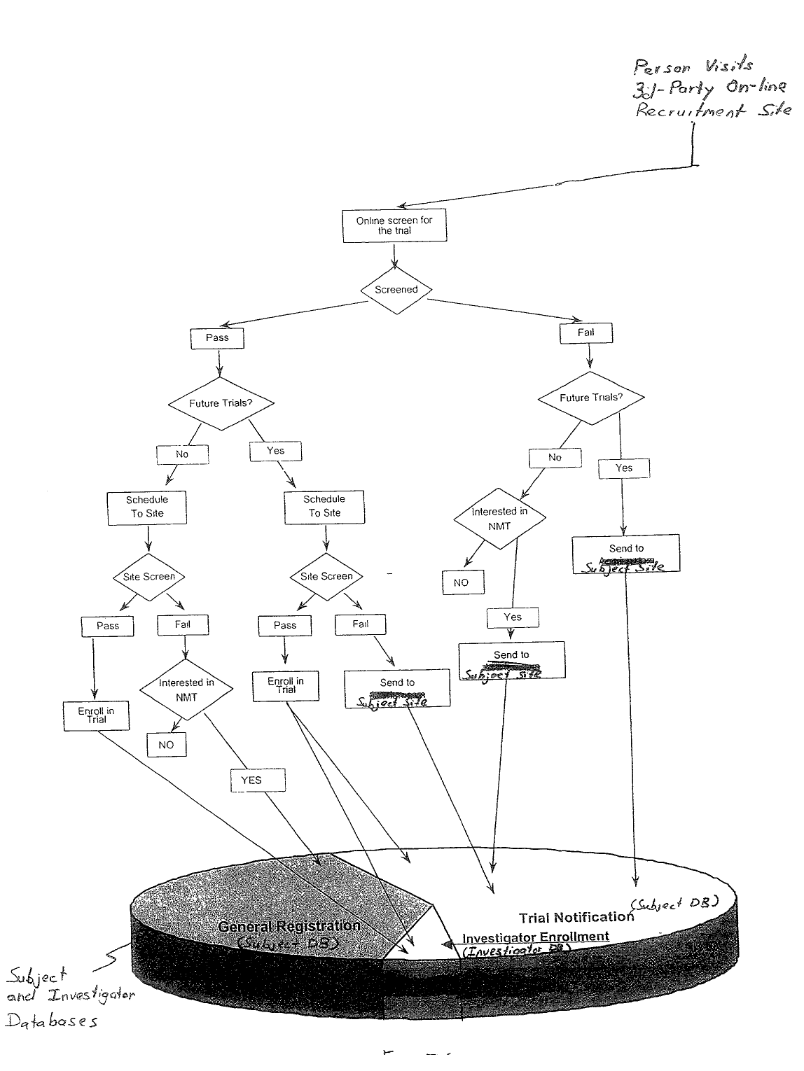

Referring still to FIG. 1, system 100 also includes an integrated investigator database. In one embodiment, the investigator database includes information from three general sources as described below, although in other embodiments it may include information from a lesser or greater numbers of sources or different sources. First, the investigator database includes data about the clinical study investigators who wish to inform clinical study sponsors of their clinical study experience and/or training, submitted by the investigators themselves. This self-reported data is typically entered into the investigator database either when a given investigator logs onto the professional site, and registers with the system as described further with reference to FIGS. 7A through 7C or by submitting such information to the professional site by mail, fax, phone or other non-computerized means. The self-reported data includes various types of information including, for example, the educational background of the investigator, the clinical study experience of the investigator, the past performance of the investigator in other clinical studies (e.g., how many subjects the investigator committed to recruit for a given study in what period of time, how many subjects the investigator actually recruited for the study in what period of time, and how many of such subjects actually completed the study), equipment available to the investigator (e.g., whether or not the investigator has access to a CAT scan machine or MR equipment which may be required for a given study), any mandated IRB relationships of the investigator (e.g., whether or not the investigator is required through professional affiliations to submit materials to a particular IRB for approval before the materials may be used to advertise the study), any hospital or HMO affiliations of the investigator, information about the investigator's staff and facilities and the geographic location of the investigator.

In addition to the self-reported information, the investigator database also includes information about investigators received from a variety of external sources. One such external source is the FDA, which can provide information about any past clinical studies for which an investigator has registered, as well as any information about sanctions or other disciplinary actions that may have been issued in connection with an investigator's work in a past clinical study. Information obtained from the investigator in the past or from other third party sources, such as an investigator's prescription writing history and the history of laboratory requests made or lab results received by an investigator in the past, are stored in the investigator database. Such external information can be used to both supplement and verify the self-reported data entered by the investigator and discussed above. Clinical study sponsors may also supply information about their past experiences with a given investigator, and such information may be stored in the investigator database.

In addition to the self-reported and external source data, additional information about a given investigator will be learned by system 100 as the investigator interacts with system 100 and attempts to enroll in clinical studies with the assistance of the system. For example, in some embodiments, after a given clinical investigator has been recruited for a given clinical study using system 100, the system will monitor the investigator's performance with respect to the clinical study and store this performance data in the investigator database if the system is linked to an EDC product that is collecting data throughout the study. In alternative embodiments, the performance data may be obtained through off-line sources.

In an embodiment, system 100 also includes a Therapeutic Incidence Area (“TIA”) database. The TIA database contains the incidence and/or prevalence of different disease conditions by geographic area. Thus, for example, the TIA database may store the incidence or prevalence of colon cancer in each of several different municipalities across the country. The data sets and search parameters used to conduct searches in the TIA databases have been created to conform to the information required by clinical study sponsors when determining the likelihood of recruitment success within the projected time frame for a particular protocol for the study, or when determining where to locate investigator sites to conduct the study. As explained more fully below, the present invention uses the TIA database to assist in the selection of investigators for a given clinical study by searching for an investigator who is proximate to a geographic area where a greater number of subjects who may be eligible to participate in the study reside or receive treatment.

An important part of system 100 is its incorporation of an extranet to facilitate secure collaborations between a clinical study sponsor (or its designees) and its investigator(s) during the process leading up to the start of a clinical study. As discussed more fully below, after a clinical study sponsor has identified an investigator to perform a given clinical study, the sponsor must formally engage the investigator for the study. During the engagement process, several documents (e.g., an investigator questionnaire, answers to the investigator questionnaire, a confidentiality agreement, a contract, a budget, an FDA form 1572, IRB documents, the study protocol, etc.) will in most instances be exchanged between the sponsor and the investigator. The present invention provides a secure environment for these communications, as well as functionality that manages and tracks the documents needed to start the clinical study. In one embodiment, this functionality is achieved by allocating individual workspaces to sponsors and investigators within the professional site. A given sponsor or investigator is then able to receive, send, and track documents from within his or her workspace.

### Subject Site and Registration

Information regarding potential clinical study subjects may be gathered from a variety of different sources including, in a preferred embodiment, via a web site such as subject site of FIG. 1B. The information obtained regarding potential clinical study subjects must be sufficiently general in nature such that it may be applicable to a variety of different therapeutic areas and disease conditions, yet specific enough to be useful in assessing the subject's eligibility for a specific study with narrowly defined inclusion or exclusion criteria.

FIGS. 2A and 2B depict an exemplary internet web page, which allows for the registration of persons in a database (e.g., the subject database of FIG. 1B) and which is used for identifying eligible subjects for a clinical study, in accordance with the present invention. Registration web page 200 includes e-mail area 201, username area 202, and password area 203 where the person registering in the database may enter his or her information. A hypertext link 204 to a privacy and security policy of the service provider may be provided in some embodiments. In all embodiments, the privacy of subjects is protected by ensuring compliance with all applicable laws. A question/answer area 205 may be provided for use in the event the person forgets his or her password. In agreement area 206, the terms and conditions pursuant to which the person is entitled to register himself or herself in the subject database and use the inventive system may be provided.

FIG. 3 depicts an exemplary web page of subject site used by a person to submit geographic, gender and contact information to a database, such as the subject database of FIG. 1B, used for identifying eligible subjects for a clinical study, in accordance with the present invention. Personal information web page 300 includes name, contact information, and geographic information area 301 as well as gender information area 302 where the person registering in the database enters his or her information.

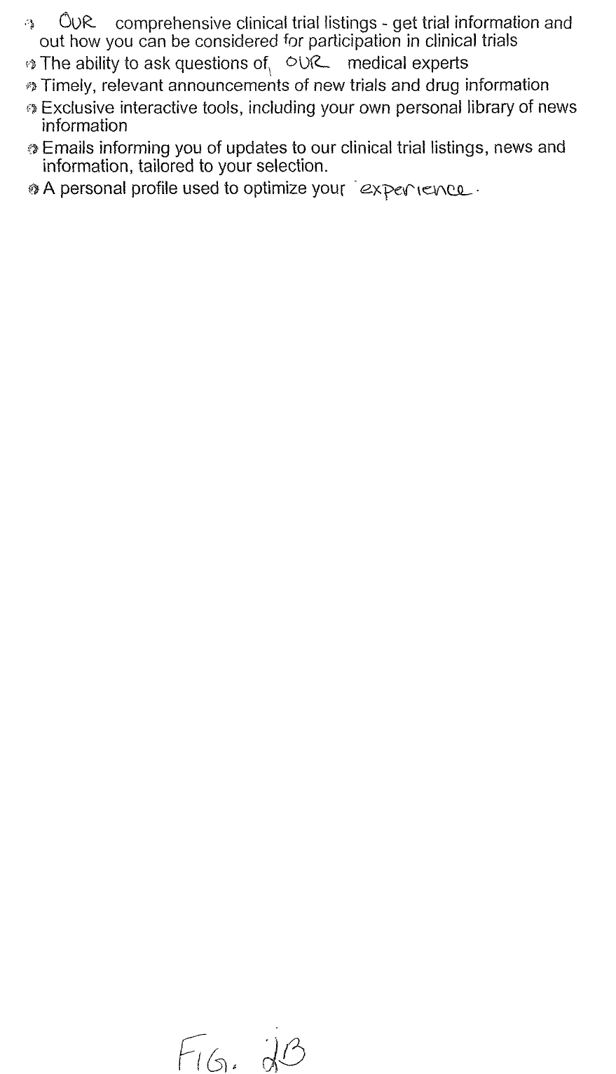

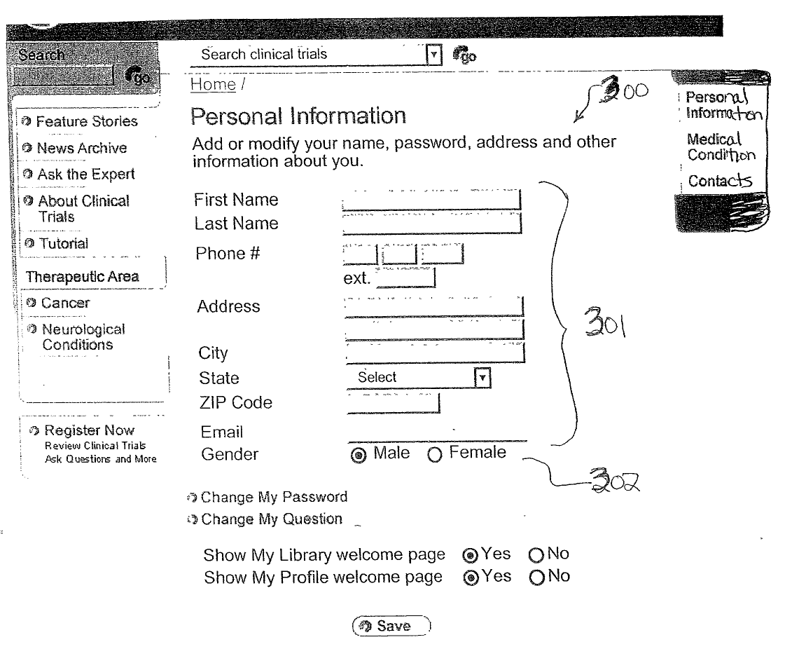

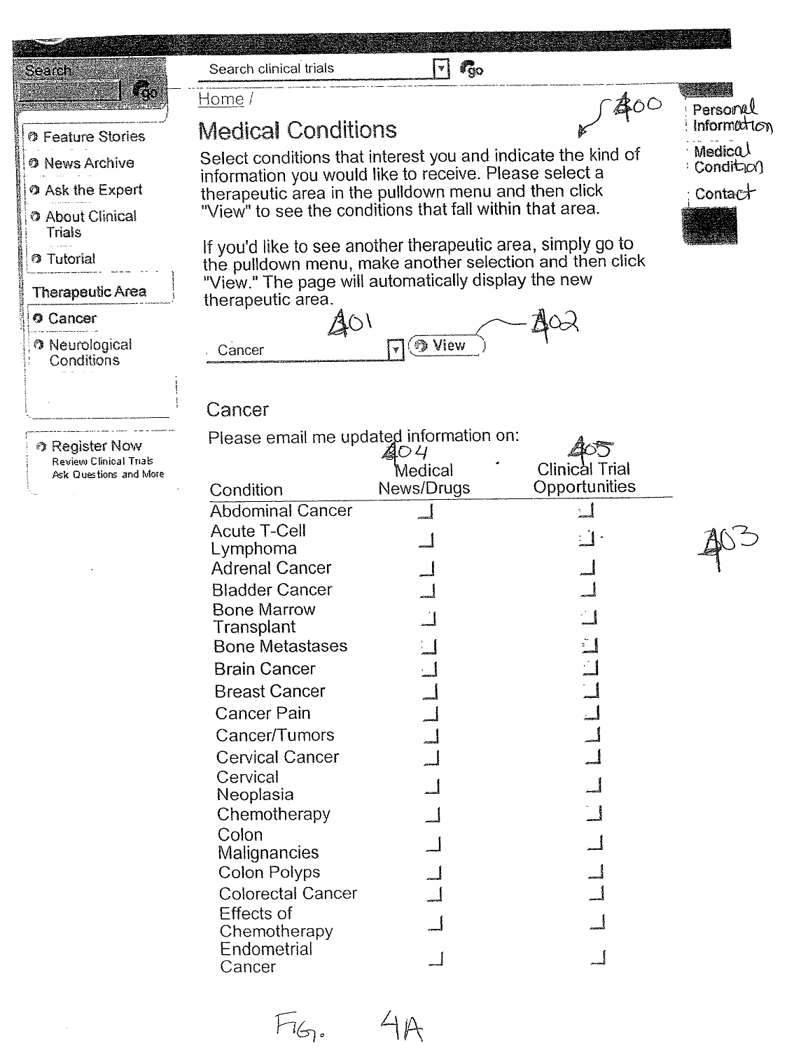

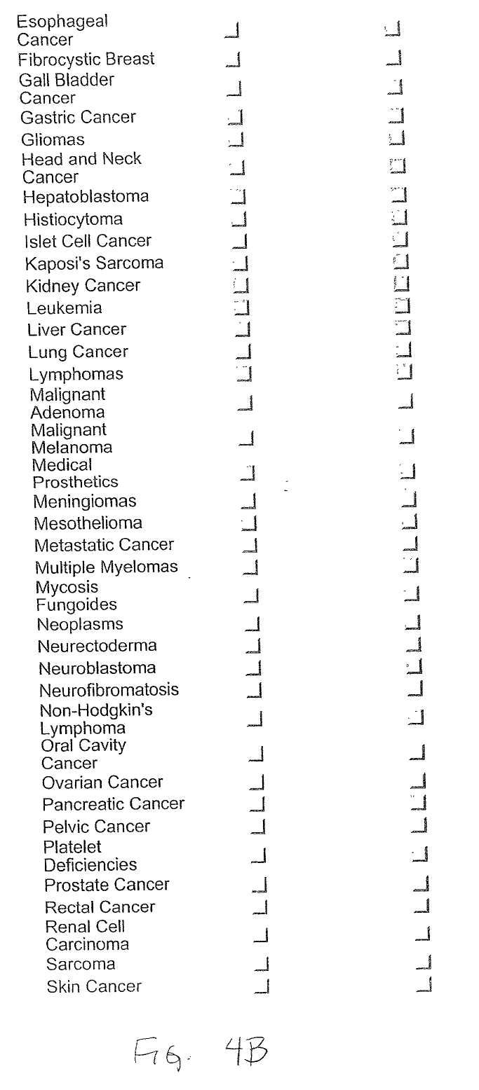

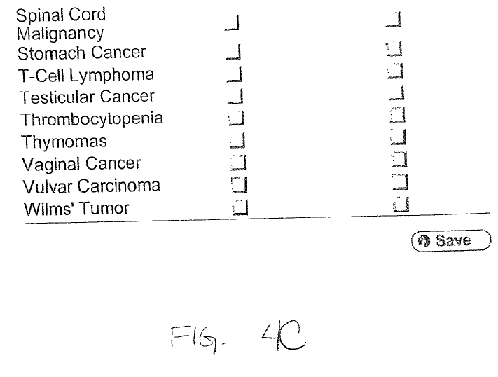

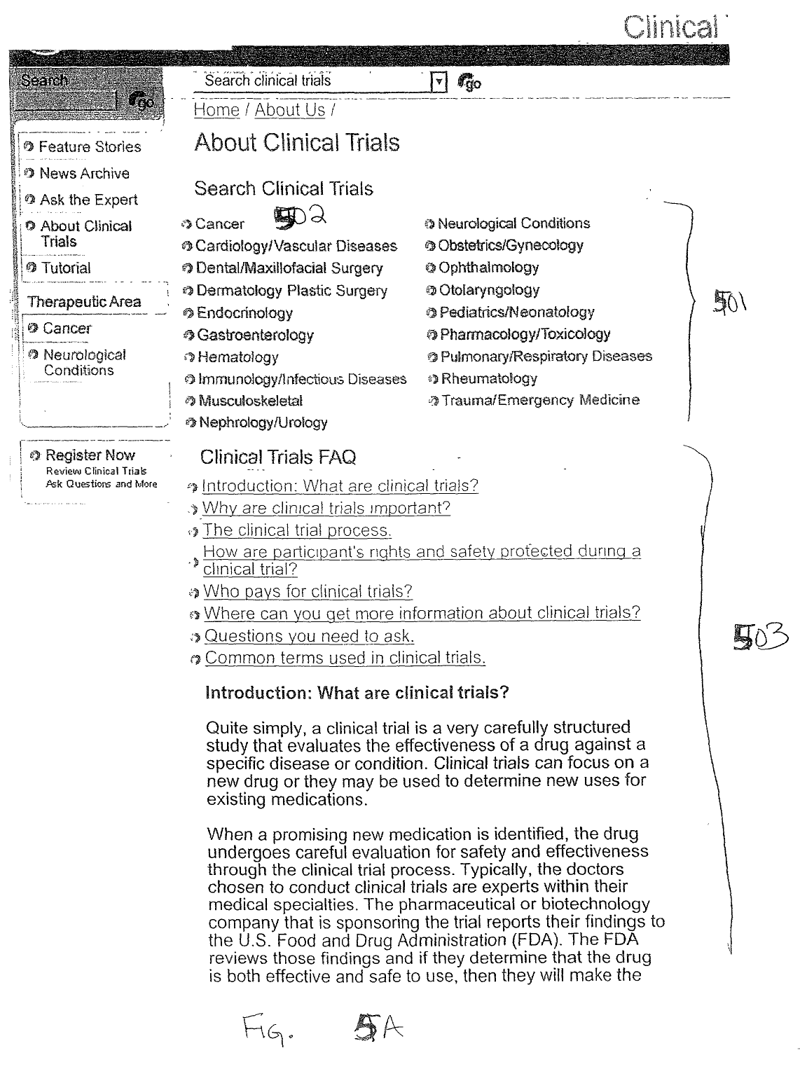

FIGS. 4A through 4C depict an exemplary web page of subject site through which a person may submit one or more disease conditions to a database for identifying eligible subjects for a clinical study, in accordance with the present invention. Therapeutic area web page 400 includes pull down menu 401 at which a person may identify a therapeutic area of interest to that person. In this example, the therapeutic area cancer has been chosen. Upon clicking on view button 402, the potential disease conditions of interest are presented to the subject or caregiver in disease condition area 403. The person may check one or more boxes in medical news/drug area 404 or clinical study opportunities area 405 to indicate if the person is interested in obtaining medical news, drug or clinical study opportunity information on any of the disease conditions specified in disease condition area 403.

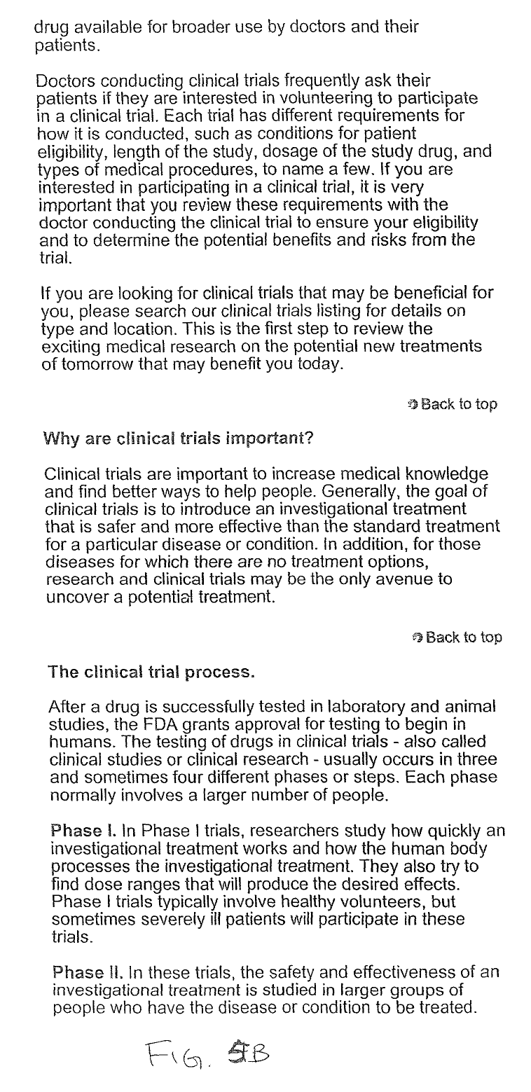

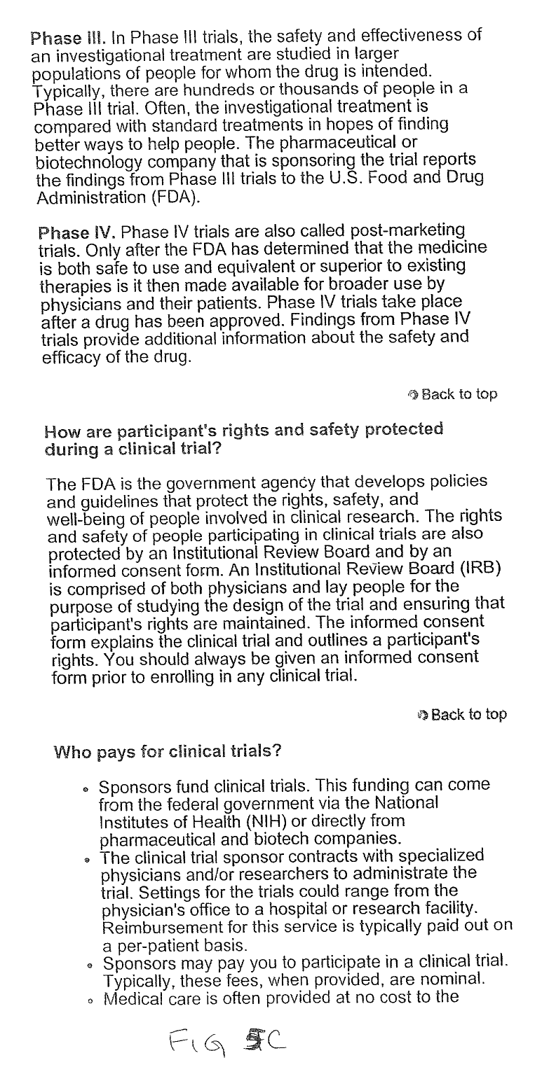

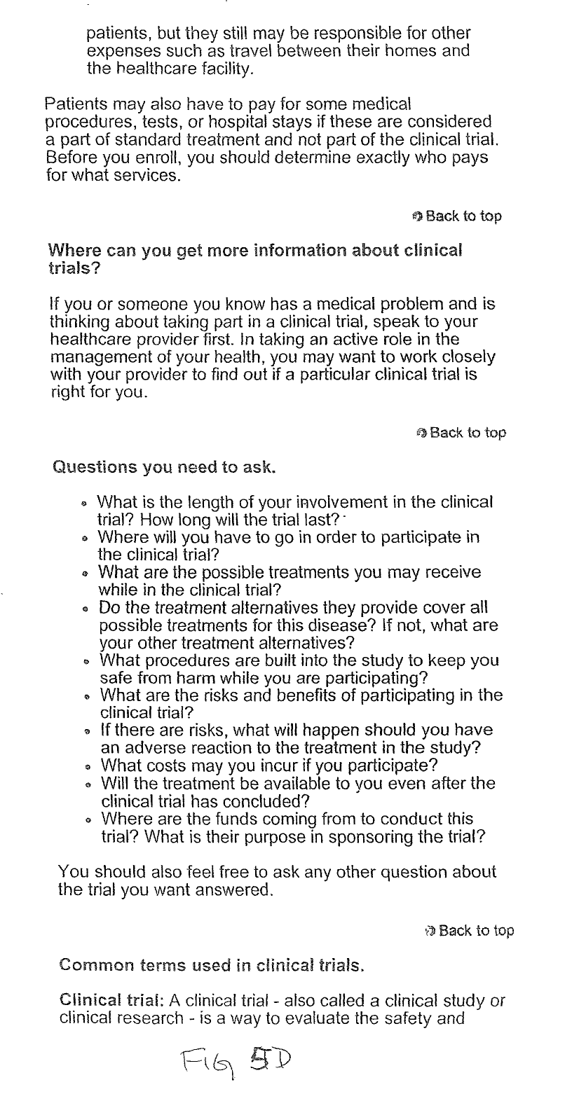

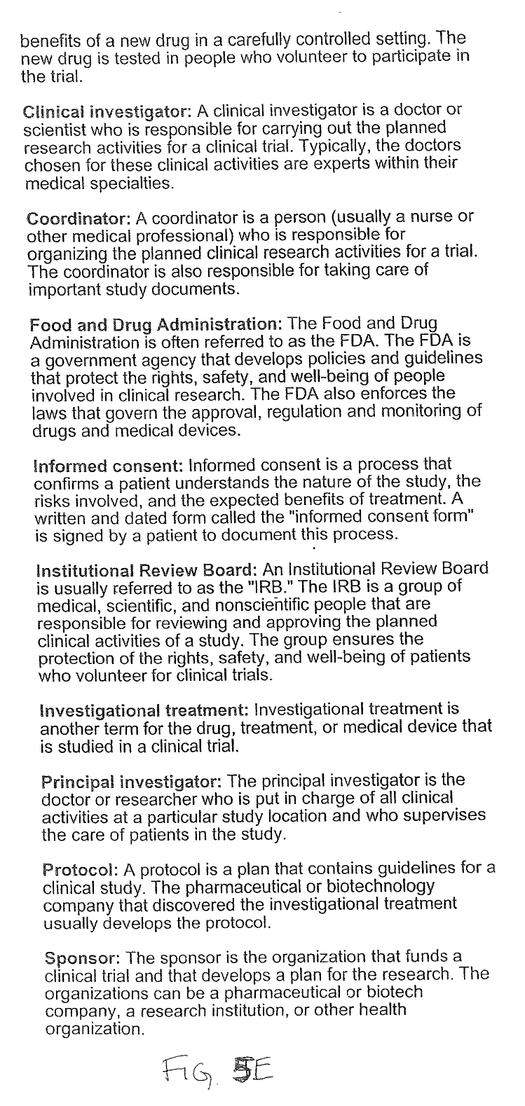

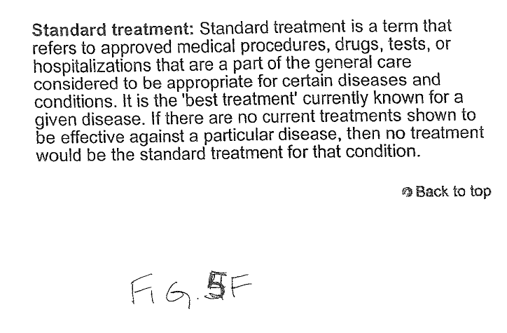

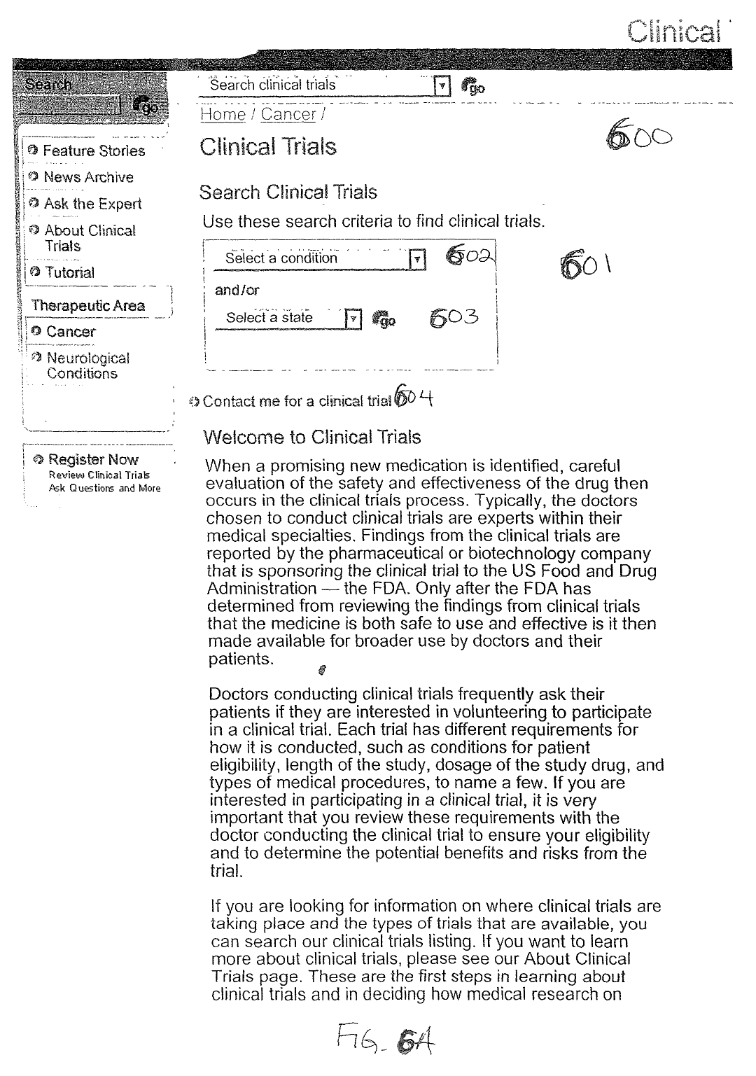

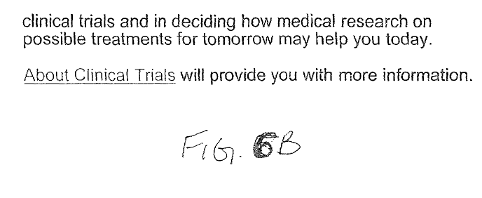

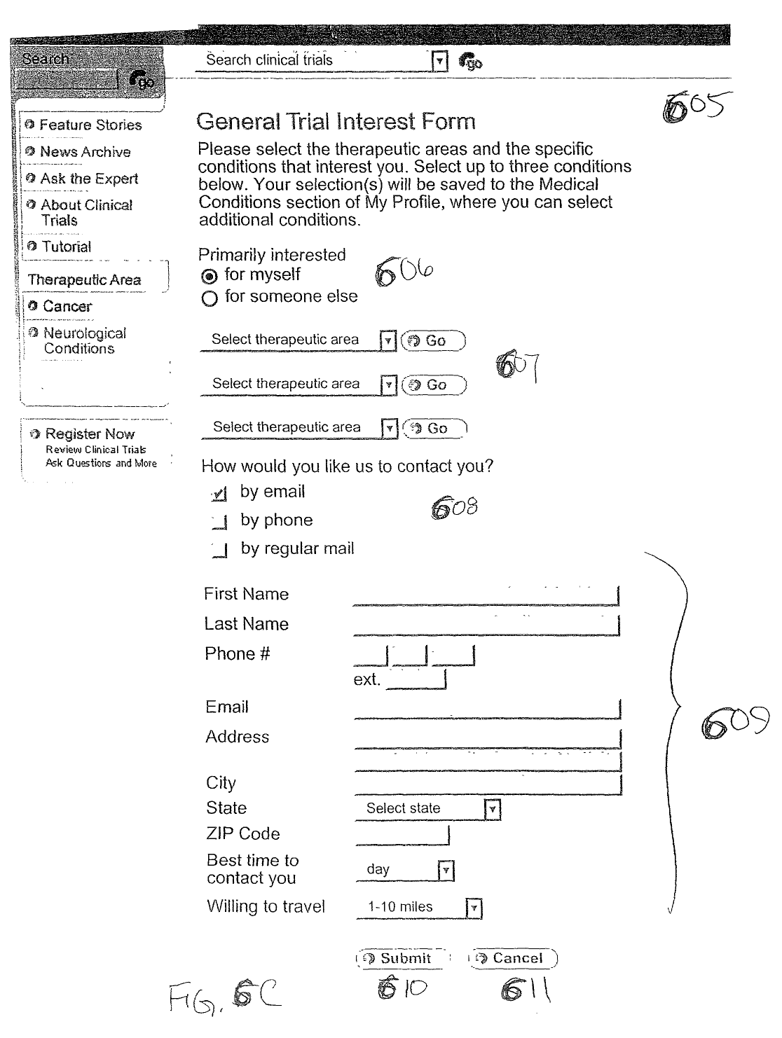

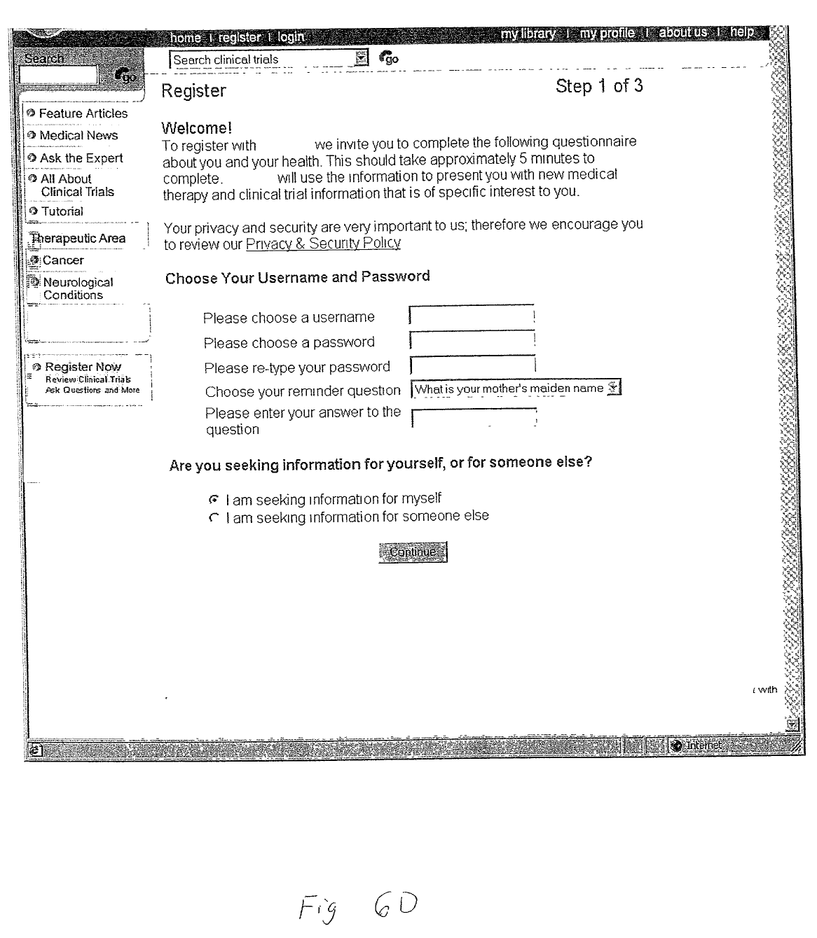

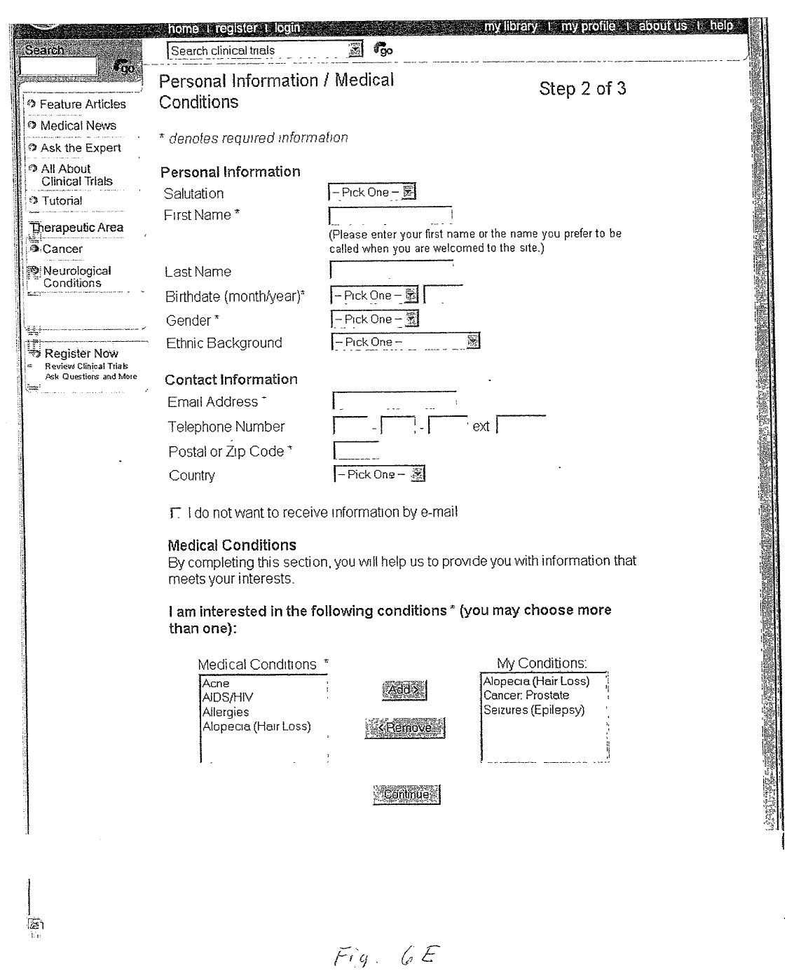

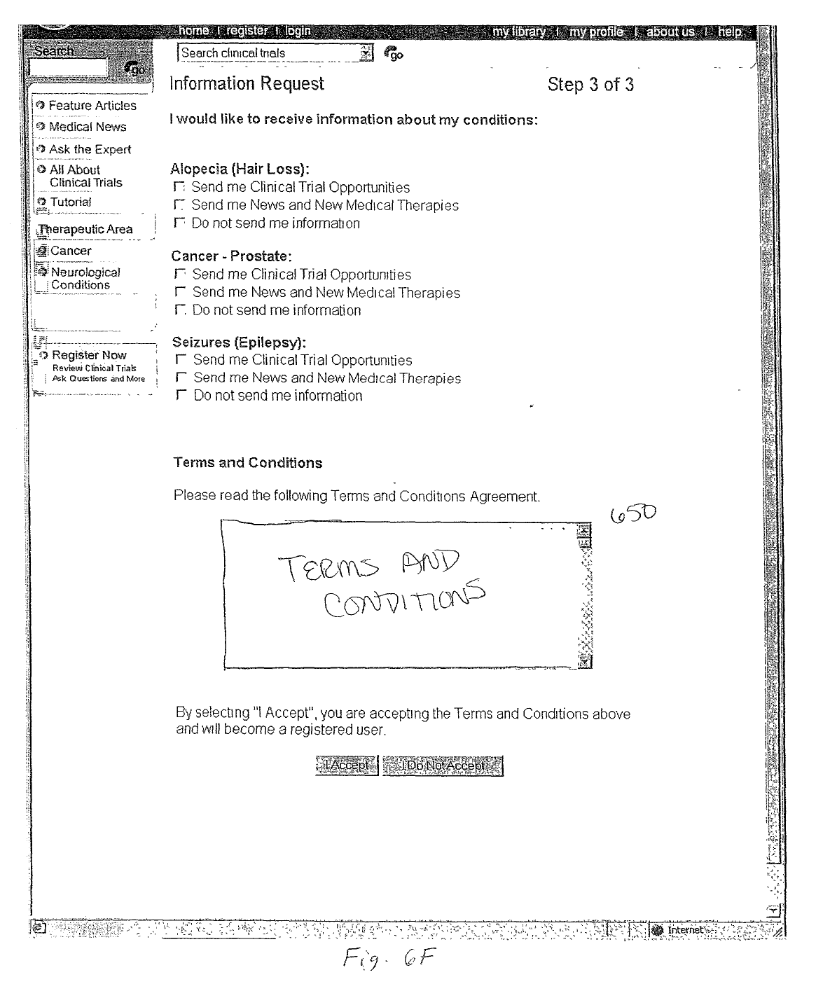

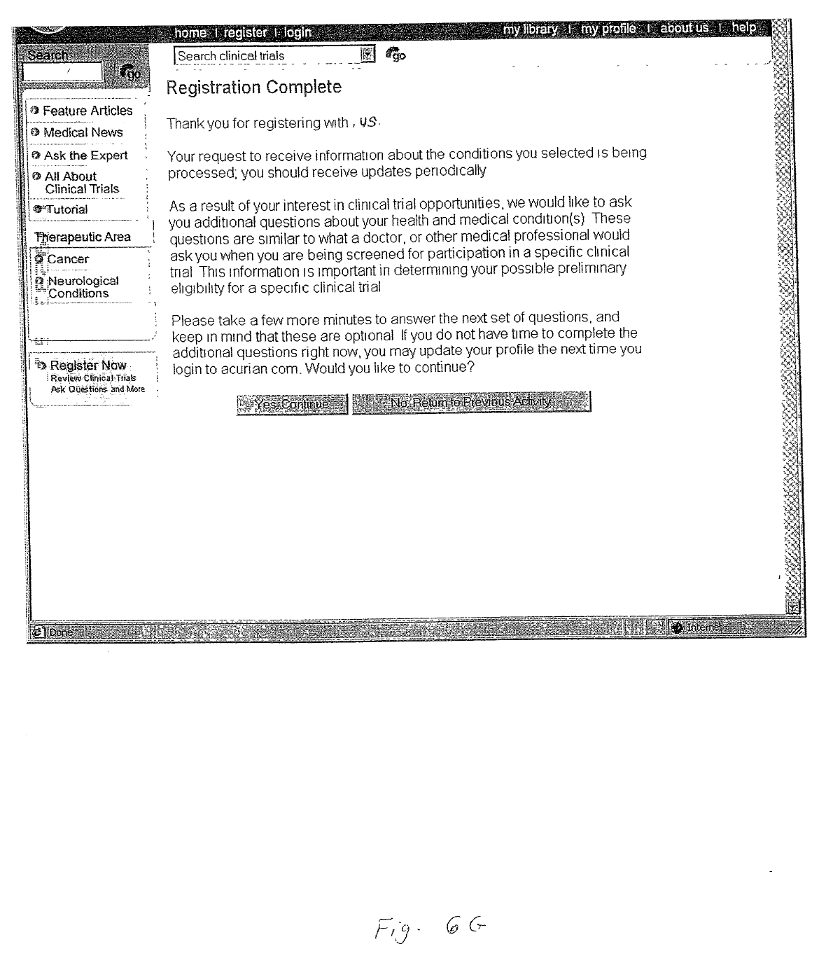

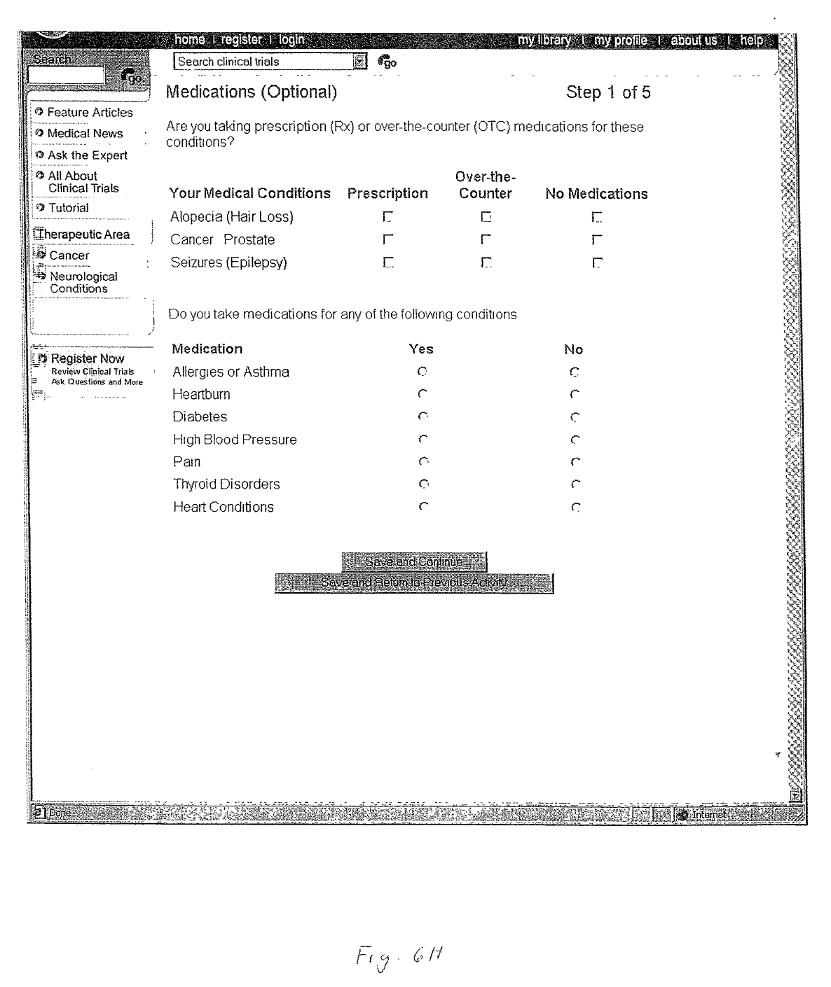

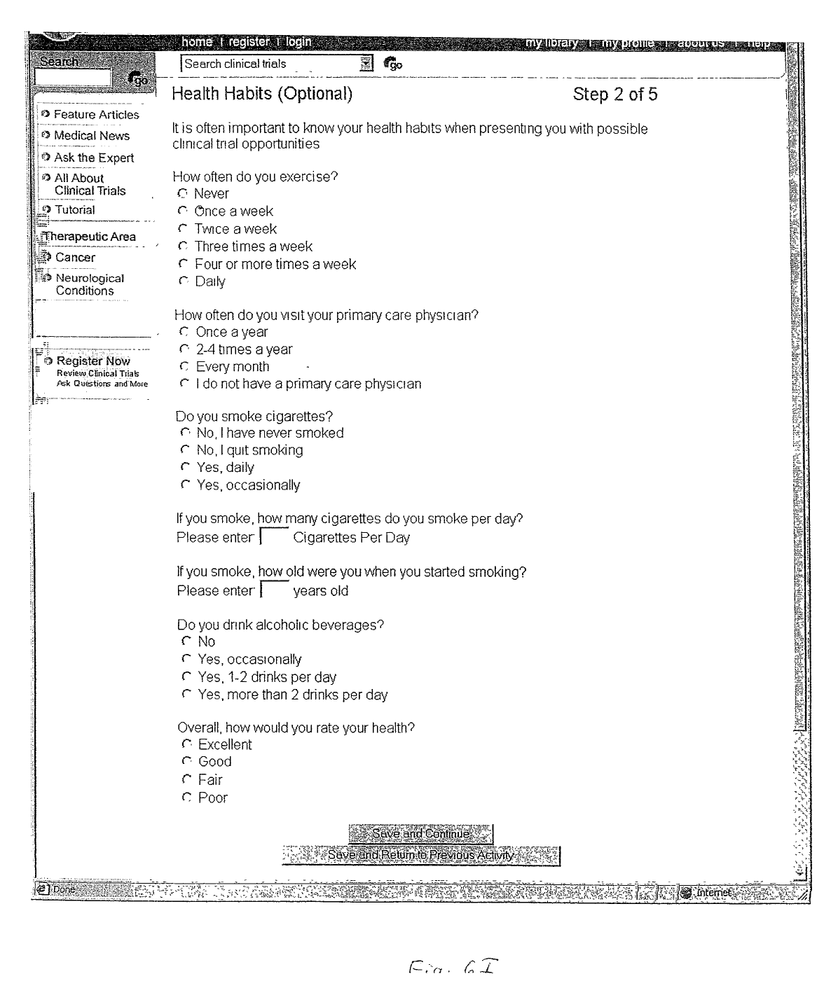

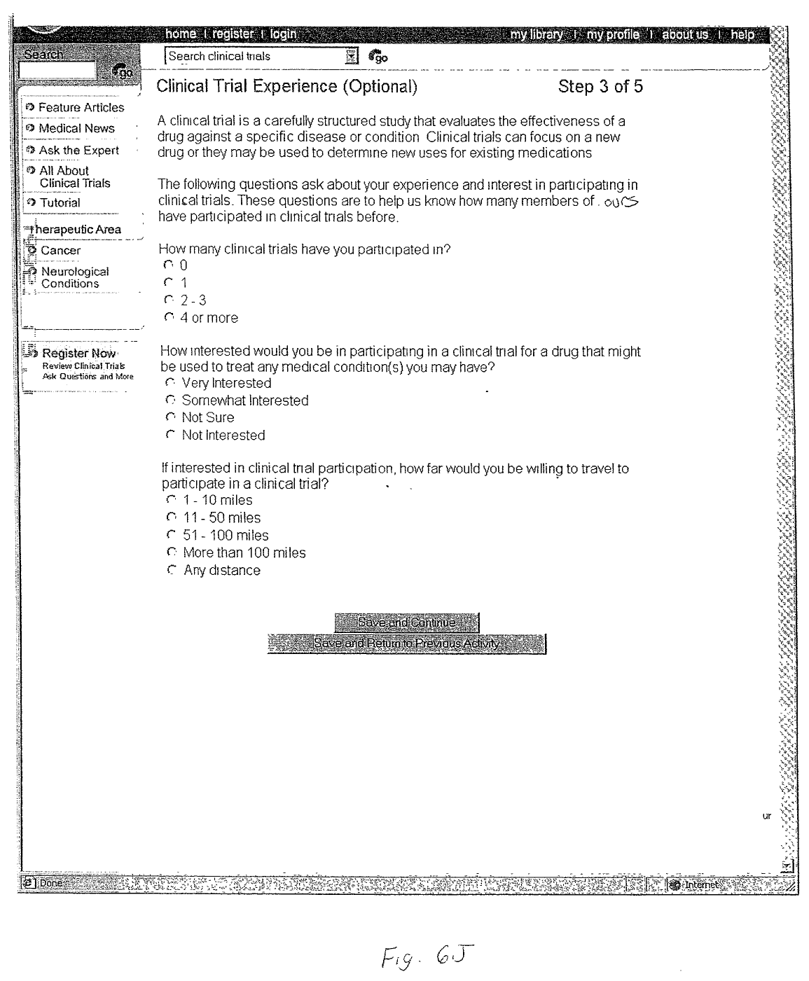

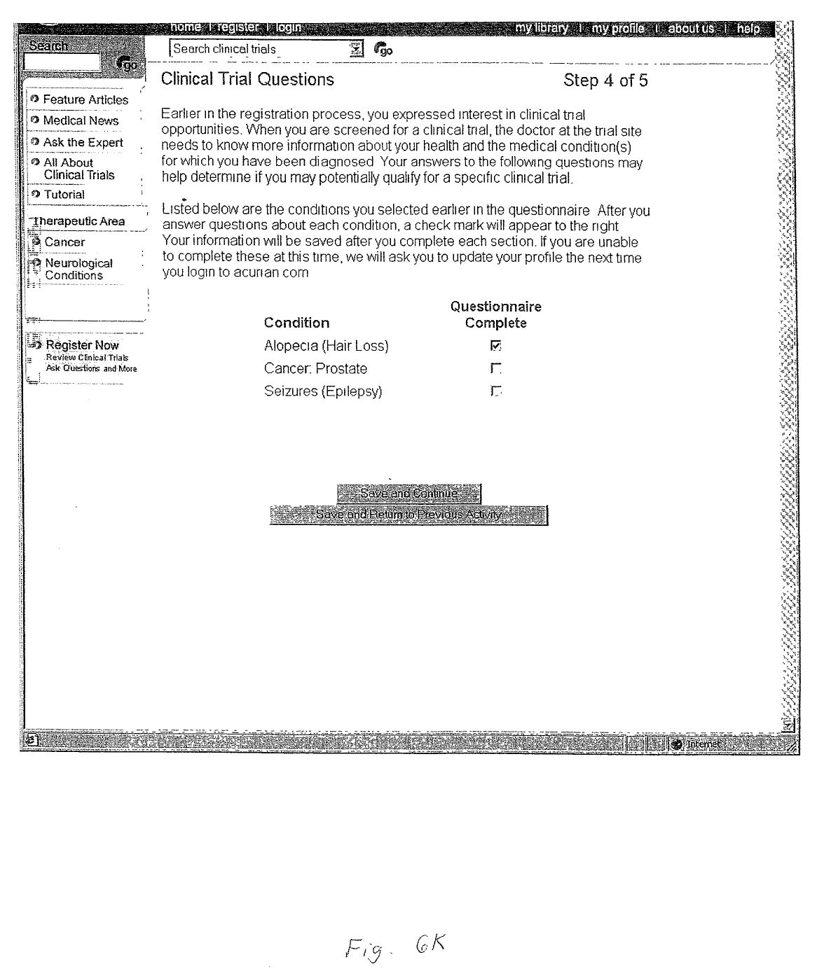

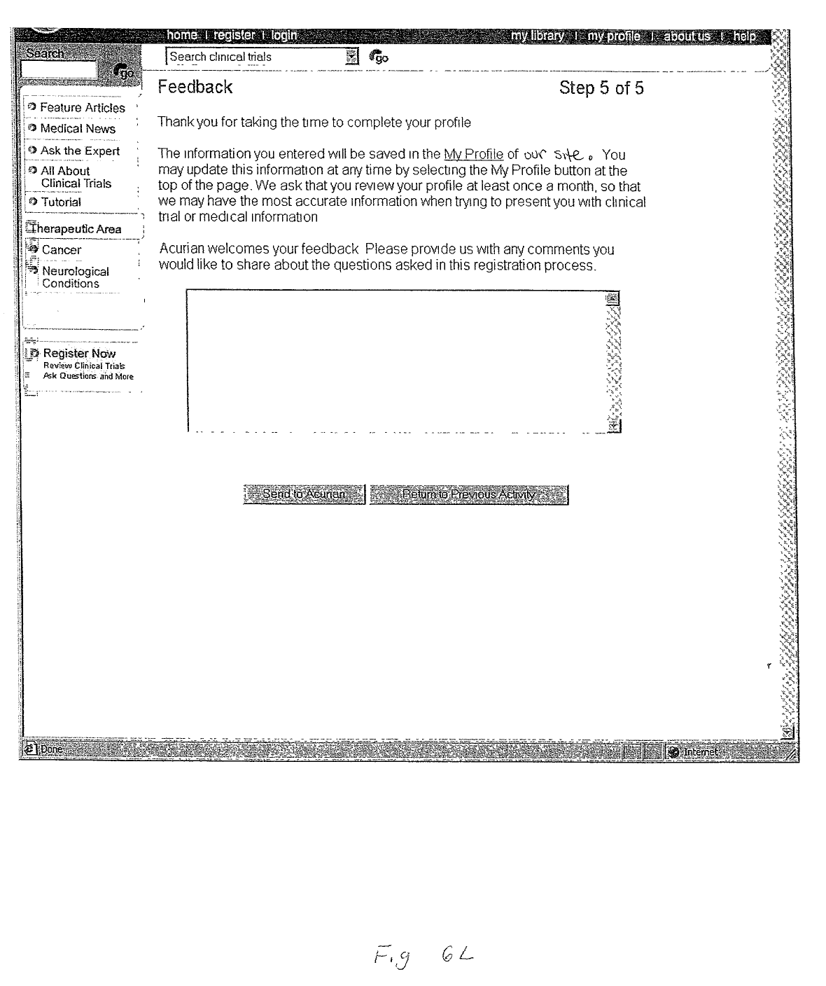

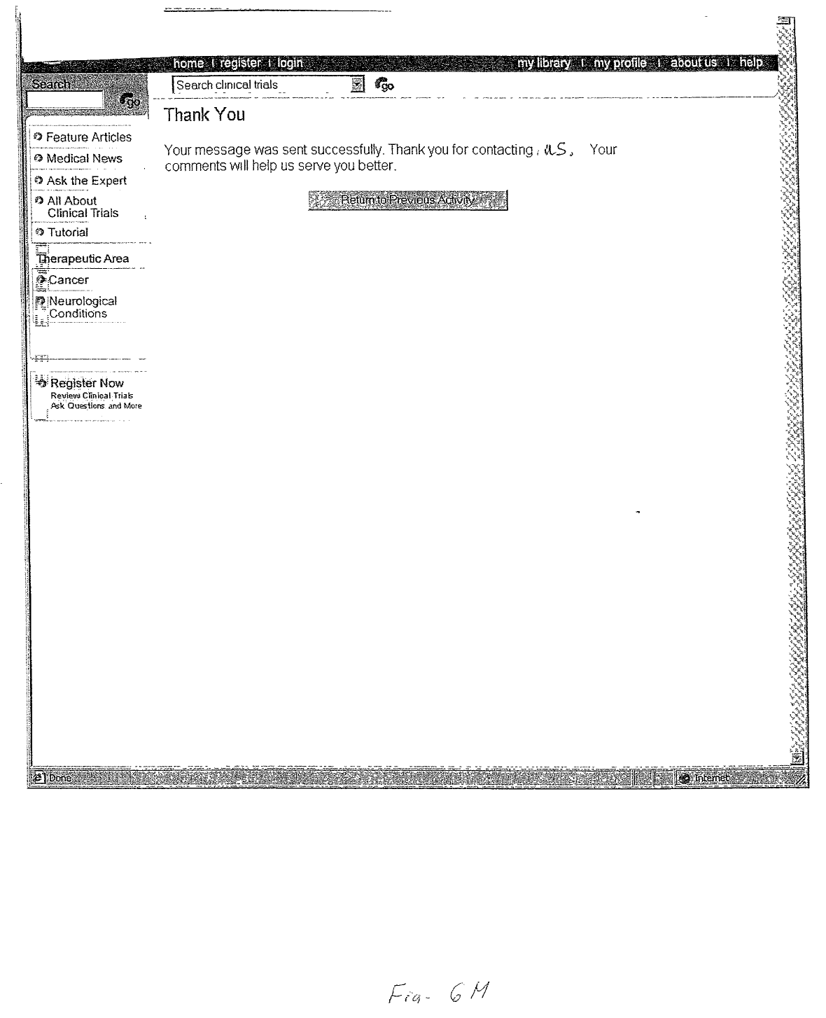

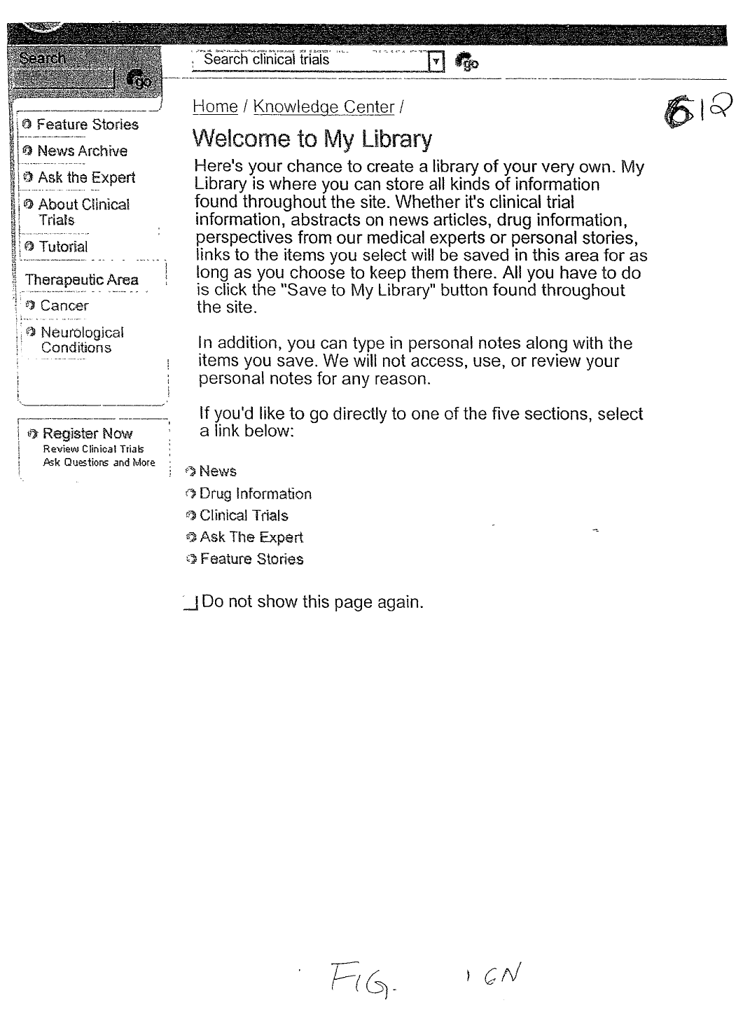

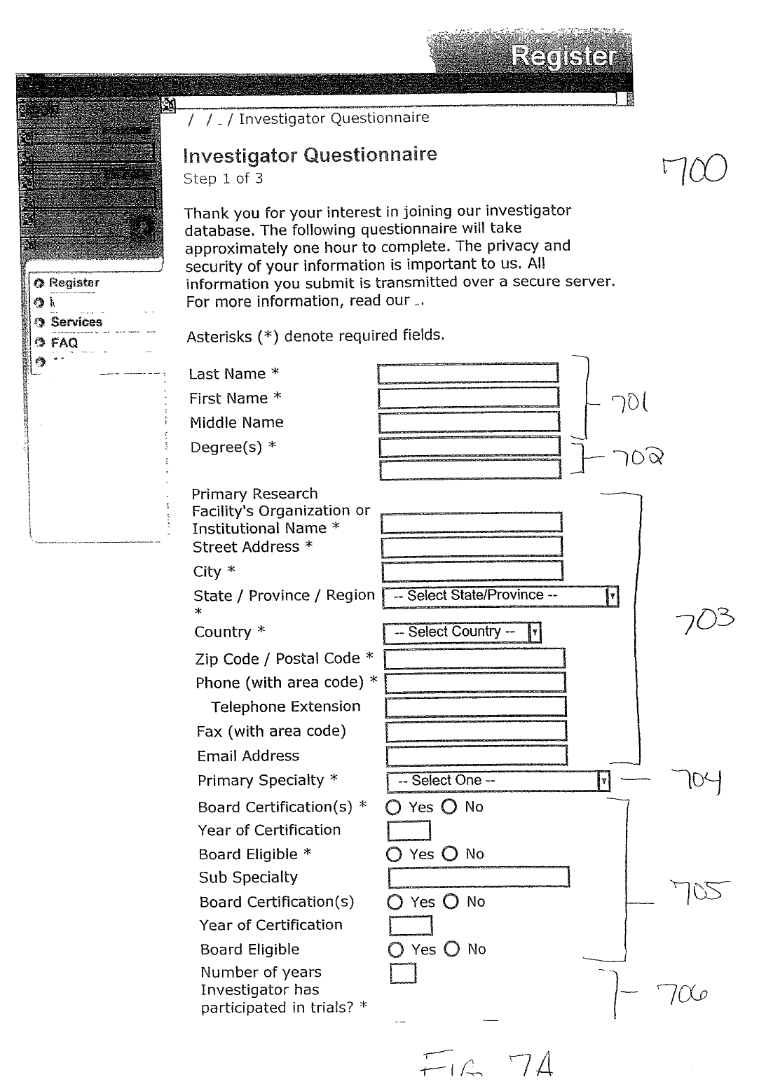

FIGS. 5A through 5F depict an exemplary web page of the subject site, which conveys information about clinical studies, and an ability to search clinical studies to a registered user, in accordance with the present invention. Frequently asked questions area 503 is provided to educate a person on clinical studies. In search area 501, the registered user may click on any one of the therapeutic areas identified (such as cancer clinical study area 502) and be taken to a search clinical study web page 600, as depicted in FIGS. 6A and 6B.

Search clinical studies web page 600 allows the user to search for clinical studies relating to the therapeutic area identified in search area 501. Search clinical study web page 600 includes search area 601 which allows the user to use particular search criteria to find clinical studies. For example the user may select a condition in condition area 602 and/or may select a state in location area 603. The user may also select a particular geographic location, in location area 603The user may indicate in contact area 604 that the person wishes to be contacted for a particular clinical study.

Upon clicking on contact area 604, the user will be taken to general study interest web page 605 shown in FIG. 6C. On general study interest web page 605, the registered user may indicate in interest area 606 whether the registered user is interested for himself/herself or for someone else. In one embodiment, the registered user may select in selection area 607 up to three therapeutic areas in which the registered user is interested. In contact area 608, the registered user indicates the manner in which the registered user would like to be contacted, e.g., by e-mail, telephone or regular mail. The registered user also indicates name and contact information in contact information area 609. The registered user submits the form by clicking on submit button 610, or may cancel the process by clicking on cancel button 611.

In other embodiments, the above-referenced information may be included in the database and entered via the web site not by the subject but by a caregiver of the subject. The caregiver may be anyone who is providing care to the subject, such as a medical professional, a family member, or a friend.

In an alternative embodiment, in order to become a user registered with the subject database, the user will be required to provide the information required as shown in the web page depicted in FIG. 6D: a user id; password; password reminder; and whether the user is seeking information for himself or herself or for someone else. In a second step, with reference to FIG. 6E, the user will be required to provide additional information such as first name, date of birth, gender, electronic mail address, zip code and an indication of one or more medical conditions in which the user is interested. Additional information, though not required for registration, may be provided such as medical conditions experienced by the user, salutation, last name, ethnic background, telephone number, country of residence, as shown in FIG. 6E. In a third step 3, the user inputs information on a web page such as that shown in FIG. 6F, including a request to receive various types of information (such as, e.g., clinical study opportunities or news and new medical therapies) about the user's medical conditions identified in FIG. 6E. The user may request that he or she not be sent any information. In area 650, the user is asked to agree to certain terms and conditions governing the user's use of the inventive system. Upon completing the required information and accepting the terms and conditions, the user will become a registered user of the inventive system, as shown in the web page depicted in FIG. 6G. At this point, the user may choose to answer additional, optional questions or to return to the previous activity. If the user chooses to answer additional questions, the user may be taken to a web pages such as those depicted in FIGS. 6H through 6J and provide information such as the type of prescriptions or over-the-counter medications taken by the user for a given medical condition; the health habits of the user; and the clinical study experience of the user. In FIG. 6K, the user can see if the user has answered completely questions about each medical condition previously listed by the user. In FIG. 6L, the user can provide feedback. In FIG. 6M, the service provider may provide a thank you to indicate that the message was sent successfully.

The registered user may also access, on the subject site, the registered user's own personal library. Library web page 612, shown in FIG. 6N, informs the registered user that he or she may maintain a personal library of information relating to clinical studies or new developments related to particular therapeutic areas found throughout the subject site. The user may also create and save personal notes relating to the same. Information may be placed in the library by the registered user or, in some embodiments, specific information on topics which may be of interest to the registered user may be placed in the registered user's library automatically based on, for example, the registered user's past selections of information to place in the library, therapeutic areas of interest, disease conditions of interest, geographic location, and/or gender.

### Investigator Registration on Professional Site

An investigator who is interested in conducting clinical studies may express his or her interest by registering on the professional site of FIG. 1B. FIGS. 7A, 7B and 7C depict investigator questionnaire web page 700 that provides a questionnaire that may be completed by an investigator interested in conducting a clinical study, in accordance with an embodiment of the present invention. In name area 701, the investigator is required to input his or her name. In degree area 702, the investigator's degree(s) are required. The PRF organization or institutional name, address, city state, country, zip code and telephone number are required (and fax and electronic mail address optionally requested) in contact area 703. Specialty area 704 requires that the investigator provide his or her primary specialty area. Board area 705 requires that the investigator indicate whether he or she is board certified and/or board eligible; optionally, the investigator's year of primary specialty board certification, and board information regarding any of the investigator's subspecialties may be provided. In study experience area 706, the investigator is required to indicate the number of years the investigator has participated in clinical studies as well as all phases of clinical research in which the investigator has participated. The investigator must include the number of investigators that conduct research at the PRF indicated in investigator area 707.

Additional information may also be provided regarding, for example, the following: the IRB with which the investigator is associated, as indicated in IRB area 708; any audits of the investigator conducted by the FDA or other regulatory agency, as indicated in FDA audit area 709; any audits of the investigator conducted by a sponsor or CRO, as indicated in sponsor audit area 710; and/or information about the investigator's PRF, such as whether it is single specialty, multi-specialty, part of a solo or group practice, or affiliated with a site management organization or research group, as indicated in PRF area 711. In alternative embodiments, an investigator provides the information requested in the investigator questionnaire by phone, fax, regular mail or other non-computerized means, rather than transmitting the information to the professional site on-line.

In addition to the information described above, an investigator may be required to include information regarding his or her publications and educational background; hospitals or PRF with which the investigator is associated; health plans with which the investigator is associated; equipment to which the investigator has access; and any sanctions imposed by the FDA or other regulatory agency upon the investigator.

### Alternative Embodiments For Subject and Investigator Registration

FIGS. 7D to 7G depict flow diagrams showing processes for registering subjects and investigators, in accordance with alternative embodiments of the present invention. FIG. 7D is directed to persons that register with the subject or investigator site based on a visit to the subject site; FIG. 7E is directed to persons that register with the subject or investigator site based on a contact with a pharmaceutical call center; FIG. 7F is directed to persons that register with the subject or investigator site based on a contact with an off-line call center; and FIG. 7G is directed to persons that register with the subject or investigator site based on a visit to a third party online recruitment site.

### Study Feasibility and Launch Process

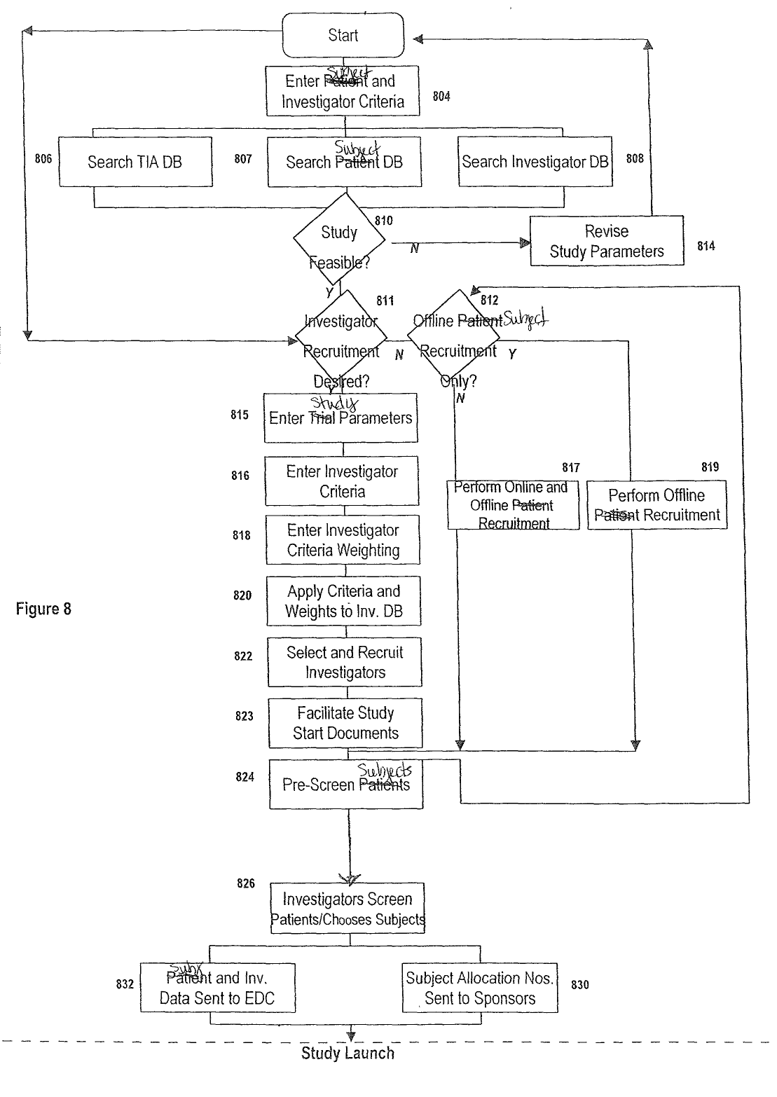

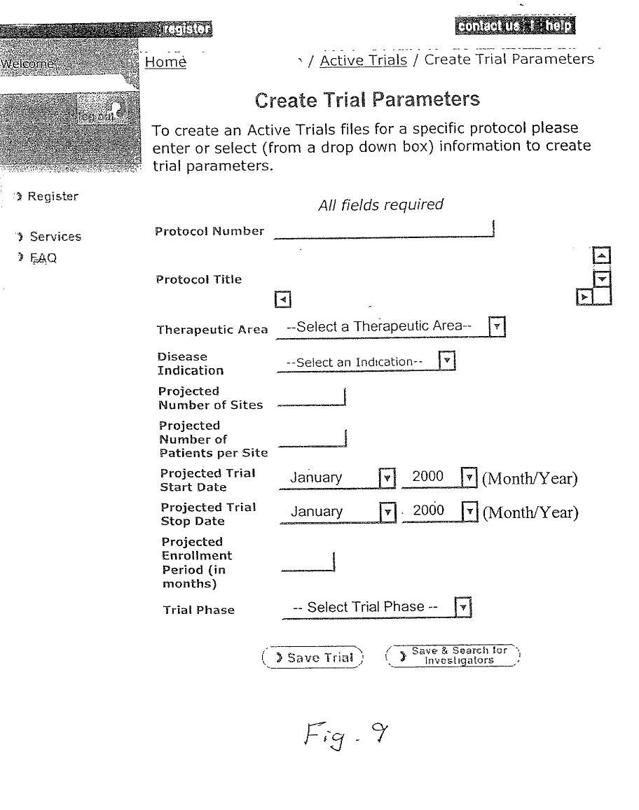

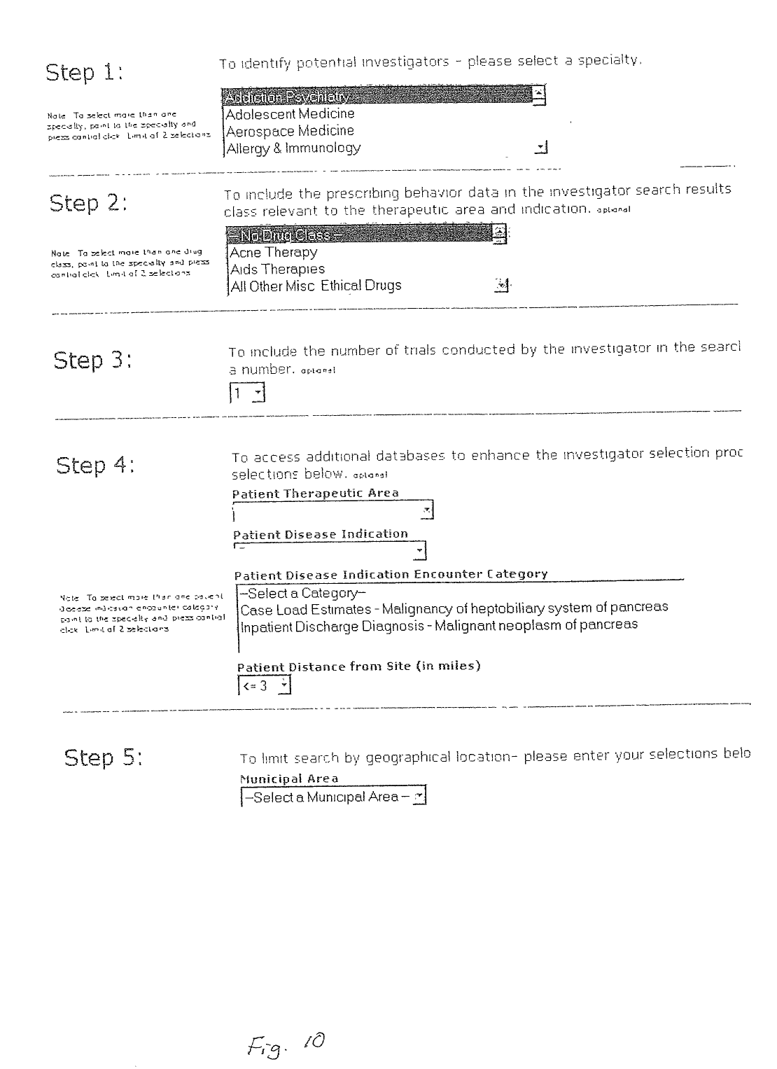

Referring now to FIG. 8, there is shown a flow diagram of a process that may be used by a sponsor to accomplish the steps necessary to start a clinical study. The process may begin at two different points. Specifically, if the sponsor wishes to begin by making a feasibility assessment with respect to the study, the process starts at step 804. Alternatively, if the sponsor does not wish to make a feasibility assessment, the process starts at step 811.

In step 804, the sponsor enters various criteria necessary to identify potential subjects and/or investigators for the study into the system. These criteria include, for example, criteria that determine which subjects may be included or excluded from the study, one or more specialties that an investigator for the study should have, information about the prescribing behavior of the investigator, the number of studies that the investigator should have conducted, the therapeutic area and disease indication associated with the clinical study, the distance around the investigator site in which subjects participating in the study should be found, and the geographic area in which the investigator should be found.

Next, in steps 806, 807 and 808, various criteria from step 804 are applied to the TIA, subjects and investigator databases in order to assess the likelihood that sufficient subjects will be available for the study, and to assess the likelihood that a sufficient number of suitable investigators will be available for the study. in applying the subject criteria to both the TIA and subject database, the present invention is able to both identify subjects in the subject database that may be appropriate for the clinical study (this information comes from the subject database), and also identify geographic areas where incidences of the relevant diseases or conditions are more prevalent (this information comes from the TIA database.) By querying the TIA database for this disease incidence/prevalence information, the system is able to identify geographic areas where potential subjects (not listed in subject database) may be more likely to be found using off-line and/or on-line recruiting not involving the subject database. In addition, the geographic locations of investigators who may qualify for the study are compared against the TIA search results and the search results from the subject database (specifically, the locations of such subjects) in order to identify investigators with the highest likelihood of fulfilling the enrollment requirements of the study because they are located proximate to where there are the largest numbers of suitable subjects. This aspect of the assessment process recognizes that, in the case of some studies, potential subjects may be unwilling to travel any significant distance to participate in the study, while, for other studies, potential subjects may be prepared to travel great distances. Therefore, even if an investigator is otherwise qualified to perform the study, if sufficient subjects are not located proximate to the investigator's site, it may be more challenging for the investigator to fulfill the subject recruitment required for the study. By correlating the geographic location of suitable subjects from the subject database and locations having a relatively higher incidence or prevalence of the disease associated with the study (from the TIA database) to the locations of suitable investigators listed in the investigator database, the present invention is able to locate investigators who are not only qualified, but also proximate to large numbers of subjects, and thus have the greatest likelihood of fulfilling the sponsor's expectations with respect to both enrollment and quality of performance.

Following the review of the search results from steps 806, 807 and 808, the sponsor makes a subjective assessment in step 810 as to the feasibility of the study based on the results obtained from the TIA, subject and investigator databases. In this step, the sponsor determines whether there is a sufficiently large pool of potential subjects who are close enough geographically to a potential investigator to make the study feasible. If, in step 810, the sponsor concludes that it would not be feasible to recruit sufficient suitable subjects and/or investigators for the study, the sponsor is given an opportunity to revise the subject and investigator criteria entered in step 804 in an effort to arrive at a feasible study. In accordance with this aspect, the sponsor repeats the process described above using revised subject and investigator criteria until the sponsor finds a study for which subject and investigator recruitment appears feasible.

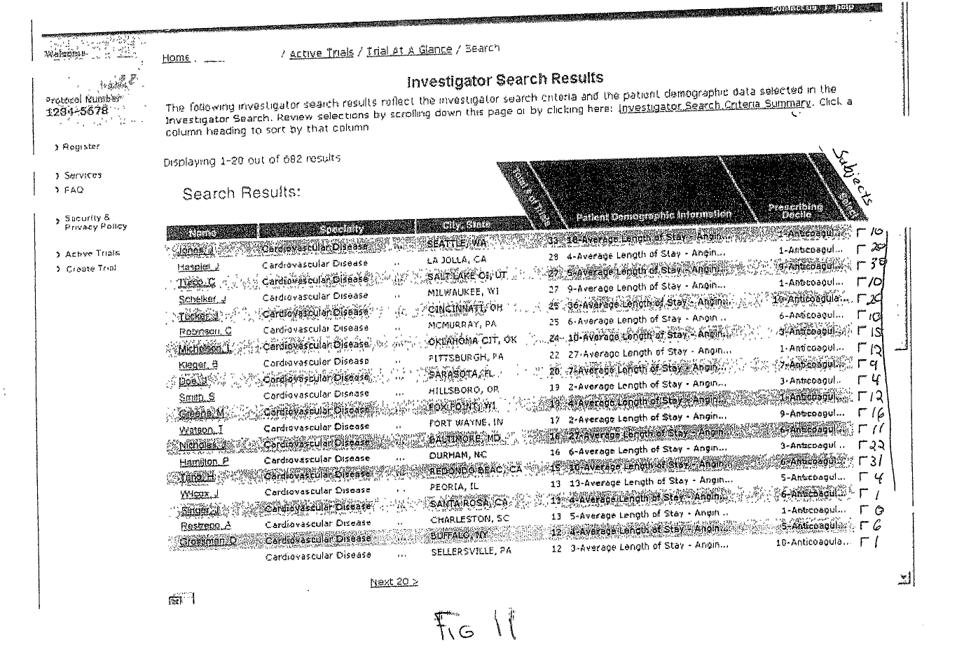

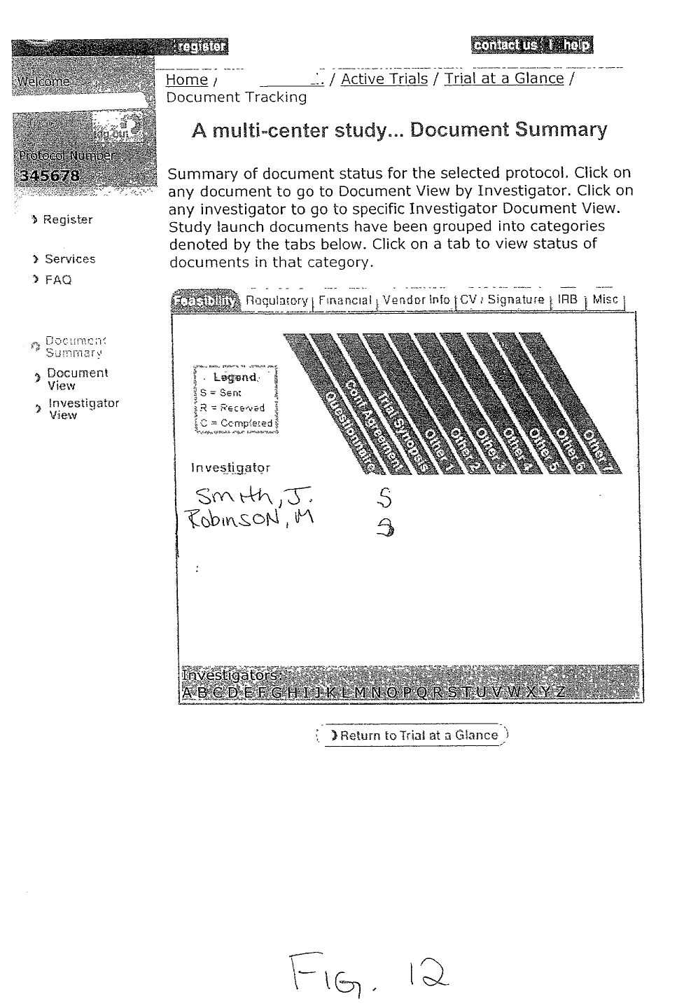

The sponsor reaches step 811 either as an entry point into the process, or after the sponsor has determined in step 810 that the study is feasible. In step 811, the sponsor determines whether the sponsor desires to use the investigator database to perform investigator recruitment for the study. If the sponsor wishes to use the investigator database for investigator recruitment, then in step 815, the sponsor begins by entering study parameter information into the system. A screen shot of a web page that may be used for entering this information is shown in FIG. 9. In this step, the sponsor enters various parameters about the study into the system. Next, in step 816, the sponsor enters investigator search criteria for the study into the system. Such search criteria could include, for example, one or more specialties that would be desirable for an investigator for the study, information about the prescribing behavior of the investigator, the number of studies that the investigator has conducted, the therapeutic area and disease indication associated with clinical studies previously conducted by the investigator, the distance around the investigator site in which subjects participating in the study should be sought, and the geographic area in which the investigator should be located. FIG. 10 is a screen shot of an exemplary web page that may be used by a sponsor to input the investigator search criteria into the system. In step 818, the sponsor is given the ability to weight one or more of the investigator criteria prior to initiating the investigator search.

In step 820, the investigator criteria and any weight applied by the sponsor, are applied to the investigator database in order to identify potential investigators for the clinical study. In one embodiment, results from queries to the TIA and subject databases for the study are also incorporated into the investigator selection process. By correlating the geographic location of suitable subjects from the subject database and locations having a relatively higher incidence or prevalence of the disease associated with the study (from the TIA database) to the locations of suitable investigators listed in the investigator database, the present invention is able to identify in step 820 investigators who are not only qualified, but also proximate to where potential subjects with the relevant disease live or are willing to travel.

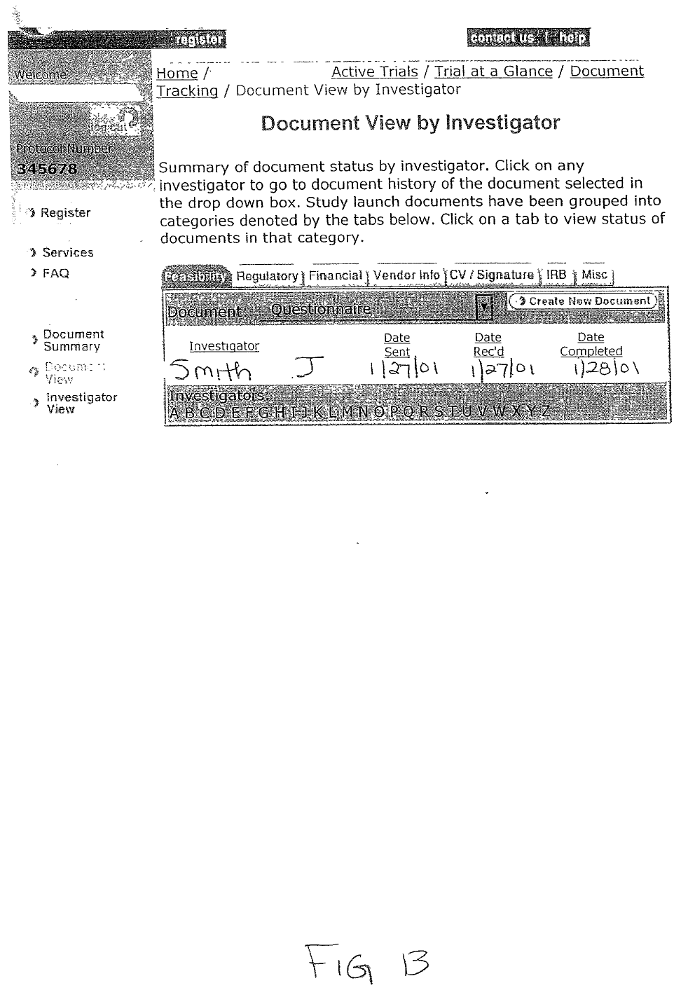

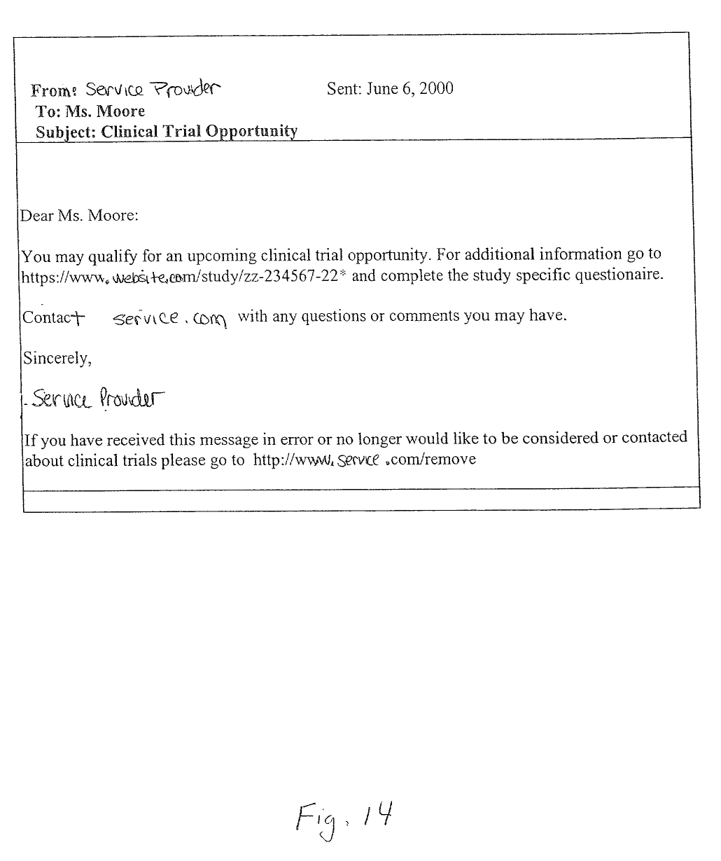

An exemplary web page that shows the results of an investigator search in accordance with the present invention is shown in FIG. 11. As shown in that figure, for each investigator identified in the search, the sponsor is shown the name of the investigator, the investigator's specialty, the city/state in which the investigator is located, the number of studies that the investigator has performed, subject demographic information obtained from the TIA database (i.e. the number of persons listed in the TIA database that are within a predetermined distance of the investigator site and who could potentially qualify as subjects for the clinical study), subject demographic information obtained from the subject database (i.e. the number of subjects listed in the subject database that are within a predetermined distance of the investigator site and who could potentially qualify to participate in the clinical study), the drug prescribing behavior of the investigator (e.g., the drug class prescribing decile associated with the investigator). It will be understood by those skilled in the art that other criteria relevant to the investigator could also be shown on this search results screen including for example, the behavior of the investigator with respect to ordering of laboratory tests/procedures.

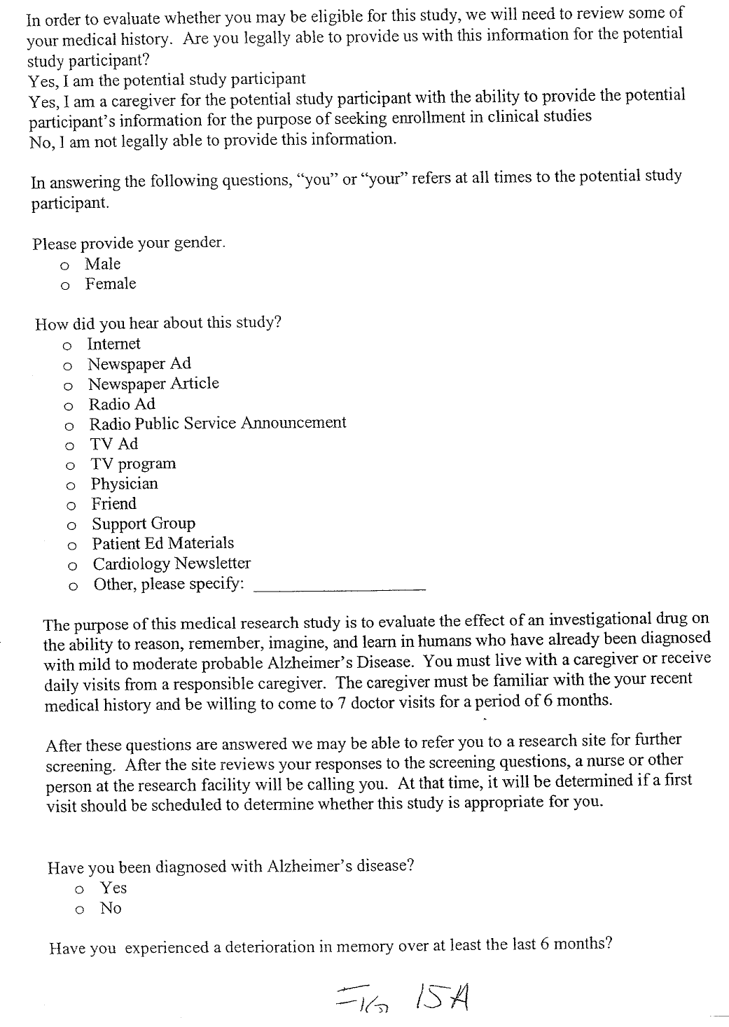

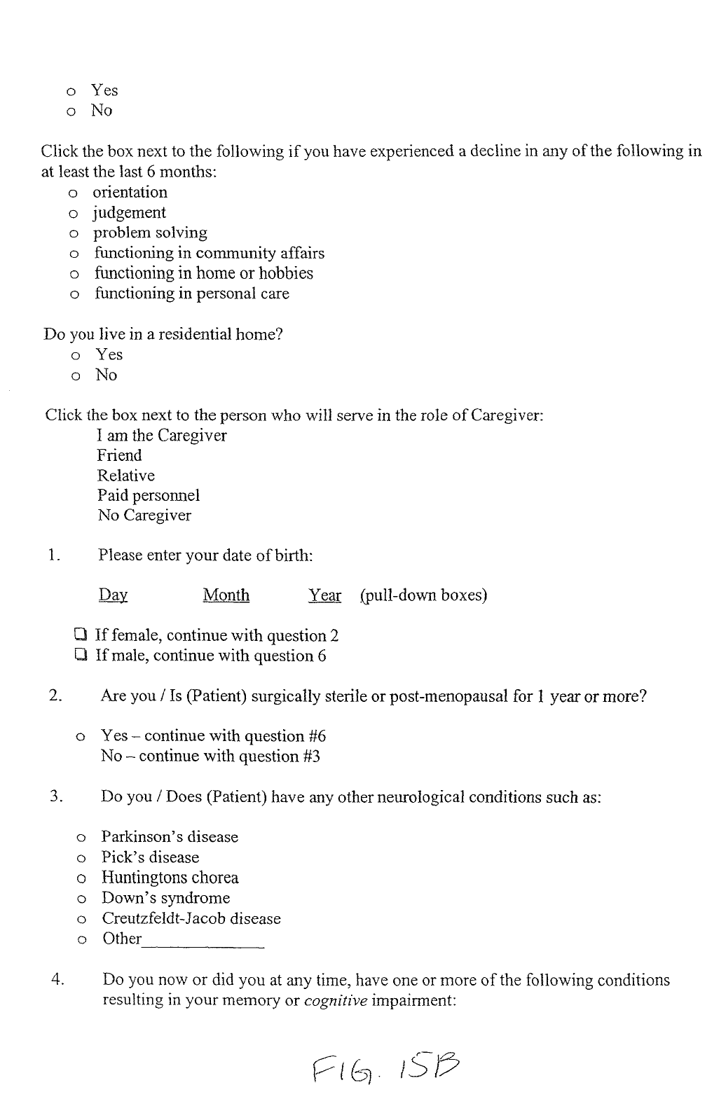

In step 822, the sponsor selects one or more investigators for the clinical study, and in step 823 begins the process of engaging the investigator(s) for the study. As mentioned above, this process is accomplished using a secure extranet embodied by the professional site. This extranet preferably includes document templates that allow sponsors (and/or investigators) to quickly generate documents relevant to the launch of a clinical study. These documents include for example, an initial questionnaire that a sponsor may send a potential investigator in order to more fully assess whether or not the investigator would be appropriate to conduct the clinical study. Other documents that may need to be in place before the study is started include a confidentiality agreement between the sponsor and investigator, and a synopsis of the study to be completed. These documents are preferably created using standard templates found in the workspace on the professional site associated with each sponsor or investigator. These documents are also preferably exchanged between the sponsor and investigator only within the extranet thereby insuring that confidentiality of such documents is securely maintained and tracked, and allowing separate version control for each of multiple investigators being recruited for the same study. FIGS. 12 and 13 are screen shots of web pages from the professional site showing use of the extranet for the creation and tracking of documents necessary for the start of a clinical study. The failure to complete or provide any of the documents required to start the study may be fatal to the investigator recruitment process, and may require repetition of the process (from either step 816 or 822) until the investigator recruitment process can be completed.

After step 823, the sponsor decides whether the sponsor is interested in using the subject database to identify potential subjects for the study. If the sponsor is interested in using on-line and/or off-line patient recruitment and retention services, then in step 817 a combination of online recruitment and off-line recruitment is used to identify potential subjects for the study. In the on-line recruitment process, the sponsor enters various criteria necessary to identify potential subjects for the study into the system. These criteria include, for example, the inclusion/exclusion criteria of subjects for the study, the therapeutic area and disease indication associated with the clinical area, and/or the distance around the investigator site in which subjects participating in the study should be found. The subject criteria are then applied to the subject database, in order to identify on-line potential subjects for the study.

Off-line recruitment is used for identification of potential subjects either by itself (step 819) or in combination with on-line recruiting techniques (step 817). Off-line recruiting is how most participants for clinical studies are currently recruited in prior art systems, and this method involves making contact through media with a potential subject in order to attempt to recruit the subject for a given clinical study. In performing off-line recruiting, the sponsor may optionally use results from a search of the TIA database to assist in identifying a geographic area where subjects for study are more likely to be found.

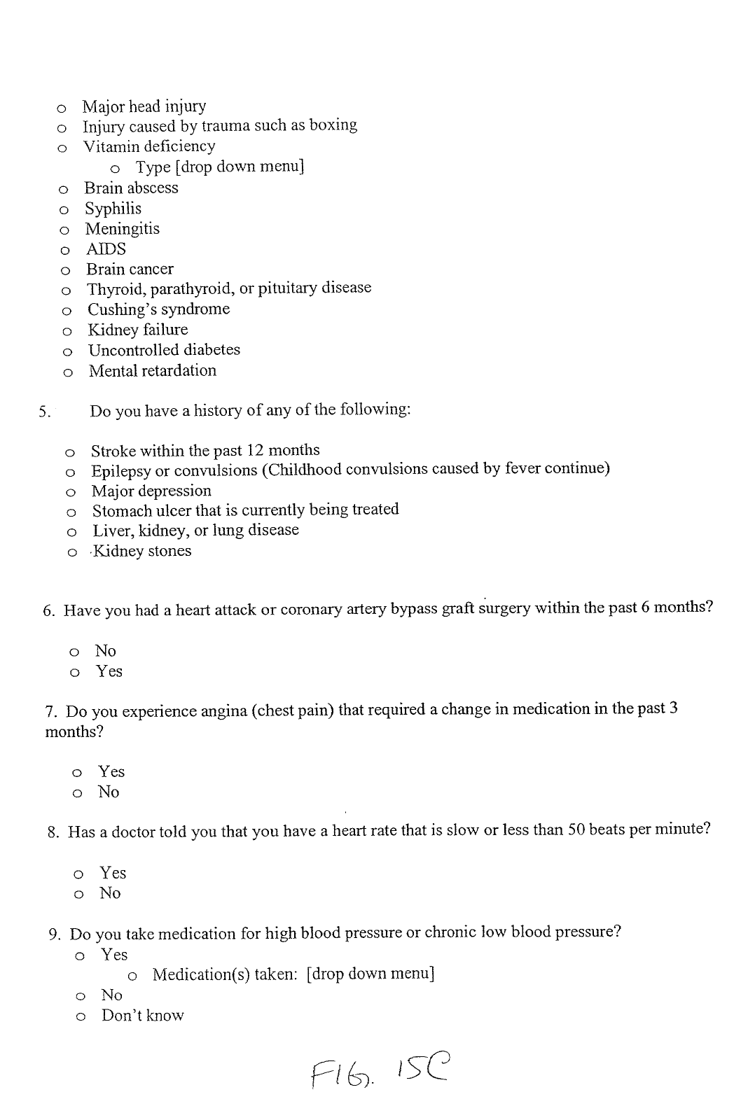

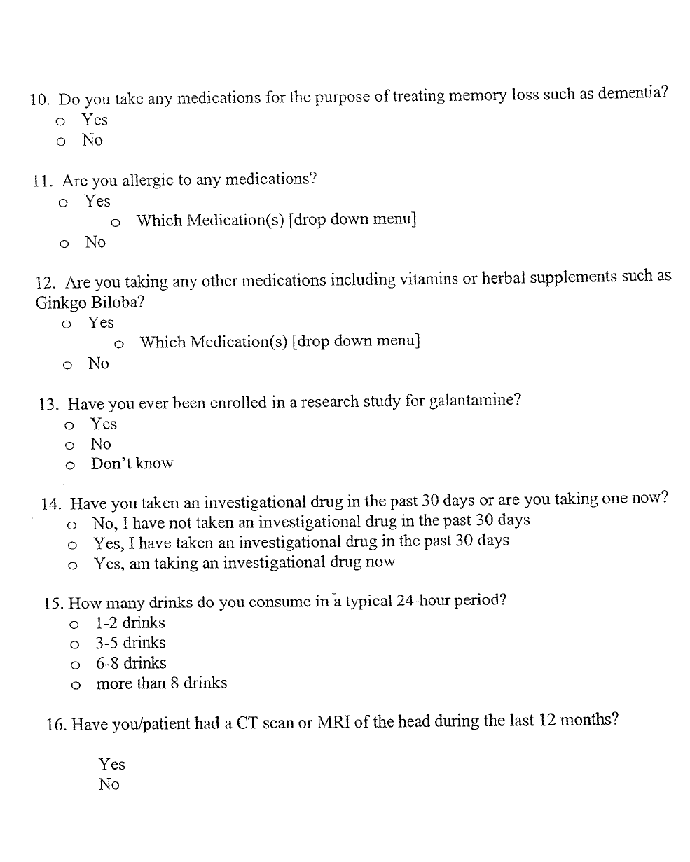

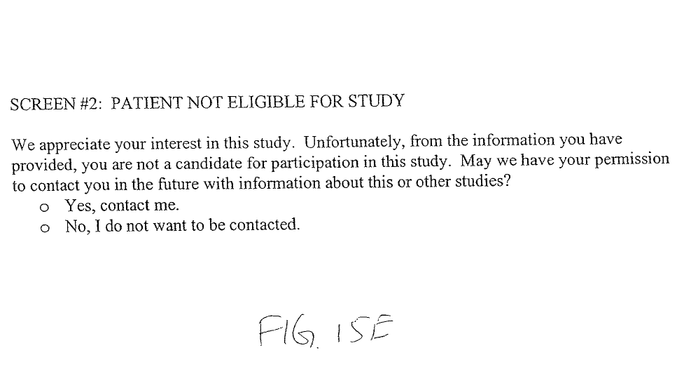

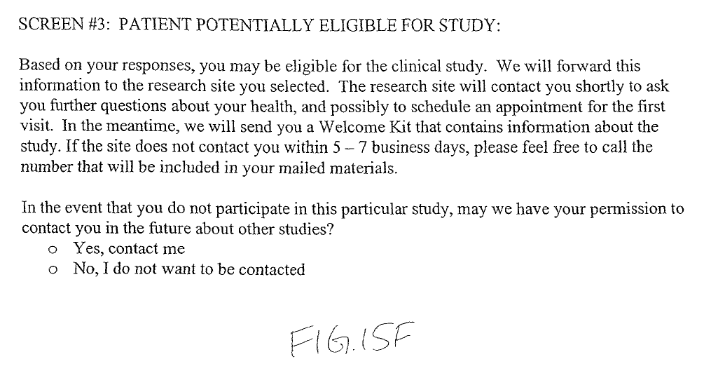

After a potential subject has been identified (step 817 or 819), the process of prescreening for participation in the study begins (step 824). In this step, subjects identified using on-line and/or off-line recruitment are notified, and asked whether or not they have an interest in participating in the clinical study. In the case of candidates that were identified on-line using the subject database, the subjects are preferably contacted by the means that they identified during their registration on the subject site (e.g., by electronic mail) in order to preliminarily determine whether they have an interest in participating in the clinical study. A screen shot of an exemplary e-mail used for providing such a notification to a potential subject is shown in FIG. 14. The notification could alternatively be provided using telephone, mail, fax or any off-line communication means. If a potential subject responds to a notification by indicating interest in participating in a clinical study, the subject is provided with a formal questionnaire that asks for information specifically relevant to the clinical study. An exemplary study-specific subject questionnaire is shown in reference to FIGS. 15A-15F. In the preferred embodiment, if in response to the e-mail notification shown in FIG. 14, the subject indicates interest in participating in the clinical study, a study-specific subject questionnaire such as shown in FIGS. 15A-15F is provided to the subject on a secure web page found on the subject site. The subject then uses this secure web page to answer all of the questions in the subject questionnaire, and to submit such answers for consideration. As mentioned above, irrespective of whether the subject is ultimately selected for participation in the clinical study, these questionnaire answers are stored in the subject database with the consent of the patient, thereby enriching the subject information stored in that database.

Following the pre-screening process described above, a list of pre-screened subjects who may be eligible to participate in a clinical study is given to the investigator. Next, in step 826, the investigator schedules an appointment with each of the subjects on his or her pre-screened list. The subject gets examined and signs an informed consent before the investigator can enroll the subject in a study. In step 830, allocation numbers for each of the subjects selected by the investigator for the clinical study are provided to the sponsor. Since the sponsor must be blind to the identities of the subjects participating in the study, the sponsor is provided with only allocation numbers of the subjects, and no identifying information (such as the name or address of such individuals) is provided to the sponsor.

Finally, in step 832, information about each of the subjects participating in the study is provided electronically from system I 00 to an electronic data capture (“EDC”) company. EDCs are typically used during the performance of a study to store and capture data from investigator(s). By electronically providing information about each of the subjects in the study to the EDC prior to start of the clinical study, the present invention facilitates the set-up of the EDC database prior to the start of a clinical study. In one embodiment, the present invention includes several different data conversion templates, each of which converts subject data (from the subject database) to a format associated with a given EDC, prior to transmission of any subject data to such EDC.

In some embodiments, the inventive system may be linked to the systems of other entities involved in the clinical studies process, thereby creating an automated clinical studies system from compound development through study feasibility and subject/investigator recruitment, study conduct and post-study marketing.

The sponsor may use the inventive system to identify both investigators and subjects, may have engaged an investigator and simply be recruiting subjects, may be looking for an investigator to take over an ongoing study, or may be looking for an investigator who will then recruit subjects.

### Specific Investigator Identification Embodiments

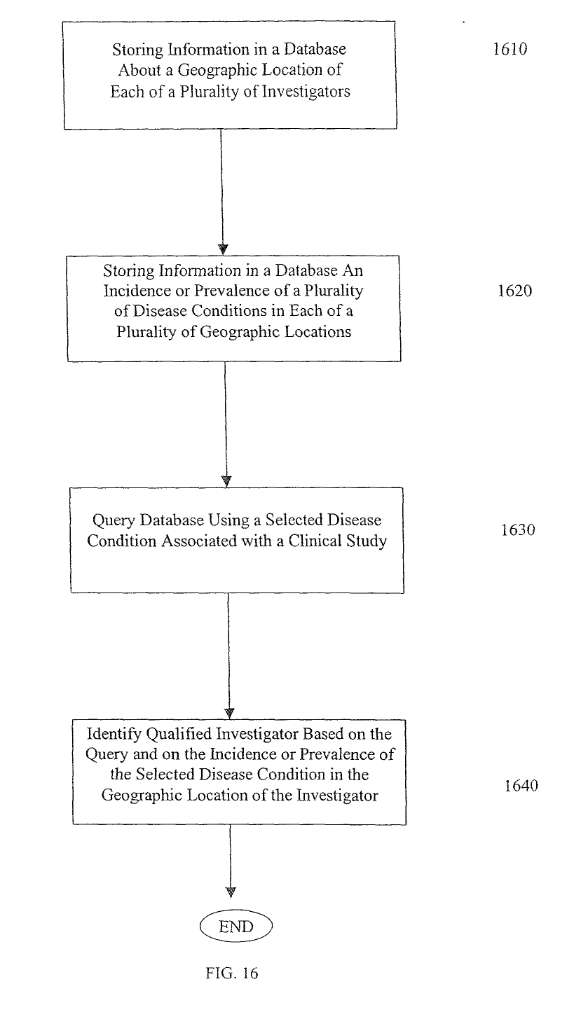

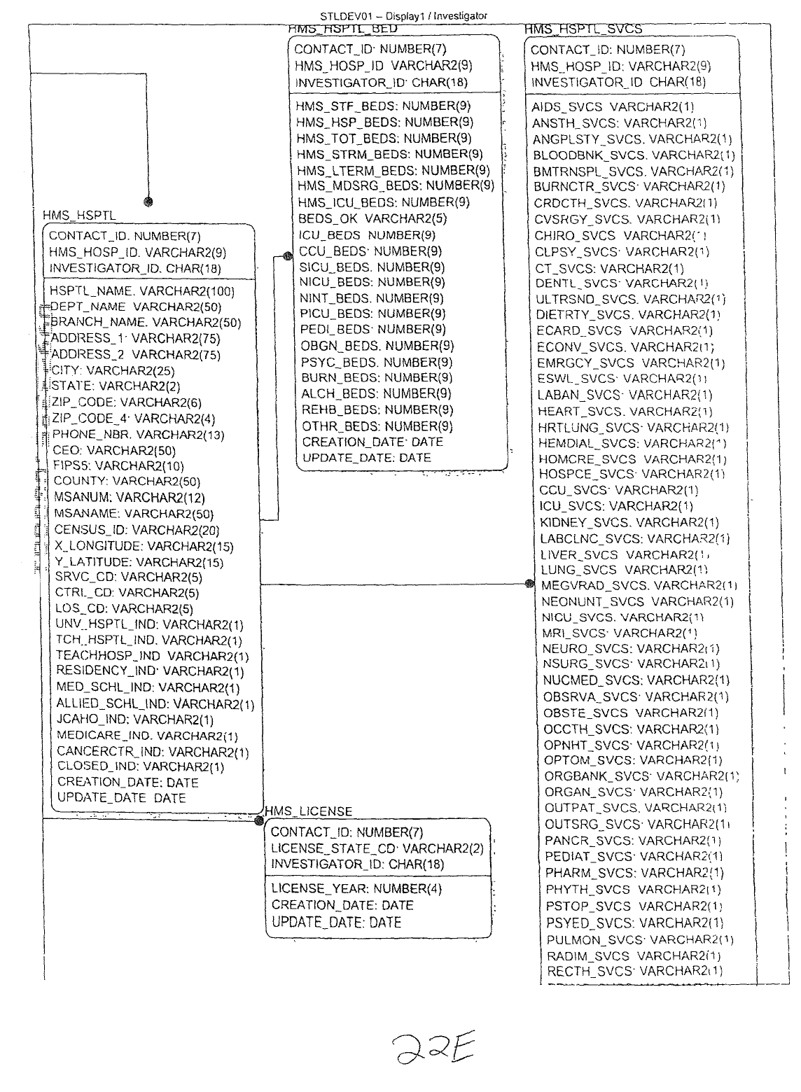

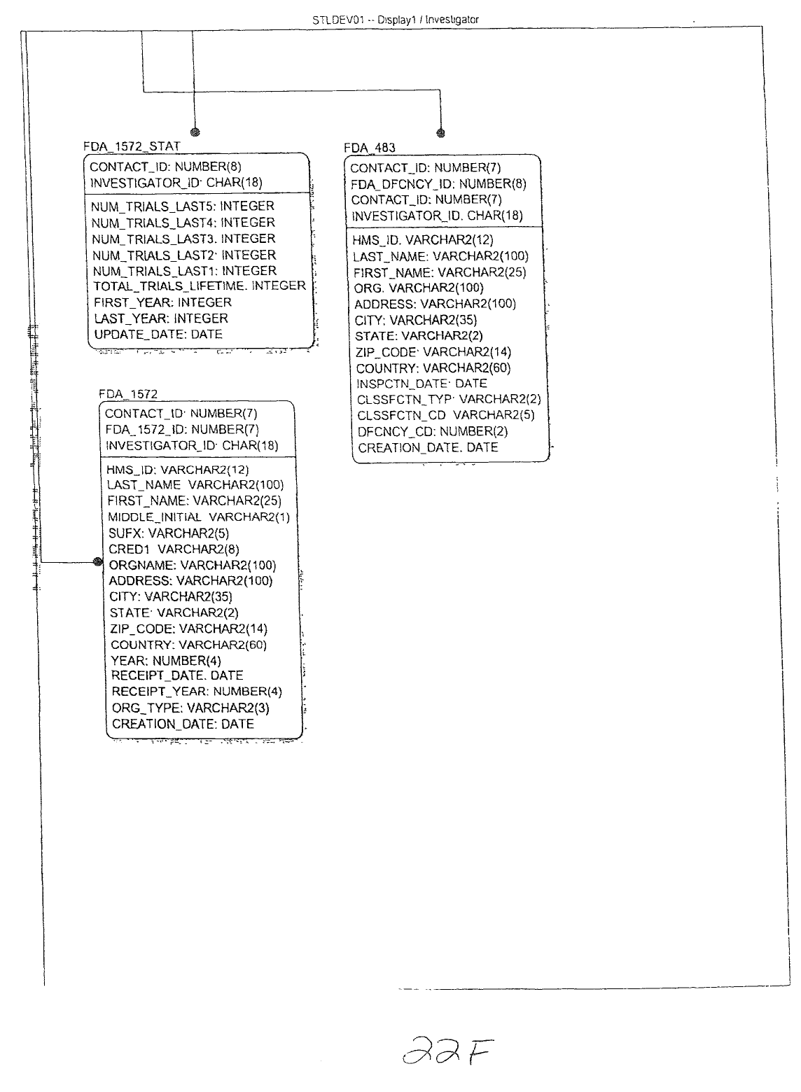

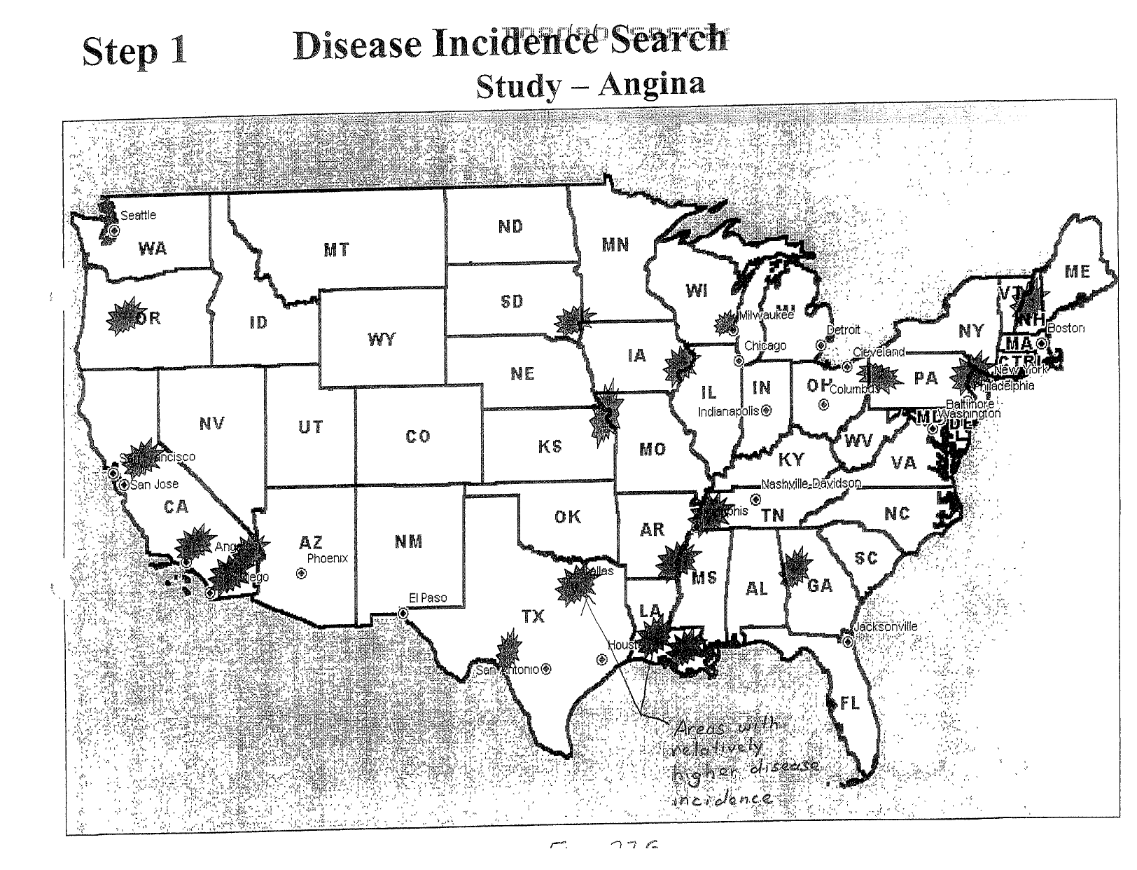

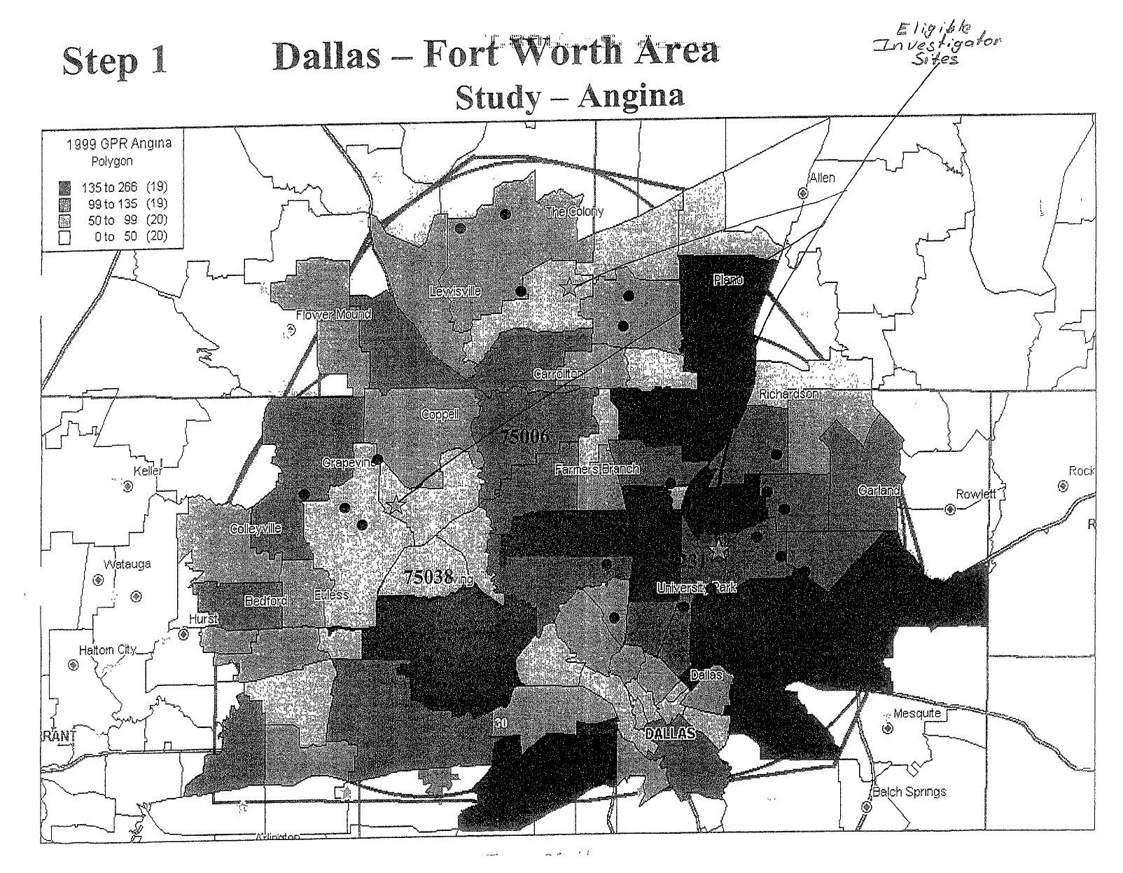

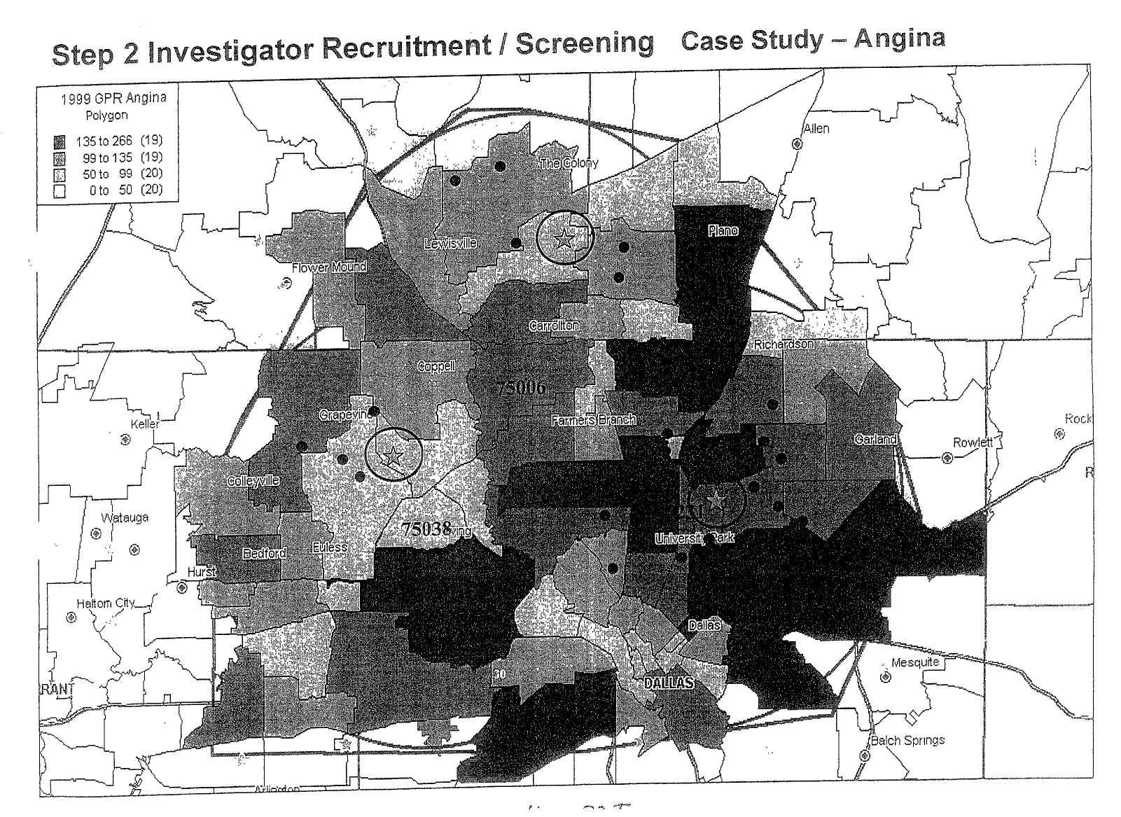

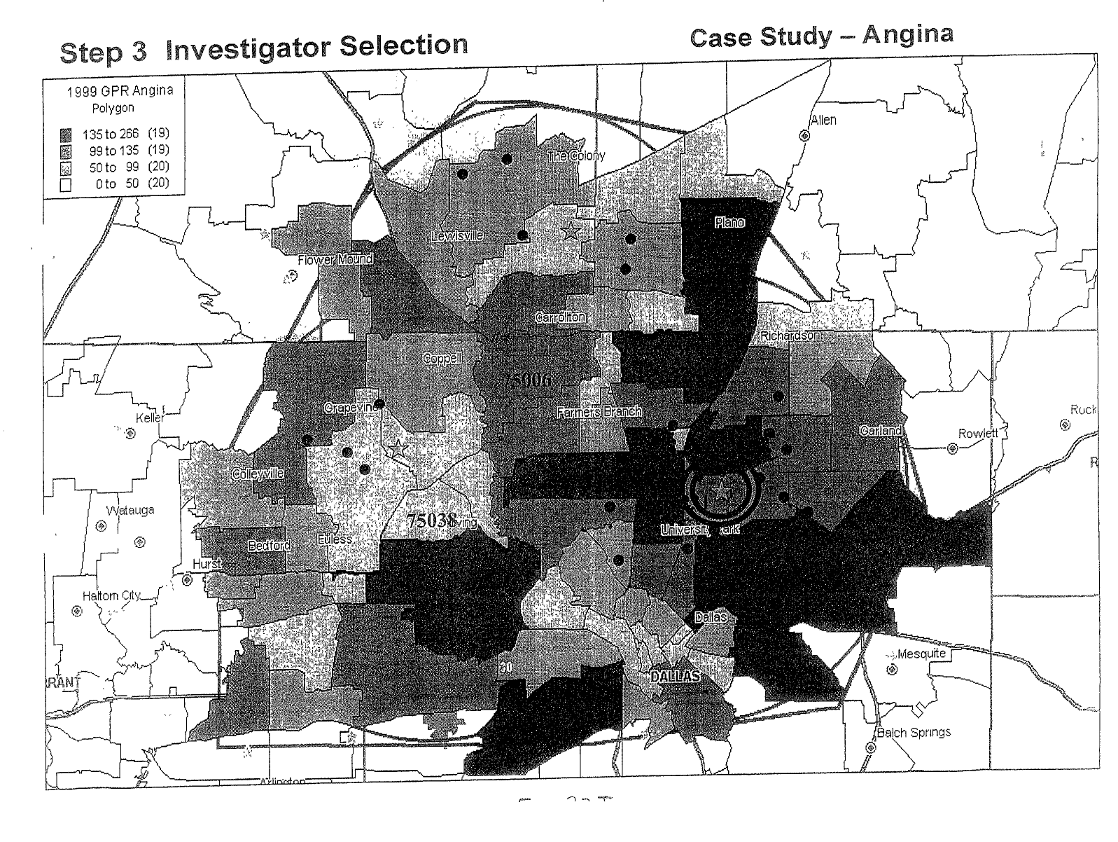

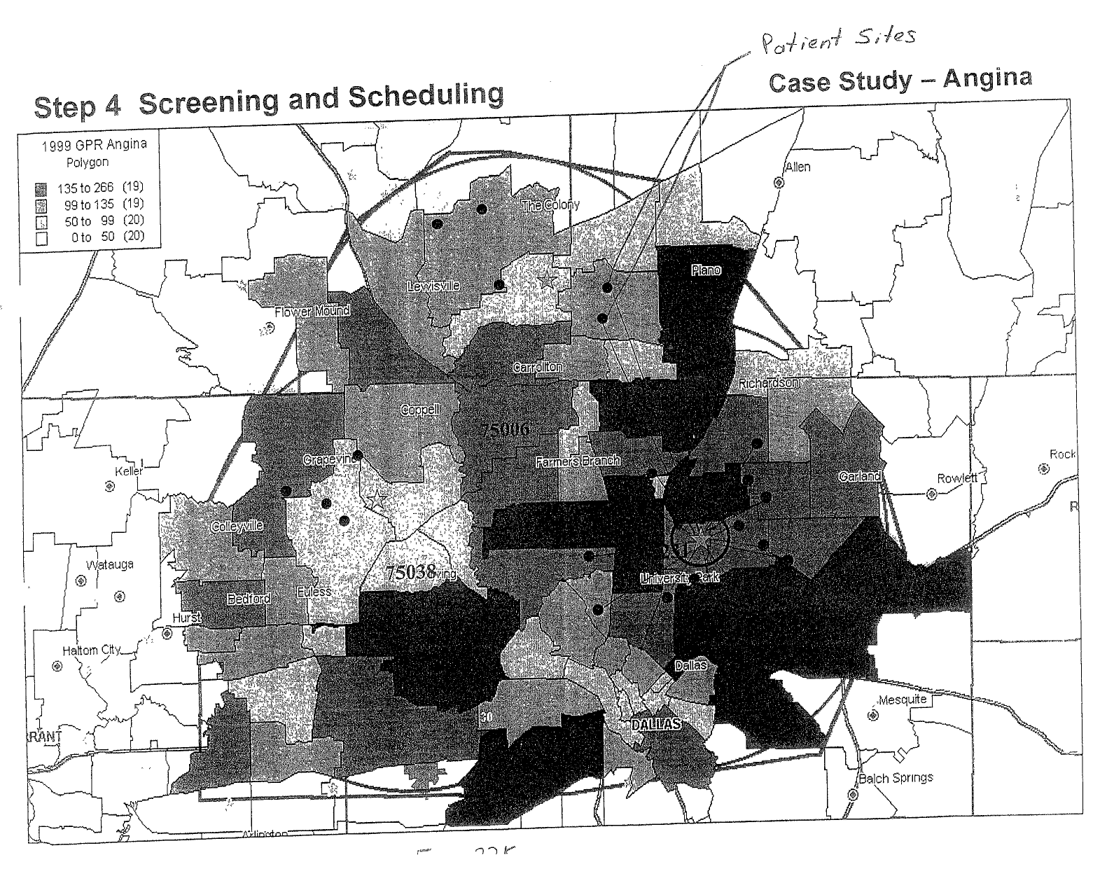

FIG. 16 is a process flow diagram of a method for identifying eligible investigators for a clinical study in accordance with one embodiment of the present invention. Specifically, at step 1610, information is stored in database 2200 of the inventive system (in particular, the data is stored in table 2252, field 2252a of FIG. 22B) relating to the geographic location of each of a plurality of investigators. At step 1620, an incidence or a prevalence of each of a plurality of disease conditions in a plurality of different geographic locations is stored in the database.

At step 1630 the system queries the database for a selected disease condition associated with the clinical study at issue. The query results in a list of locations wherein there is a relatively greater incidence or prevalence of the selected disease condition. From the result of this query, the system identifies both investigators that may qualify to perform the clinical study based upon the geographic location of the investigator compared with the query result, as shown at step 1640, and potential registered subjects. Thus, an investigator located where there is a requisite incidence or prevalence of the selected disease condition is potentially eligible.

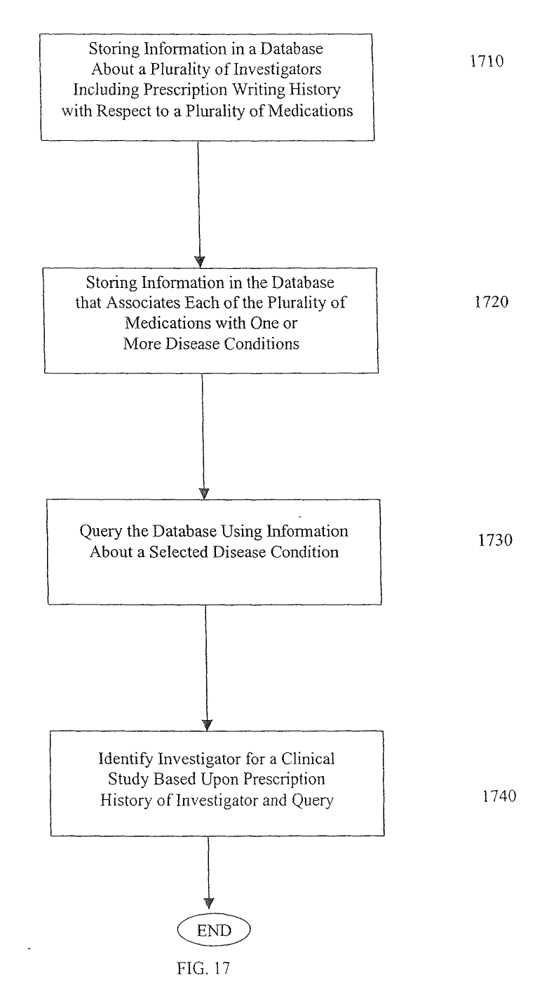

FIG. 17 is a process flow diagram showing the steps of a method for identifying eligible investigators for a clinical study in accordance with another embodiment of the present invention. At step 1710, information is stored in the inventive system database relating to prospective investigators for clinical studies. This information includes information regarding the prescription writing history of each of the investigators with respect to a plurality of classes of medications. The prescription writing history information is provided by a third party.

At step 1720, information is stored in the database that associates each of the plurality of medications discussed above with one or more disease conditions. At step 1730, the database is queried wherein information representing a selected disease condition associated with the specific clinical study is used. The query will result in correlation between the specific disease condition and related prescriptions. At step 1740 the inventive system identifies an investigator based upon the query results and the investigator's prescription writing history. The determination may be based, for example, upon the volume of prescriptions for the medications written by the investigator as compared to the volume of prescriptions for that medication written by other physicians. The determination may vary depending upon the specific clinical study, and will be known to those skilled in the art and is within the scope of the present invention.

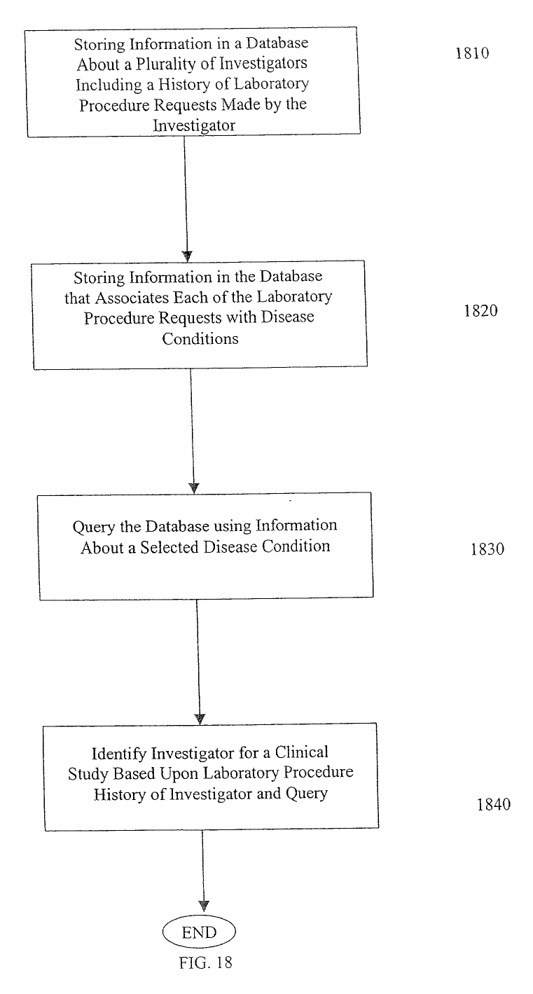

FIG. 18 is a process flow diagram depicting the steps of a method for identifying eligible investigators for a clinical study in accordance with yet another embodiment of the present invention. At step 1810, information is stored in the inventive system database relating to prospective investigators for clinical studies. This information includes information regarding the history of each investigator's request for laboratory procedures (e.g., blood work for subjects, urinalysis, EKG, etc.). Other requests will be known to those skilled in the art and are within the scope of the present invention.

At step 1820, information is stored in the database that associates each of the laboratory procedure requests discussed above with one or more disease conditions. At step 1830, the database is queried wherein information representing a selected disease condition associated with the specific clinical study is used. The query will result in correspondence between the specific disease condition and related laboratory procedures. At step 1840 the inventive system identifies an investigator based upon the query results and the investigator's laboratory procedure requests. The determination may be based upon the fact that the investigator has never requested a certain laboratory procedure, or always prescribes a certain laboratory procedure. The determination may vary depending upon the specific clinical study, and will be known to those skilled in the art and is within the scope of the present invention.

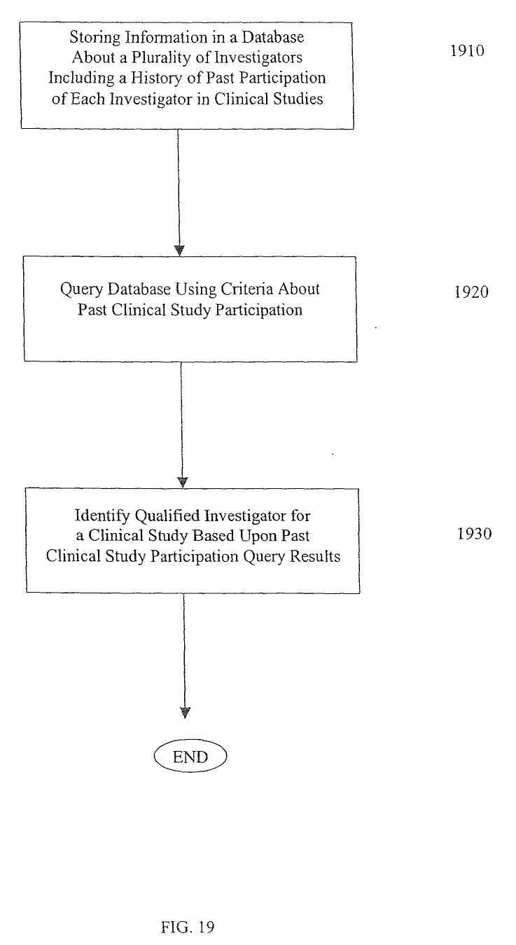

FIG. 19 is a process flow diagram depicting the steps of a method for identifying eligible investigators for a clinical study, in accordance with yet a further embodiment of the present invention. With reference to FIG. 19, in step 1910, information regarding a plurality of investigators is stored in a database. Such information includes the history of each investigator's past participation in clinical studies. The history information is stored in a database of the inventive system (shown at table 2220, field 2220A of FIG. 22A). In step 1920, the database is queried using criteria about past clinical study participation. In step 1930, a qualified investigator for a clinical study is identified based on the results of the query regarding past clinical study participation.

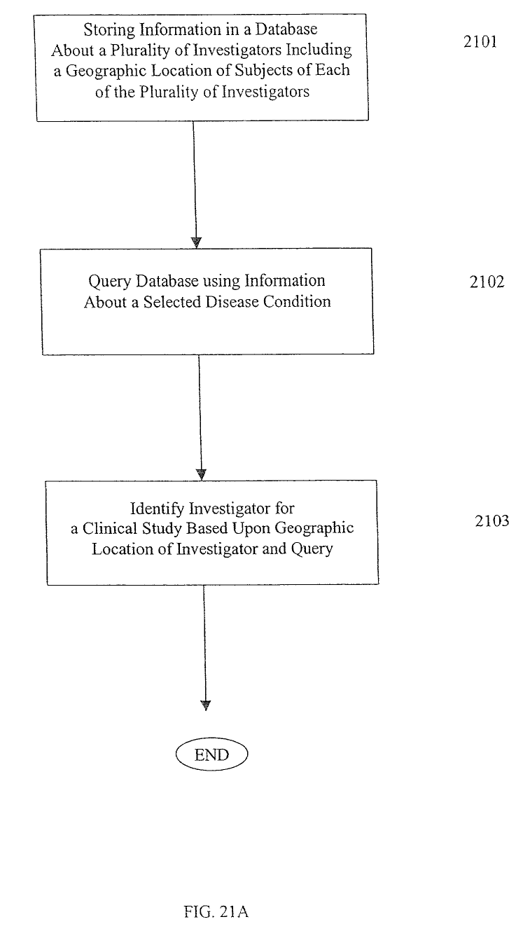

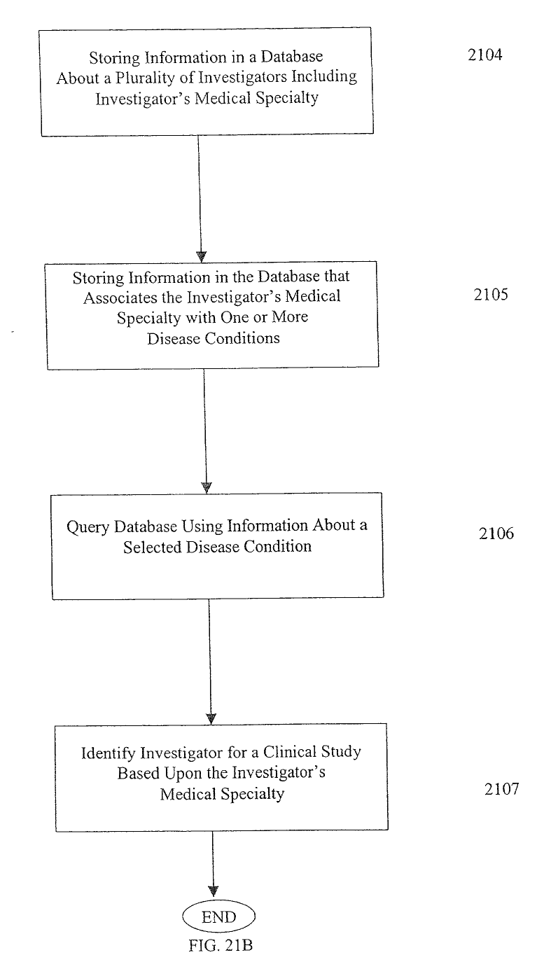

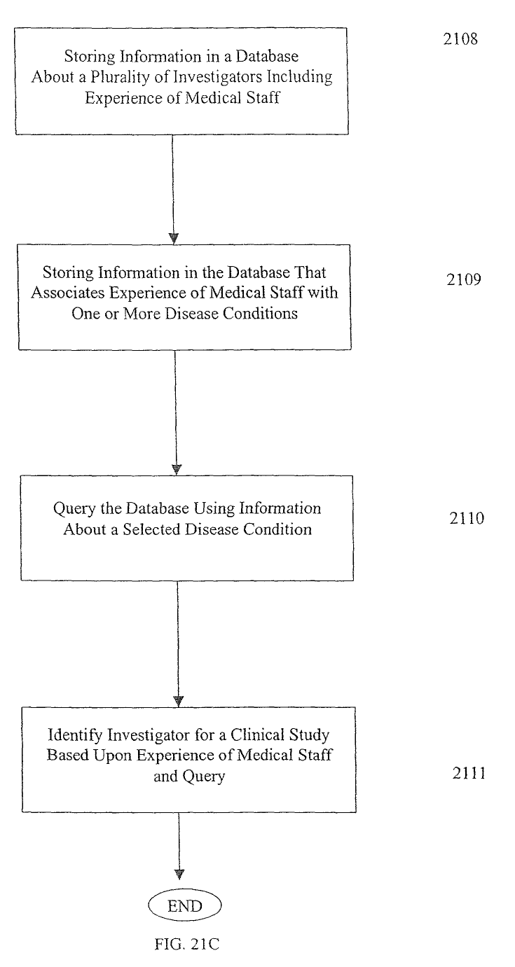

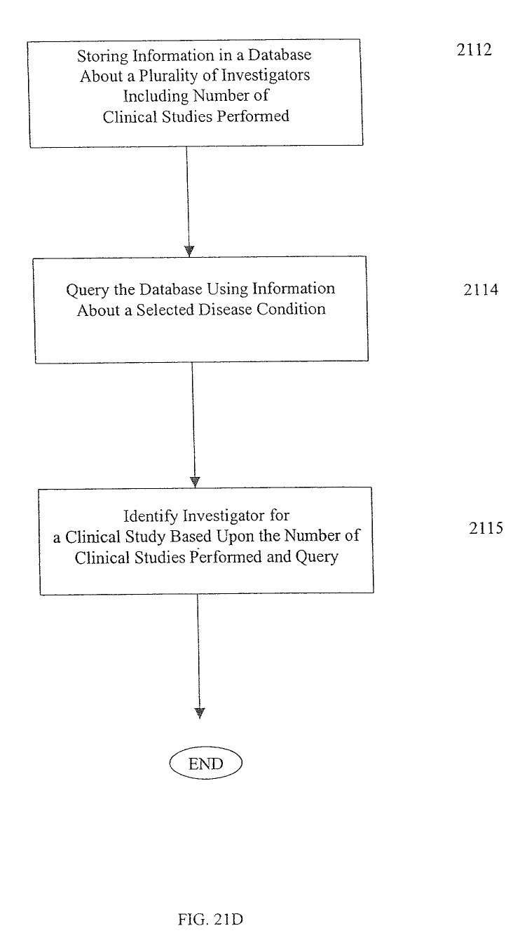

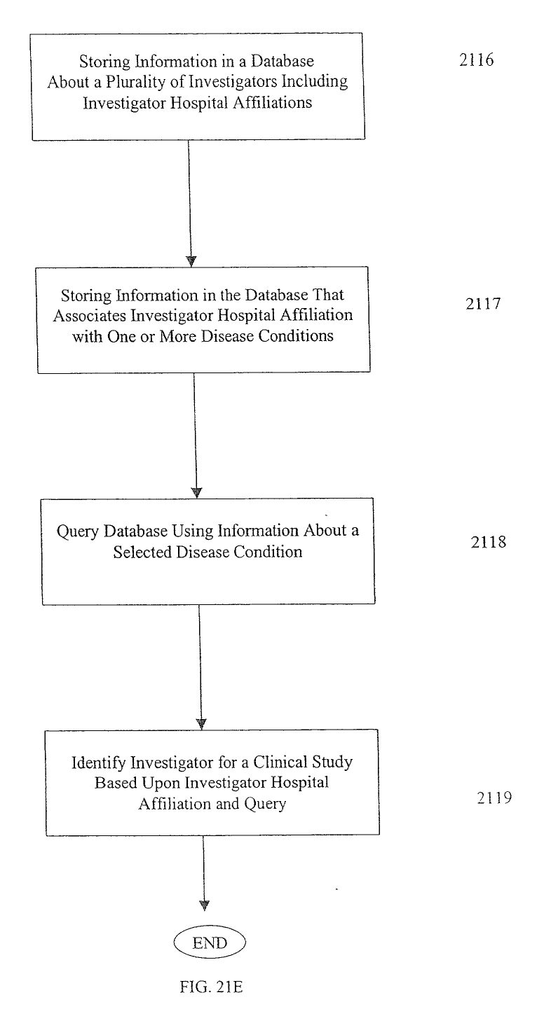

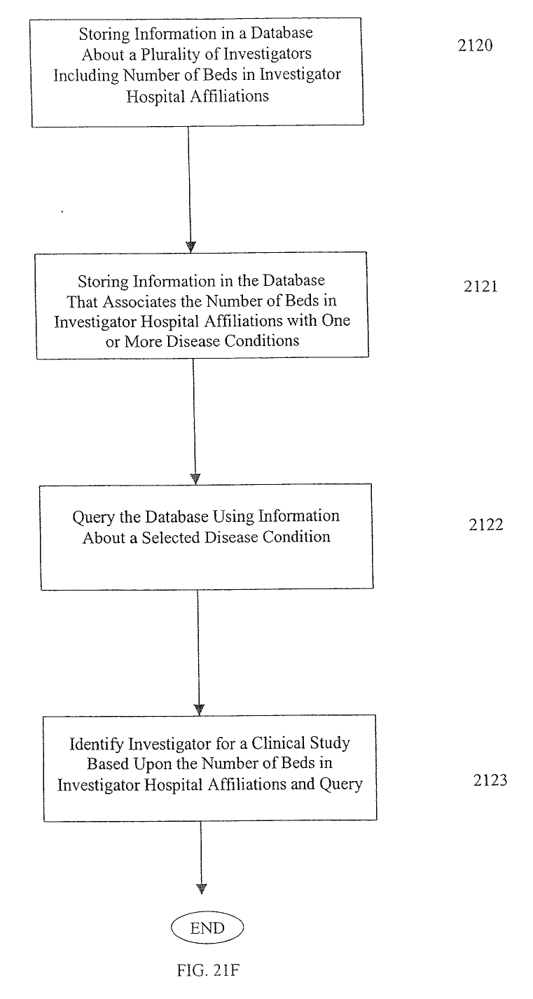

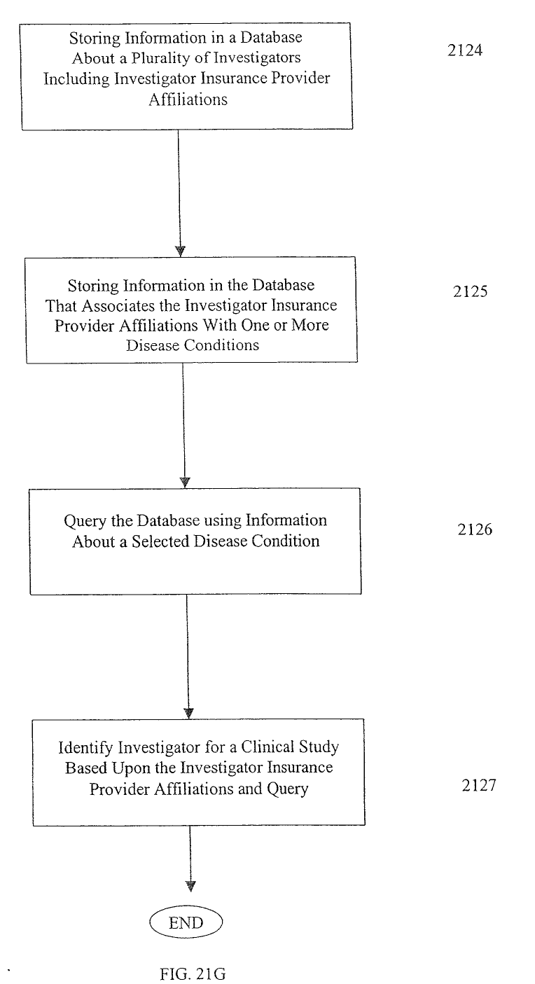

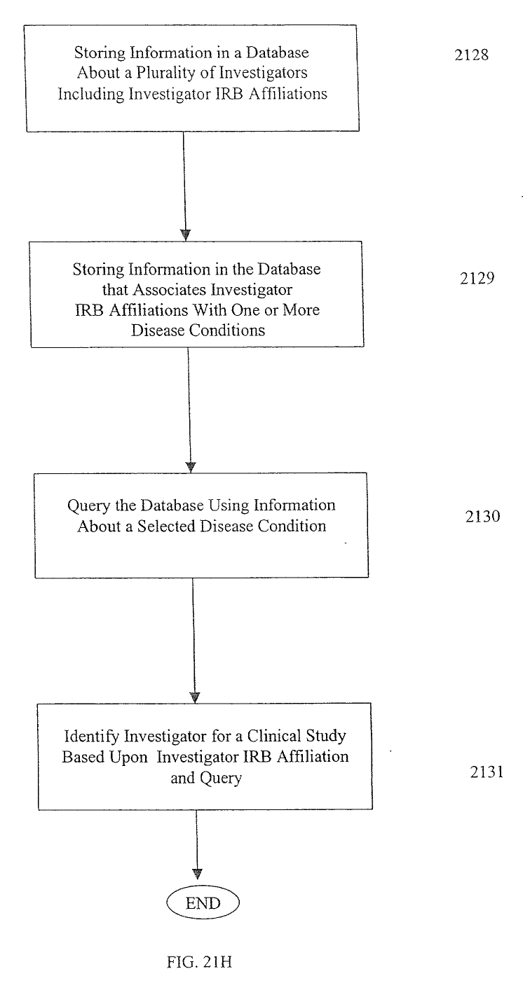

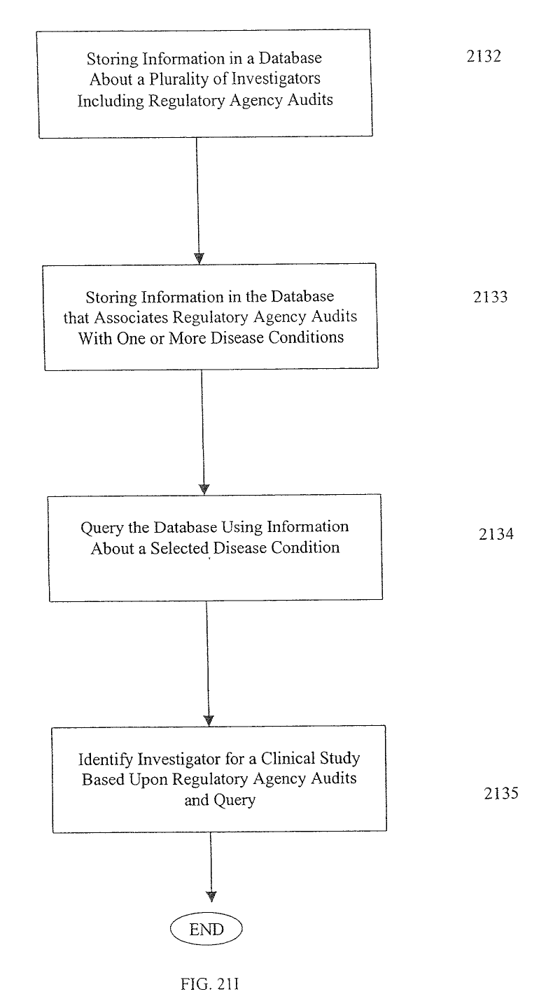

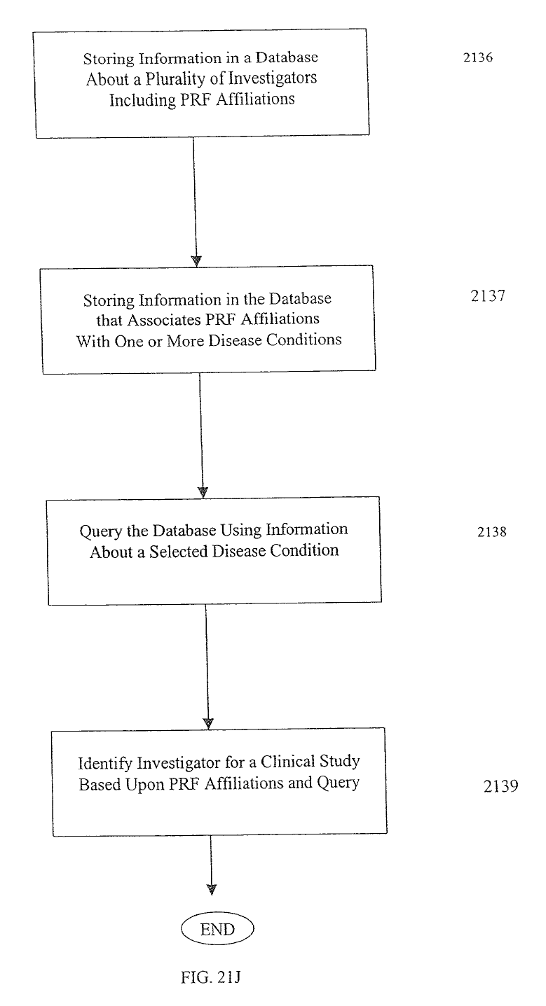

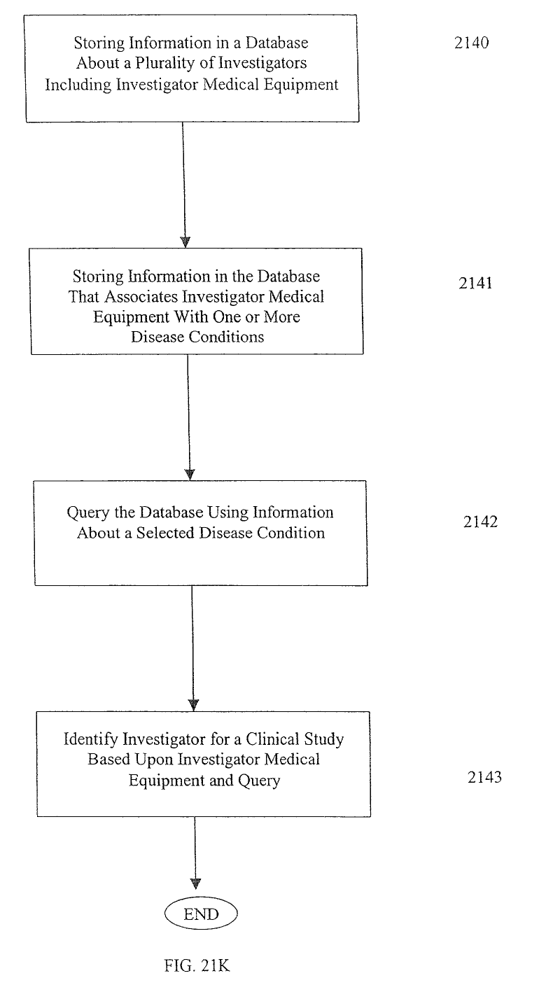

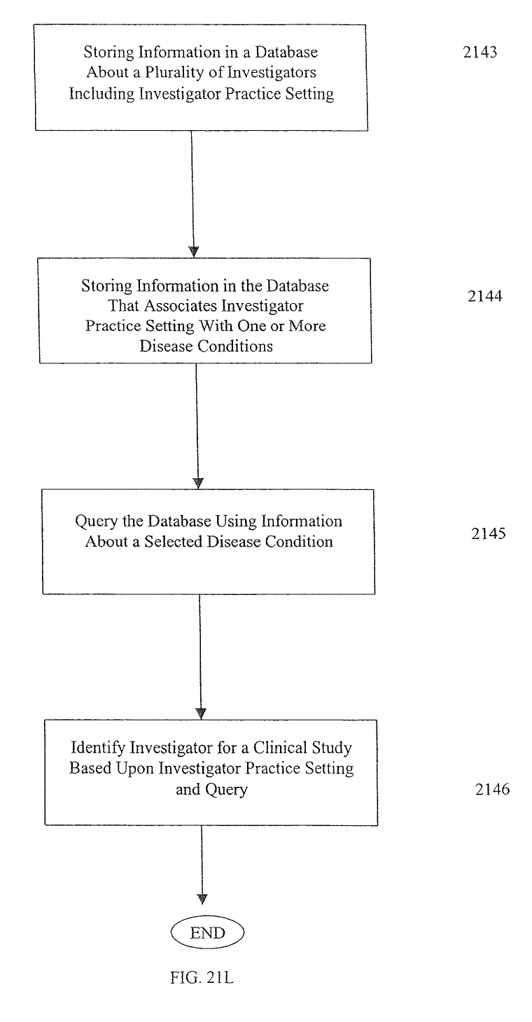

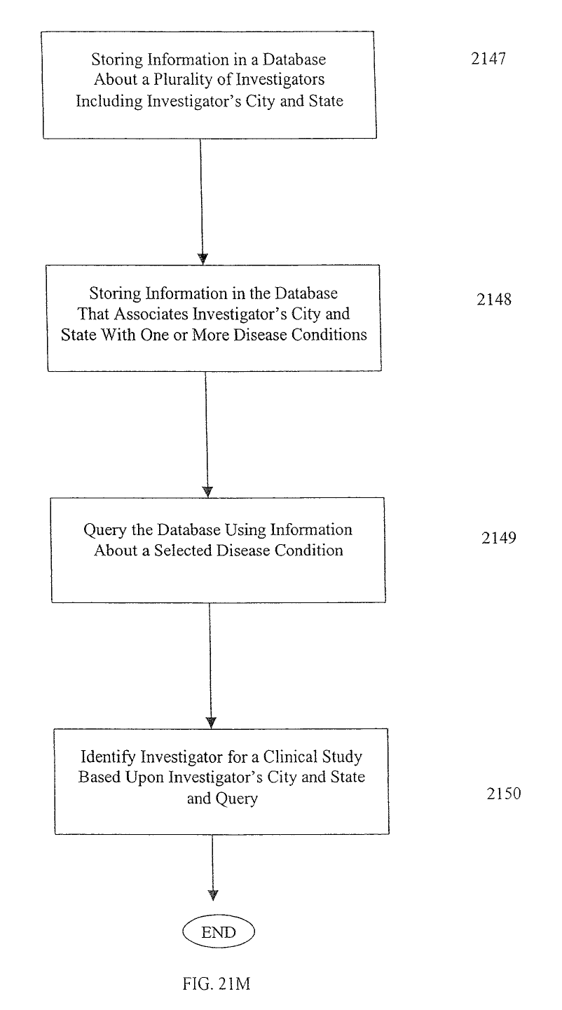

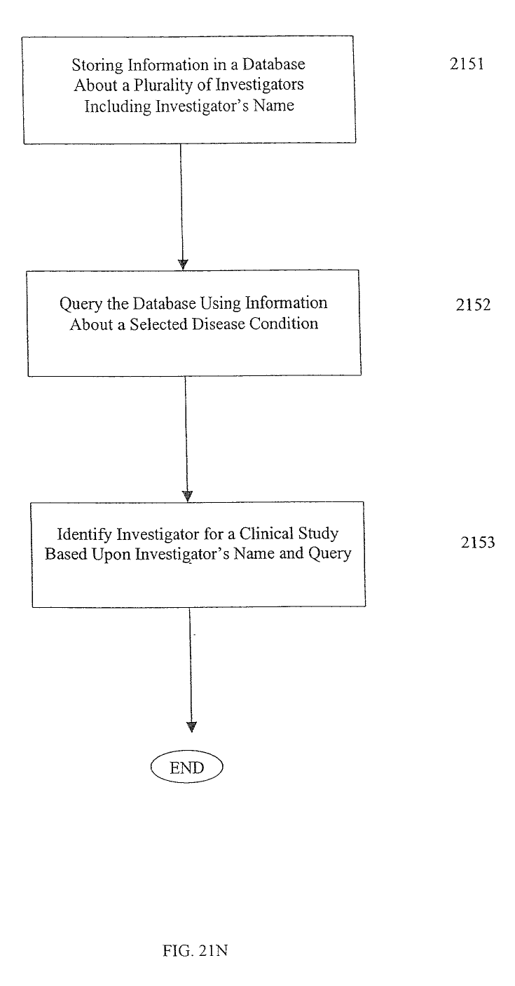

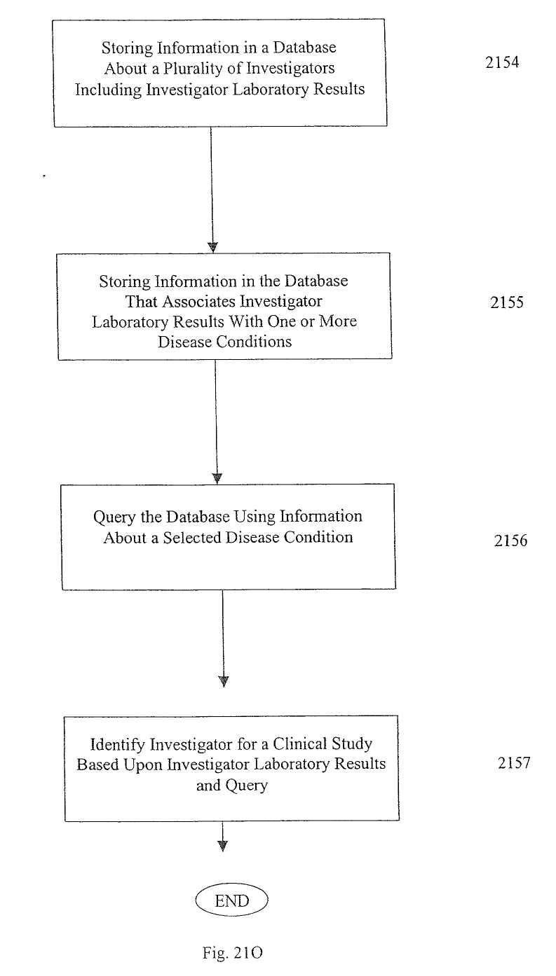

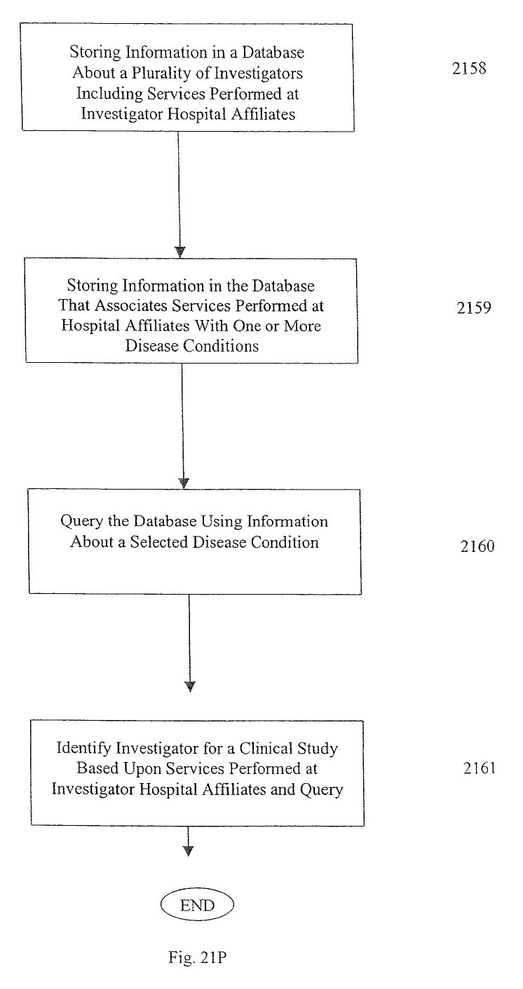

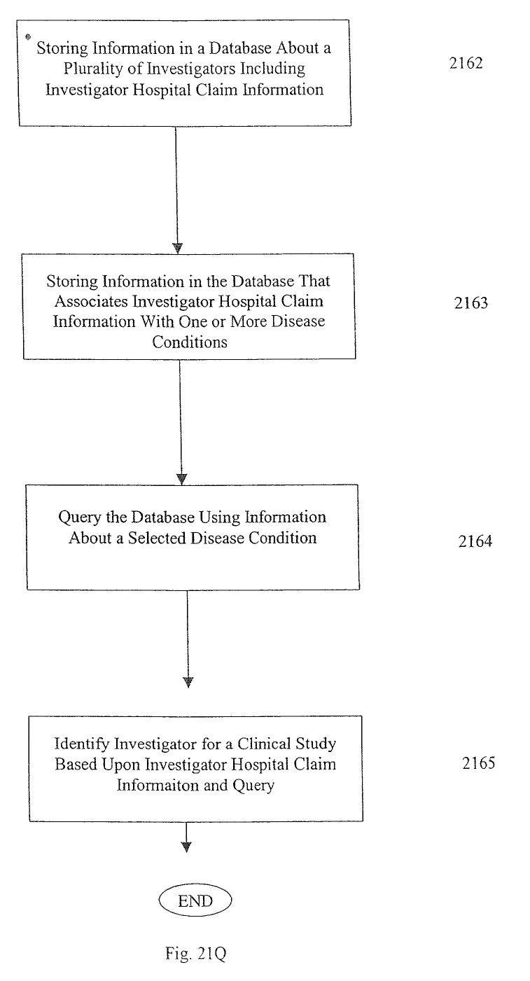

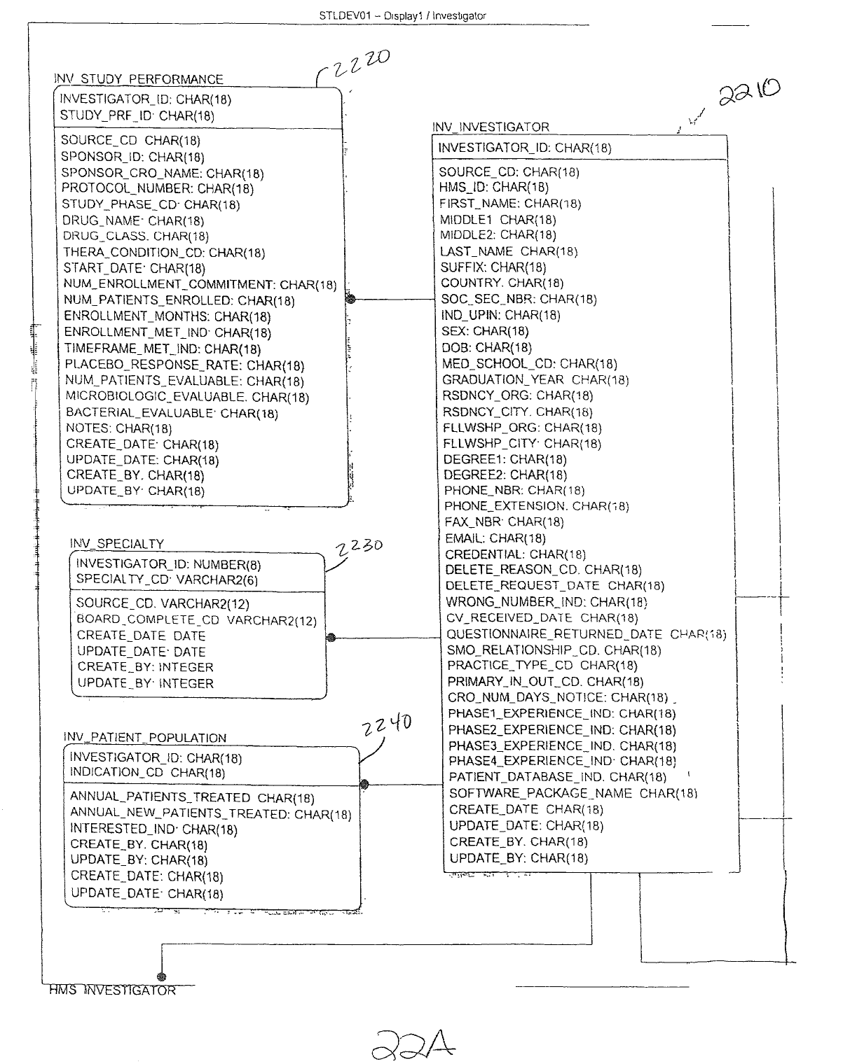

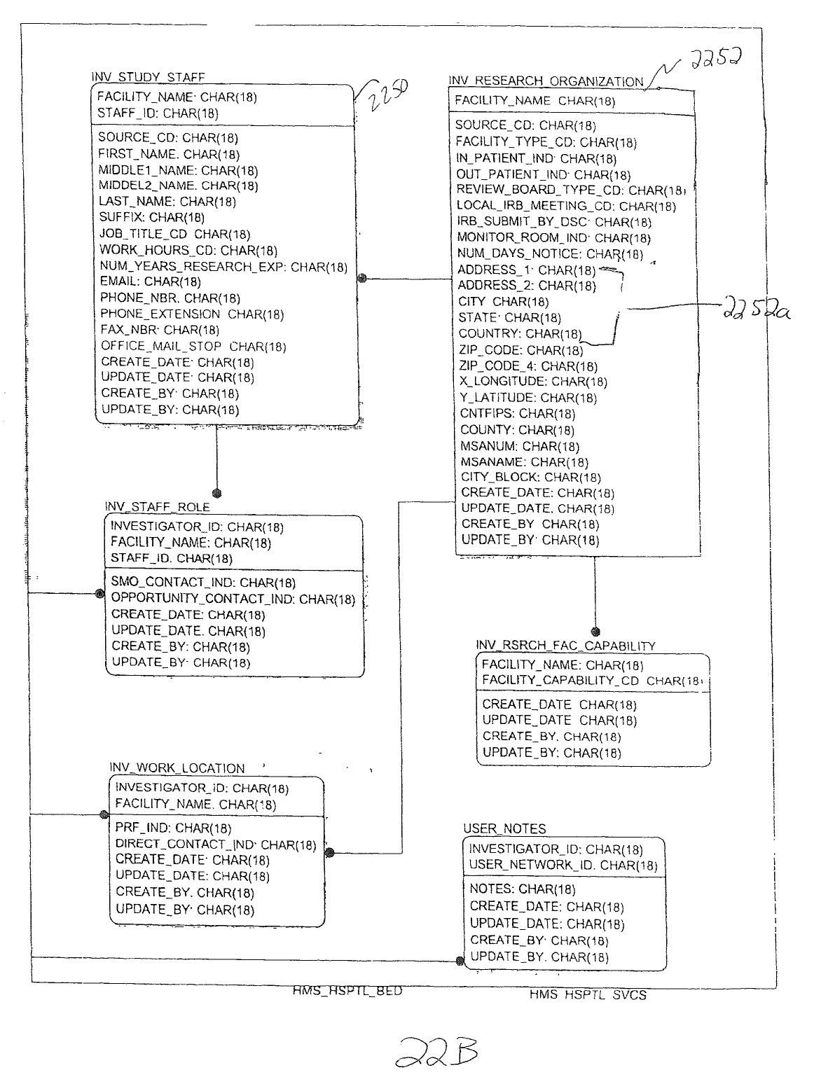

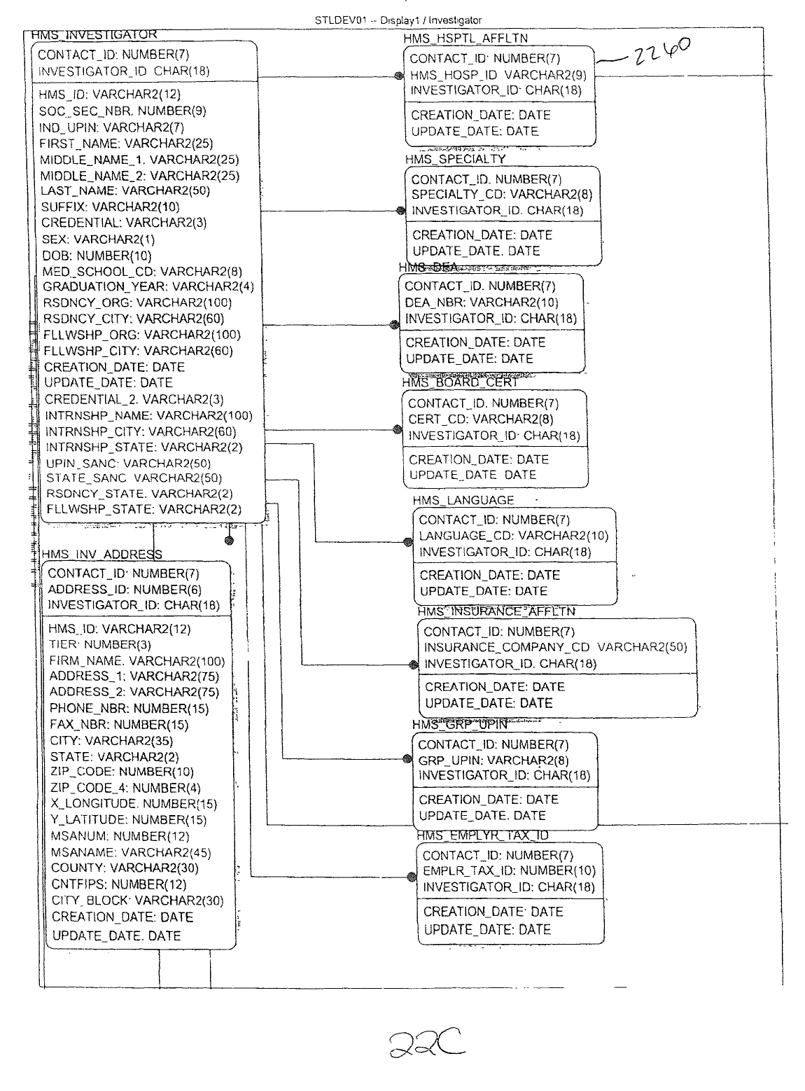

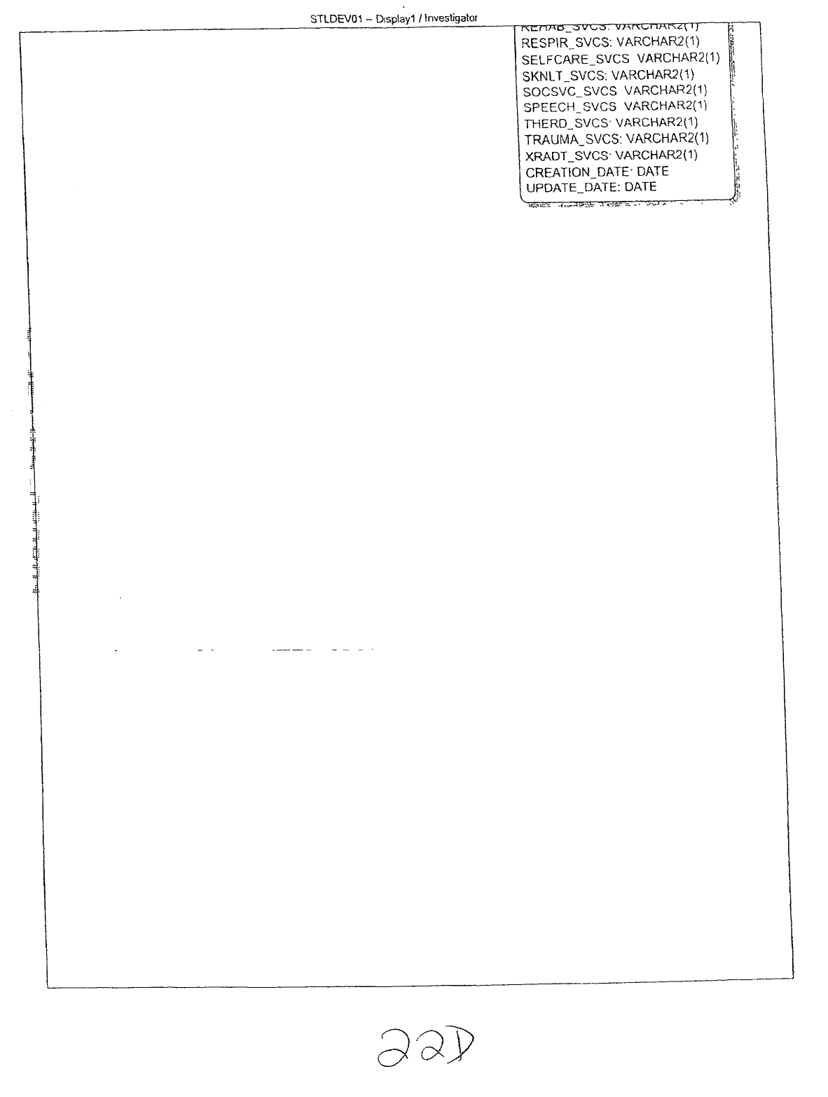

FIG. 21A is a process flow diagram depicting the steps of a method for identifying eligible investigators for a clinical study, in accordance with a further embodiment of the present invention. With reference to FIG. 21A, in step 2101, information regarding a plurality of investigators is stored in a database. Such information includes a geographic location of subjects located near the investigator. In step 2102, the database is queried using criteria about a selected disease condition. In step 2103, a qualified investigator for a clinical study is identified based on the results of the query and the geographic location of the investigator's subjects.

FIG. 21B is a process flow diagram depicting the steps of a method for identifying eligible investigators for a clinical study in accordance with another embodiment of the present invention. At step 2104, information is stored in the inventive system database relating to prospective investigators for clinical studies. This information includes information regarding the investigator's medical specialty, which can be supplied either by the investigator or a third party, such as a certification board.

At step 2105, information is stored in the database that associates each of the investigator's specialty with one or more disease conditions. At step 2106, the database is queried wherein information representing a selected disease condition associated with the specific clinical study is used. The query will result in correspondence between the specific disease condition and related specialties. At step 2107 the inventive system identifies an investigator based upon the query results and the investigator's specialty.

FIG. 21C is a process flow diagram depicting the steps of a method for identifying eligible investigators for a clinical study in accordance with yet another embodiment of the present invention. At step 2108, information is stored in the inventive system database relating to prospective investigators for clinical studies. This information includes information regarding the experience of an investigator's medical staff, which may include the actual size of the staff, any particular expertise among the staff, etc. Other information about an investigator's staff will be known to those skilled in the art and are within the scope of the present invention- The staff information can be supplied by the investigators or third parties.

At step 2109, information is stored in the database that associates the experience of the investigator's medical staff discussed above with one or more disease conditions. At step 2109, the database is queried wherein information representing a selected disease condition associated with the specific clinical study is used. The query will result in correspondence between the specific disease condition and related staff experience. At step 2110 the inventive system identifies an investigator based upon the query results and the experience of the investigator's medical staff.

FIG. 21D is a process flow diagram depicting the steps of a method for identifying eligible investigators for a clinical study in accordance with another embodiment of the present invention. At step 2112, information is stored in the inventive system database relating to prospective investigators for clinical studies, which includes the number of clinical studies each investigator has performed. This number can be supplied by the investigators or third parties.

At step 2114, the database is queried wherein information representing a selected disease condition associated with the specific clinical study is used. At step 2115 the inventive system identifies an investigator based upon the query results and the number of investigator clinical studies.

FIG. 21E is a process flow diagram depicting the steps of a method for identifying eligible investigators for a clinical study in accordance with yet another embodiment of the present invention. At step 2116, information is stored in the inventive system database relating to prospective investigators for clinical studies, which includes hospitals with which the investigator is affiliated. This information can be supplied by the investigators or third parties.

At step 2117, information is stored in the database that associates each of the investigator hospital affiliates with one or more disease conditions. At step 2118, the database is queried wherein information representing a selected disease condition associated with the specific clinical study is used. At step 2119 the inventive system identifies an investigator based upon the query results and the investigator's hospital affiliates.

FIG. 21F is a process flow diagram depicting the steps of a method for identifying eligible investigators for a clinical study in accordance with a further embodiment of the present invention. At step 2120, information is stored in the inventive system database relating to prospective investigators for clinical studies. This information includes each of the investigator's hospital affiliates' number of beds, which may include information regarding how many beds are dedicated to ICU, cancer, OBGYN, etc. The information can be supplied by the investigators or third parties.

At step 2/121, the number of hospital beds is associated with one or more disease conditions. At step 2122, the database is queried wherein information representing a selected disease condition associated with the specific clinical study is used. At step 2123 the inventive system identifies an investigator based upon the query results and the number of beds in an investigator's affiliated hospitals.

FIG. 21G is a process flow diagram depicting the steps of a method for identifying eligible investigators for a clinical study in accordance with yet a further embodiment of the present invention. At step 2124, information is stored in the inventive system database relating to prospective investigators for clinical studies. This information includes information regarding each investigator's insurance provider affiliations. The insurance provider affiliation information can be supplied by the investigators or third parties.

At step 2125, information is stored in the database that associates each of the insurance providers with one or more disease conditions. At step 2126, the database is queried wherein information representing a selected disease condition associated with the specific clinical study is used. The query will result in correspondence between the specific disease condition and related insurance providers. At step 2127 the inventive system identifies an investigator based upon the query results and the investigator's insurance provider affiliations.

FIG. 21H is a process flow diagram depicting the steps of a method for identifying eligible investigators for a clinical study in accordance with yet a further embodiment of the present invention. At step 2128, information is stored in the inventive system database relating to prospective investigators for clinical studies. This information includes information regarding each investigator's mandated IRB relationships. For example, an investigator may be affiliated with a local IRB or central IRB. The mandated IMB relationships information can be supplied by the investigators or third parties.

At step 2129, information is stored in the database that associates each of the investigators with IRBs. At step 2131 the inventive system identifies an investigator based upon the query results and the investigator's mandated IRB relationships.

FIG. 211 is a process flow diagram depicting the steps of a method for identifying eligible investigators for a clinical study in accordance with yet a further embodiment of the present invention. At step 2132, information is stored in the inventive system database relating to prospective investigators for clinical studies, which includes regulatory agency audits that have been performed for each investigator. This information may include audits from the FDA, or other audits that are known to those skilled in the art. The audit information can be supplied by the investigators or third parties.

At step 2133, information is stored in the database that associates each of the regulatory audits with one or more disease conditions. At step 2134, the database is queried wherein information representing a selected disease condition associated with the specific clinical study is used. The query will result in correspondence between the specific disease condition and related audits. At step 2135 the inventive system identifies an investigator based upon the query results and the agency audits of the investigator.

FIG. 21J is a process flow diagram depicting the steps of a method for identifying eligible investigators for a clinical study in accordance with an additional embodiment of the present invention. At step 2136, information is stored in the inventive system database relating to prospective investigators for clinical studies, which includes the investigator's PRF affiliations. This information can be supplied by the investigators or third parties.

At step 2137, information is stored in the database that associates each of the investigators with particular PRFs as appropriate. At step 2138, the database is queried. At step 2139 the inventive system identifies an investigator based upon the query results and the investigator's PRF affiliations.

FIG. 21K is a process flow diagram depicting the steps of a method for identifying eligible investigators for a clinical study in accordance with yet an additional embodiment of the present invention. At step 2140, information is stored in the inventive system database relating to prospective investigators for clinical studies. This information includes information regarding each investigator's medical equipment, such as is the investigator has a CAT scanner, and EKG machine, etc. The information can be supplied by the investigators or third parties.

At step 2140, information is stored in the database that associates the types of equipment that an investigator has with one or more disease conditions. At step 2141, the database is queried wherein information representing a selected disease condition associated with the specific clinical study is used. The query will result in correspondence between the specific disease condition and related equipment that an investigator has. At step 2142 the inventive system identifies an investigator based upon the query results and the investigator's equipment.

FIG. 21L is a process flow diagram depicting the steps of a method for identifying eligible investigators for a clinical study in accordance with yet a further embodiment of the present invention. At step 2143, information is stored in the inventive system database relating to prospective investigators for clinical studies, which includes the investigator practice setting, which is where the actual clinical study is conducted, and where a subject would most likely go to participate. This information is provided by the investigator.

At step 2144, information is stored in the database that associates the investigator practice setting with one or more disease conditions. At step 2145, the database is queried wherein information representing a selected disease condition associated with the specific clinical study is used. The query will result in correspondence between the specific disease condition and related setting information. At step 2146 the inventive system identifies an investigator based upon the query results and the investigator's practice setting.

FIG. 21M is a process flow diagram depicting the steps of a method for identifying eligible investigators for a clinical study in accordance with another embodiment of the present invention. At step 2147, information is stored in the inventive system database relating to prospective investigators for clinical studies, which includes the investigator's city and state. This information is provided by the investigator.

At step 2148, information is stored in the database that associates each of the investigator's city and state. At step 2149, the database is queried wherein information representing a selected disease condition associated with the specific clinical study is used. The query will result in correspondence between the specific disease condition and the investigator's city and state. At step 2150 the inventive system identifies an investigator based upon the query results and the investigator's city and state.

FIG. 21N is a process flow diagram depicting the steps of a method for identifying eligible investigators for a clinical study in accordance with another embodiment of the present invention. At step 2151, information is stored in the inventive system database relating to prospective investigators for clinical studies, which includes the investigator's name. This information is provided by the investigator.

At step 2152, the database is queried wherein information representing a selected disease condition associated with the specific clinical study is used. At step 2153 the inventive system identifies an investigator based upon the query results and the investigator's name.

FIG. 210 is a process flow diagram depicting the steps of a method for identifying eligible investigators for a clinical study in accordance with yet another embodiment of the present invention. At step 2154, information is stored in the inventive system database relating to prospective investigators for clinical studies. This information includes information regarding the history of each investigator's laboratory results. The laboratory results information can be supplied by the investigators or third parties.

At step 2155, information is stored in the database that associates each of the laboratory results discussed above with one or more disease conditions. At step 2156, the database is queried wherein information representing a selected disease condition associated with the specific clinical study is used. The query will result in correspondence between the specific disease condition and related laboratory results. At step 2157 the inventive system identifies an investigator based upon the query results and the investigator's laboratory results. The determination may vary depending upon the specific clinical study, and will be known to those skilled in the art and is within the scope of the present invention.

FIG. 21P is a process flow diagram depicting the steps of a method for identifying eligible investigators for a clinical study in accordance with a further embodiment of the present invention. At step 2158 information is stored in the inventive system database relating to prospective investigators for clinical studies. This information includes, with respect to each hospital with which the investigator is affiliated, the services performed, which may include information regarding whether the hospital performs transplants, dialysis, bum units, etc. The information can be supplied by the investigators or third parties.

At step 2159, the services performed are associated with one or more disease conditions. At step 2160, the database is queried wherein information representing a selected disease condition associated with the specific clinical study is used. At step 2161 the inventive system identifies an investigator based upon the query results and the number of beds in an investigator's affiliated hospitals.

FIG. 21Q is a process flow diagram depicting the steps of a method for identifying eligible investigators for a clinical study in accordance with an additional embodiment of the present invention. At step 2162, information is stored in the inventive system database relating to prospective investigators for clinical studies, which includes the investigator's hospital claim information. This information pertains to claims made by subjects to a hospital, which claims include disease condition information and also are associated with an investigator. Such information can be supplied by the investigators or third parties.

At step 2163, information is stored in the database that associates each of the claims with one or more disease conditions. At step 2164, the database is queried wherein information representing a selected disease condition associated with the specific clinical study is used. The query will result in correspondence between the specific disease condition and related claims. At step 2165 the inventive system identifies an investigator based upon the query results and the claims.

The investigator database may also include any combination of, or all of the above information related to the investigator. Moreover, the query of the investigator database may further include search criteria selected from any, and/or all, and all combinations of the information stored in the database. Therefore, the query may include any permutation of combinations of the information including the investigator's prescription writing history, information corresponding to a history of laboratory requests made by the investigator, information corresponding to past participation of the investigator in clinical studies, information corresponding to the medical specialty of the investigator, information corresponding to experience of a medical staff of the investigator, information corresponding to how many clinical studies have been performed by the investigator, information corresponding to hospital affiliations of the investigator, information corresponding to insurance provider affiliations of the investigator, information corresponding to mandated IRB relationships of the investigator, information corresponding to regulatory agency audits of the investigator, information corresponding to PRF affiliations of the investigator, information corresponding to equipment of the investigator, information corresponding to the investigator's practice setting, information corresponding to the investigator's city and state of practice, and information corresponding to the investigator's name.

### Investigator Ranking System

In selecting an investigator for a particular study, in some embodiments, a sponsor may employ an investigator ranking system which is a tool to help predict the success of an investigator in performing clinical studies. In this embodiment, certain fields of the investigator database (as discussed in more detail below with reference to FIG. 21) are weighted based on one or more algorithms and an investigator is assigned a ranking value. Some of the fields of the investigator database that may be used are as follows: reported study performance by sponsors; reported study performance by third party sources; 1572 counts from the FDA; FDA audit lists; hospital affiliation; mandated IRB relationships; drug prescribing decile for related classes of drugs; aggregate subject demographics of disease incidence proximate to investigator location; and self-reported data. The weighting algorithm is derived using the investigator's past clinical study experience as a basis. The specific weighting algorithm can be used as a tool to predict performance by an investigator on studies for drugs in a variety of specialties.

Thus, for example, in one embodiment, the fields selected for weighting are as follows: investigator experience (namely, the number of 1572s filed in the last five years); the professional certification (namely, if the investigator is board certified, the number 1 is assigned and if not, a zero value is assigned); scientific leadership (namely, the total number of peer-reviewed publications in the past five years); regulatory criteria (namely, for any FDA audits conducted in the past five years, assigning the number 1 if no warning letter was issued, assigning a zero value if no audits were conducted, and assigning a −1 if a warning letter was issued); and study coordinator criteria (namely, the total number of study coordinators ACRP certified). The value for investigator experience is weighted by multiplying it by 1; the value for professional certification is weighted by multiplying it by 5; the value for the specific leadership is weighted by multiplying it by 5; the value for the regulatory criteria is weighted by multiplying it by 25; and the value of study coordinator criteria is weighted by multiplying it by 5.

In some embodiments, the inventive system refines these rankings by later analysis of clinical study results.

### Subject Recruitment

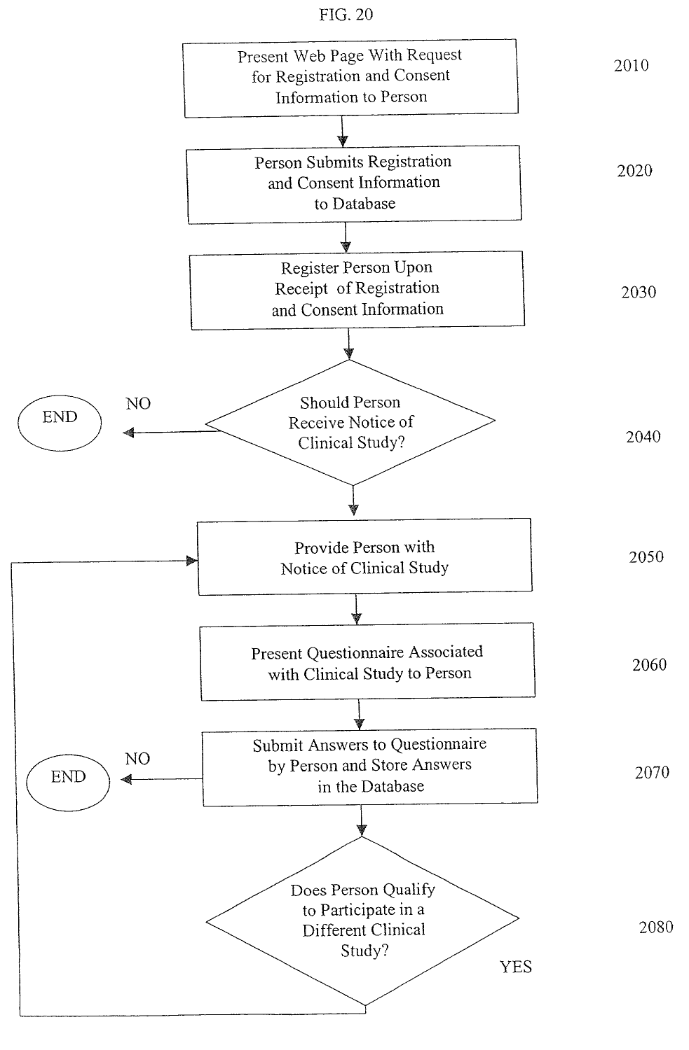

FIG. 20 is a process flow diagram showing the steps of a method for recruiting a person to participate in a clinical study in accordance with one embodiment of the present invention. As shown in step 2010 of FIG. 20, a person is presented with one or more web pages sponsored by the inventive system, as discussed above and shown in FIGS. 2A and 2B. The person may be the subject himself or herself or a caregiver of the subject. The caregiver may be either the legal guardian of the subject, or a friend or relative or other interested person. The web page(s) has a registration form that requests a variety of information from the person. For example, the form may ask for the geographic location of the person, which may include a specific city in which the person resides and the distance the person is willing to travel to participate in a clinical study (with reference to FIG. 3). The registration form also may ask for the gender and age of the person, at least one disease condition of interest to the person, a medical history of the person and/or numerous other factors known to those skilled in the art. The form also may include contact information, such as a relative or friend who may be contacted in an emergency. Other registration information will be known to those skilled in the art and are within the scope of the present invention.

Further, the form may inquire as to consent information about the person. This information includes queries about the person's date of birth. The form may also inquire as to whether the person wishes to receive notice of one or more clinical studies and permission to send the same. The clinical study information sent may be targeted specifically to the person's disease condition of interest, may be targeted to pharmaceutical histories, geographic location, etc.

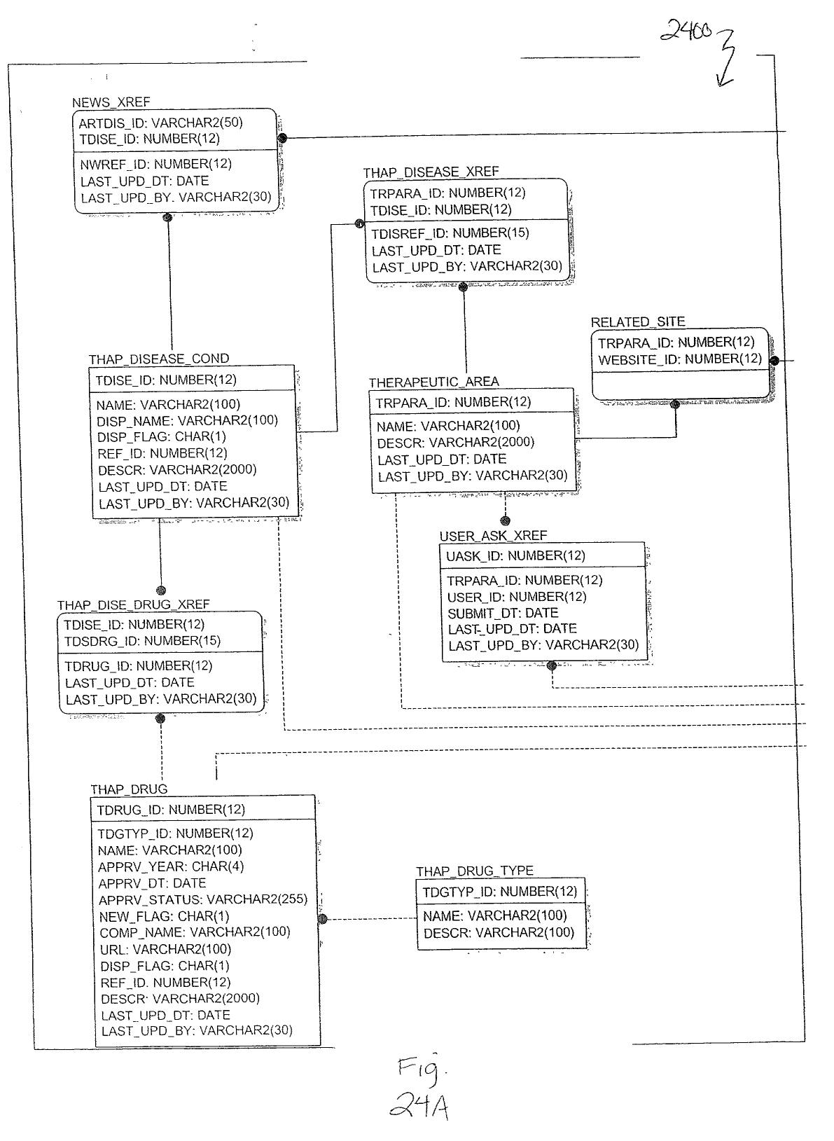

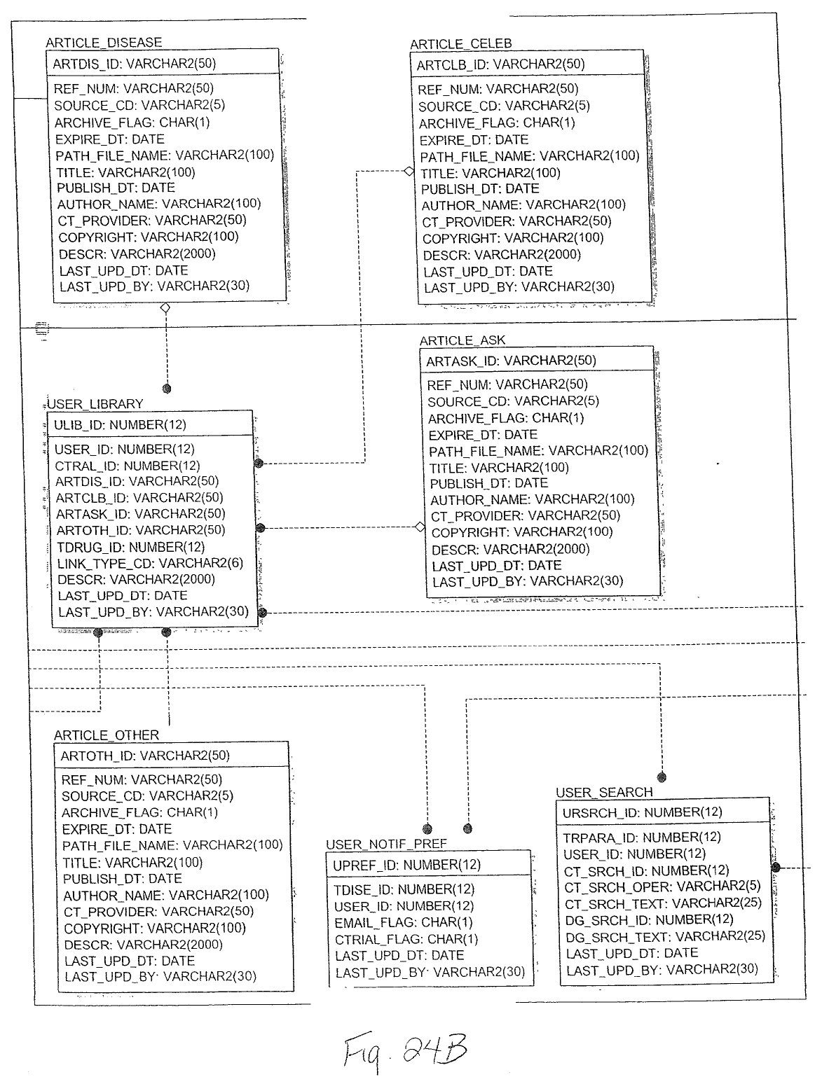

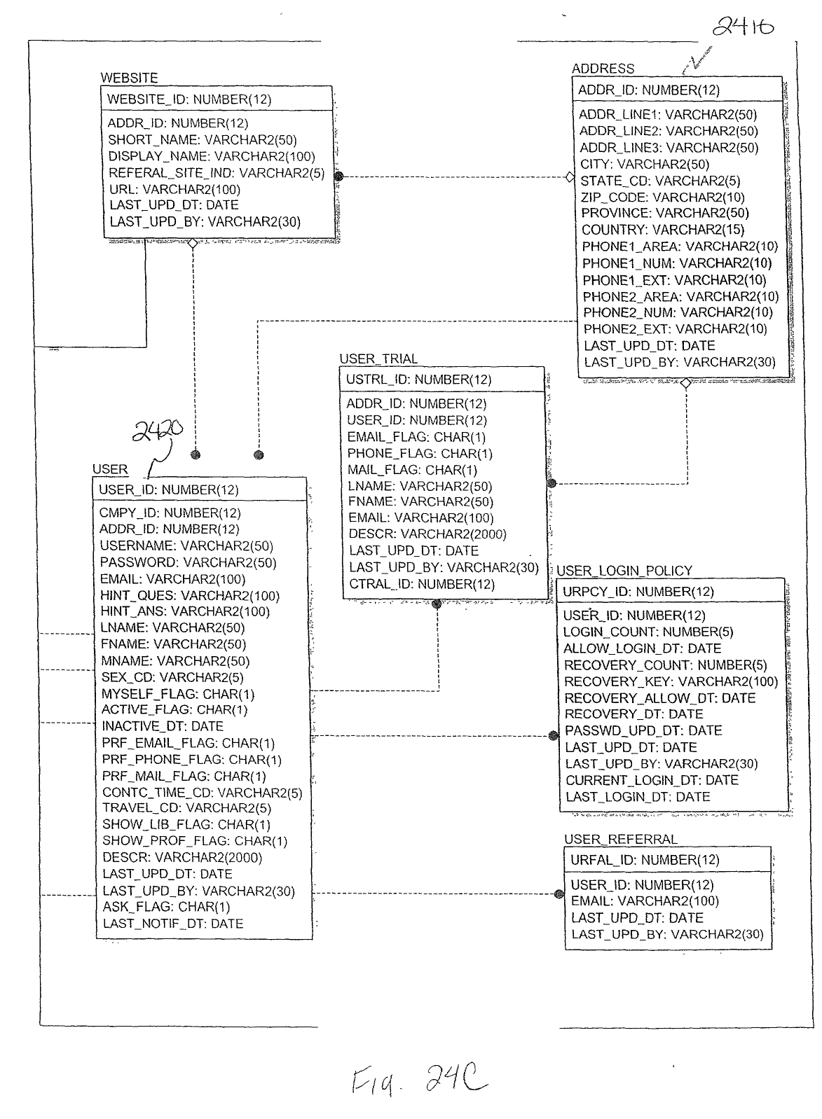

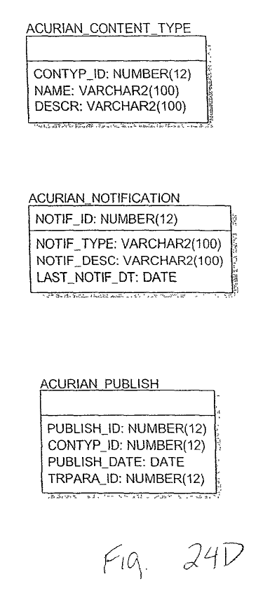

At step 2020 of FIG. 20, the person, or caregiver, completes the registration form as presented on the web page(s). The data is submitted to the subject database and stored therein as described later with reference to FIG. 24, shown as Tables 2410 and 2420. Once the database is populated with the registration information, the person or caregiver is automatically registered with the inventive system, as shown in step 2030.

Once the person or caregiver is registered, the inventive system evaluates the information provided in the registration form and determines if the person or caregiver should receive notice of a clinical study, as shown in step 2040. For example, the inventive system asks the person or caregiver to confirm that he or she is legally qualified to provide simple consent to add the person's information to the database and to give permission to receive notices about clinical studies. This determination may be based upon information of the person's age, or whether the person or caregiver actually gave permission to receive such notices, for example.

The system also evaluates the information with respect to the person's possible selection for a clinical study. For example, the system queries the database based on: a disease condition of interest indicated by the subject; the geographic location of the subject; other information from the registration of the subject or a prior questionnaire completed by the subject; and the geographic location of the investigator that has been selected to perform the clinical study. Other determining factors will be known to those skilled in the art and are within the scope of the present invention.

If the system determines that the person does not match the geographic location and disease condition of any currently available clinical studies, the inquiry about the person ends. In some embodiments, the system asks the person if the system may contact the person about future studies that may match the criteria set forth in the registration by the person. If, so, when a new study is entered, the person may show up as a potentially eligible subject, and an e-mail or other notification will be delivered to the person. If, on the other hand, the data regarding the person matches data related to a clinical study, the system provides the person or caregiver with notification of the clinical study, as shown as step 2050. This notification may be by e-mail, telephone or regular mail, as desired by the person, for example with reference to FIG. 3.

Once a person is notified of a clinical study that may be of interest, the system presents to the person a questionnaire that is specifically associated with the clinical study at step 2060. In some embodiments, the person will receive an electronic mail or other notification that a study may match their needs, and the person initiates contact with the system or with a call center to take the particular pre-screening questionnaire. This questionnaire requests information about the person regarding high level inclusion/exclusion criteria. The answers given by the person or caregiver to the questionnaire are securely stored in the subject database of the system (FIG. 24) at step 2070.

As discussed above, this information is evaluated and the person is pre-screened for a clinical study. If the person's responses to the pre-screening indicate that the person may be eligible to participate in the study, the person will be given an investigator name and address and contact information where the subject can schedule an appointment to undergo a more detailed screening process to determine whether the person is qualified to participate. Should the person not be chosen, the information previously stored in the subject database from the questionnaire is evaluated to determine if the person is qualified to participate in a different clinical study than that previously matched, as shown in step 2080. As with the previous determination made, typical queries include whether the person is within a geographic location (as defined by the person or caregiver) of another clinical study and if the person has a disease condition of interest that corresponds with another clinical study. Other determining factors will be known to those skilled in the art and are within the scope of the present invention.

If it is determined that the person is qualified to participate in a different clinical study, the system provides the person with notice of that clinical study, as was discussed earlier. If the subject is eligible for two studies, the subject is presented with them both simultaneously.

### Push Technology For Enrolling Participants

As an alternative to a passive method of enrolling investigators, sponsors, and clinical subjects, push technologies can be used to deliver descriptions of the service and to enroll participants. The subject database accommodates this type of data. Using suitable methods of privacy protection, information can be emailed to unregistered individuals to notify them of the potential to participate in an ongoing study. Similarly, location or ease of access may be important in designing or implementing a study. The GPS functionalities built into wireless phones and other communications devices combined with the ability to transmit information, such as that provided by Bluetooth wireless technology would permit sponsors or investigators to directly contact individuals within particular locations.

### Selection of Subjects Using Genotype and Phenotype Data

In addition, the present invention permits more efficient use of genotype as well as phenotype data, and other genetic sequencing information, for better selection of candidates for clinical studies. Thus, medial practitioners, including but not limited to doctors, nurses, blood banks, pharmacists, etc., take blood, tissue scrapings or hair samples for genetic analysis to determine the presence of various alleles and polymorphisms. Such samples are analyzed for the presence of various alleles that might correlate or be associated with various diseases. This polymorphism analysis is greatly improved by such techniques as the DNA chip. Such chips are manufactured by a number of different sources such as Affymetrix, Santa Clara, Calif.

Alleles that are associated with metabolic polymorphisms can also be identified. This is of great importance if differing breakdown rates or even products of the investigational compound affect the drug's safety or efficacy. In this manner, a sponsor can begin clinical studies on a more homogenous population to simplify the complexities of the testing process. Indeed, such a discrete portion of the population can, in some cases, arguably qualify for special testing parameters, such as that for an Orphan Drug. After approval of the product for such subpopulations, testing is continued to obtain regulatory approval of the product for the population at large.

Many forms of disease appear to be genetically linked including, for example, early onset breast cancer. In early onset breast cancer, the presence of certain gene sequences such as the BRCA-1 mutation greatly increase the probability that the disease will occur. In many cases, the presence of the BRCA-1 mutation does not lead to the disease, and the disease also can occur when the BRCA-1 mutation is not present. For a product associated with breast cancer, clinical study sponsors may wish to first test their product on discrete populations—such as those with the BRCA mutation—to determine if such a discrete population reacts differently to a product compared to the population at large. Most importantly, testing such differing populations can lead to greater safety and efficacy in new drug products for the subpopulations tested. Moreover, identification of differences in response is important in discovering improved drugs. Alternately, the product may be designed only for use by a discrete population, such as that with a particular disease and a particular genotype.

In the alternative, the sponsor might wish to garner a more heterogeneous population for testing. Moreover, as genomic research advances, regulatory agencies might require studies that specifically target a large number of different alleles to obtain market approval for the entire population.

This ability to pool test subjects, either individually or as parts of large groups such as could be assembled by blood banks and laboratory testing companies, permits easier marketing of genomic information and stimulates research in this area. The site of the present invention has the ability to act as a clearinghouse to match potential sponsors with groups or individuals that, for example, have particular genotypes and phenotypes. Indeed, as the cost of genomic testing goes down, the invention may be a centralized location that potential clinical subjects may contact not only for participation in studies, but for background genetic tests. As those of ordinary skill in the art will recognize, the present invention may include genetic sequence information in any of the databases described herein. Moreover, any of the functionality described herein which is based on or operates on disease condition, medical, or treatment information may also be based on or operate on genetic sequence information.

Investigators, persons or other parties supply genetic sequence information for inclusion in the subject database and/or the TIA database along with other suppliers of clinical subjects post the potential clinical subjects that they have identified by location, genetic background at particular genetic loci, family history, lifestyle or any other criteria and then market access to these subjects to potential sponsors. In this way, the invention stimulates the ease of access to unique subject populations.

The invention also permits more efficient marketing of pharmaceutical products and postmarketing studies. The invention collects and pools information regarding the locations of particular doctors as well as their prescription habits. Such information can be used in the design of post-marketing studies as well as determining which doctors would be most easily approached to sell different drug formulations.

### Building the Investigator Database

As described earlier, prospective investigators enter data into the Investigator Questionnaire (FIG. 7 described above) that includes information regarding the investigator's professional background and information about past clinical studies performed by that investigator. In other embodiments, known to those skilled in the art, data relating to the investigator is provided by the investigator not by way of a web site, but orally or by off-line written means.

Specifically focusing on the information regarding past clinical studies, the investigator is asked for data relating to the specific types of clinical studies the investigator performed in the past, the class of drugs that were tested, the protocol number, what recruiting commitments were made by the investigator in each of the past clinical studies, how successful the investigator was in meeting the recruiting commitments, how many subjects participated in the study, and of those who began the study, how many actually completed the study. This data is stored in the database 2200 as shown in FIG. 22. For example, the investigator may have committed to recruiting 25 subjects over a six-month period of time for a particular clinical study. The database will thus include information about this commitment and results therefrom, i.e. was the investigator successful in meeting this commitment, how many subjects actually participated in the study, and of those subjects who began the study, how many actually completed the study (clinically evaluable subjects).

The investigator database also includes information regarding the investigator's publications in the related medical fields, the number of subjects the investigator treats in a given time-frame, any specialties the investigator may have, what board certifications the investigator has, what types of equipment are available to the investigator, affiliated hospitals, the size and expertise of the investigator's staff, etc. Other types of data relating to the investigator will be known to those skilled in the art and are within the scope of the present invention.

Third party information may be used to validate self-reported information submitted by an investigator. Such third party information may include data received from the FDA through the Freedom of Information Act (“FOIA”). In particular, for every clinical study performed in the United States an investigator must submit to the FDA a Form 1572 or appropriate analog. The non-confidential information of Form 1572 can be obtained through FOIA, and includes, for example, the names and addresses of all of the investigators who conducted a particular clinical study. The FDA also performs audits on clinical studies, which can result in a Form 483. Again, all non-confidential information from the 483 audit can be obtained through FOIA. Validated data also is obtained from various other third parties such as entities that collect performance data as a result of the conduct of their own businesses.

FIGS. 22A through 22F is an exemplary data structure for implementing an investigator database 2200. For example, table 2210 includes investigator data related to basics such as name, age, address, phone, etc. Table 2220 contains data about a specific study performed by the investigator, Table 2230 relates to the investigator's specialties, and Table 2240 relates to the investigator's subject population. Shown in FIG. 22B, table 2250 contains data about the investigator's staff. Table 2260 of FIG. 22C contains data regarding the investigator's hospital affiliations. It will be understood by those skilled in the art that the investigator database of the present invention could be implemented using many different formats or structures, and that the particular structure shown in FIGS. 22A thorough 22F represents one example of such a data structure.

### EXAMPLE

### Use of TIA Database to Assist in Investigator and Subject Selection

FIGS. 22G-K depict use of a disease incidence search on a TIA database to assist in performing investigator and subject selection. The example shown relates specifically to use of the invention to perform a study related to the disease of angina. Initially, the TIA database is queried using angina as the query criterion to identify geographic locations where the incidence of angina is more prevalent. These areas are identified on a national basis in FIG. 22G, and specifically for the Dallas-Fort Worth area in FIG. 22H. It bears noting that, within the Dallas-Fort Worth area, the TIA database has further identified an incidence value for each sub-region of the Dallas-Fort Worth area. Sites of various investigators in Dallas-Fort Worth that are potentially eligible to perform the study are also shown on FIG. 22H. These investigator sites were found by querying the investigator database as described above. FIG. 221 shows that there are three eligible investigator sites in the Dallas-Fort Worth Area. These three investigator sites are shown as circled stars in FIG. 221. Of the three eligible investigator sites, one of the investigator sites is located in a sub-region having a higher incidence of angina than is found in the subregions of the other two eligible investigators. As shown in FIG. 22J, the investigator located in the sub-region having the highest incidence of angina is next selected to perform the study. Following selection of this investigator for the study, subjects closest to the site of the selected investigator are identified for screening, as shown in FIG. 22K.

### Sponsor Data Access Limitations

A sponsor who has submitted data for inclusion in the investigator database must be afforded appropriate confidentiality protections to ensure their continued competitive advantage. Thus, in one embodiment of the present invention, the inventive system provides limited access views of such data. This method maintains the confidentiality of clinical study information associated with number of clinical study sponsors. In connection with this method, the clinical study information from the sponsors is received and stored in a database. Each sponsor is permitted full access to the clinical study information submitted by that sponsor and only aggregated access to information submitted by other sponsors. The clinical study information includes, in one embodiment, investigator information, sponsor identification, protocol information, drug indication information, drug class information, clinical study enrollment goal information, actual clinical study enrollment information, and clinically evaluable subjects information. In one embodiment, each sponsor is denied access to the protocol information, drug class information and sponsor identification information of other sponsors.

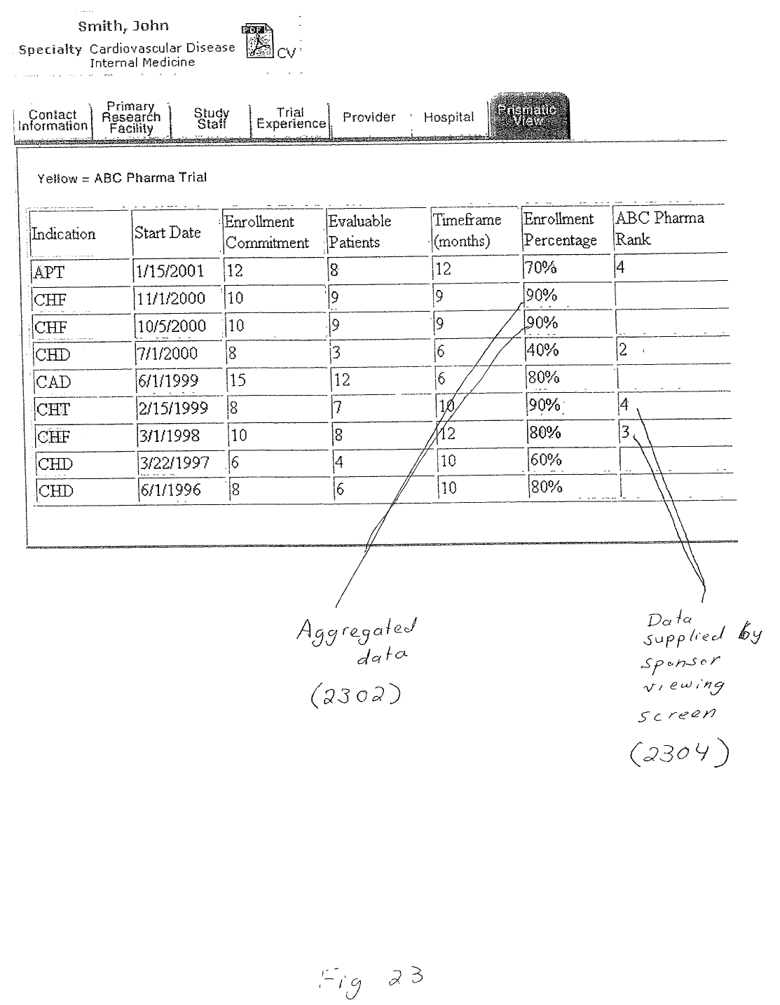

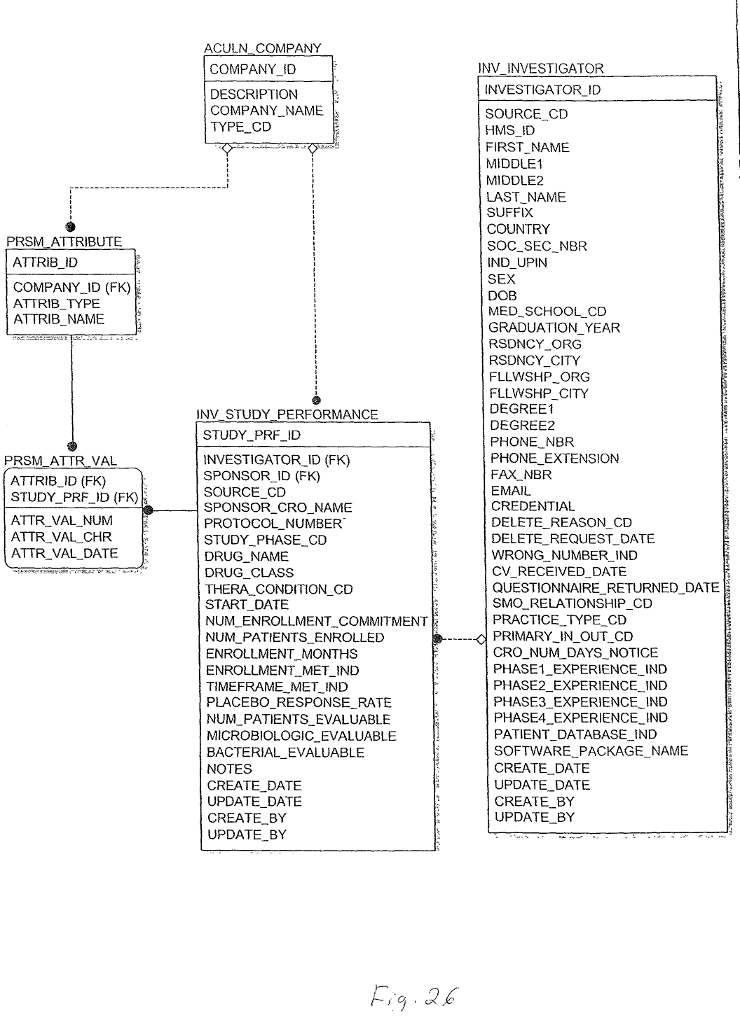

FIG. 23 is a screen shot showing sponsor access limitations to study data. Aggregated data 2302 can be viewed by all sponsors, whereas data 2304 can only be viewed by the sponsor that supplied that data 2304 to the database. FIG. 26 depicts an exemplary data structure used for implementing the sponsor access limitations discussed above.

### Multi-Viewer Content Presentation

The subject site the inventive system includes content such as, e.g. new articles, feature stories, drug listings, expert Q&A transcripts, etc., from multiple different sources for presentation to potential subjects and other persons visiting the subject site. The content as provided by the source is provided using verbiage which is highly technical and sophisticated. However, the content is transformed and presented to visitors of the subject site in a manner which is lay-accessible. Similarly, content which is collected from various sources for presentation on the professional site is transformed and presented in a manner which is appropriate for individuals accessing the professional site, such as investigators and sponsors.

### Certification of Investigators

The professional site may include, in some embodiments, a toolkit presented to investigators which includes training materials for investigators, including training regarding appropriate practices for clinical research on humans. Continuing medical education credits may be awarded to investigators completing a specified amount of training.

### Permission Based Electronic Mail Marketing

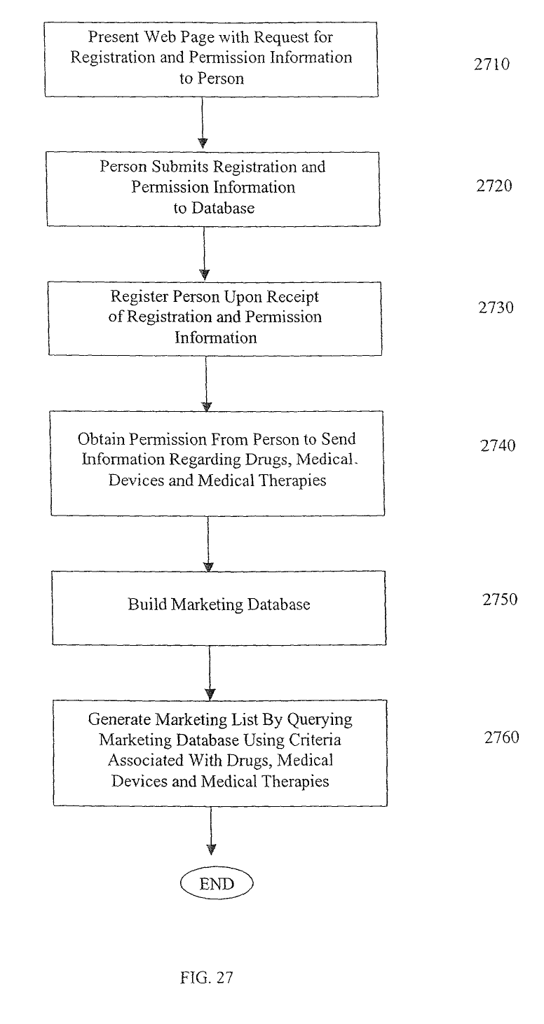

The systems and methods of the present invention can be utilized for the marketing of FDA approved new drugs and devices. FIG. 27 is a flow diagram of a method for performing permission-based electronic mail marketing to consumers, in accordance with the present invention. In steps 2710-2720, one or more web pages are presented that allow a person to register with the subject database by submitting registration and permission information to the database. The registration information includes name information and contact information and the permission information indicates whether the person wishes to receive notice of one or more clinical studies. In step 2730, the person is automatically registered with the database upon receipt of the registration and permission information. In step 2740, permission is obtained to send marketing information concerning drugs, medical devices or medical therapies to the person. The database is added to in step 2750 by repeating the above steps for a plurality of persons. Next, in step 2760 a list is generated for use in marketing drugs, medical devices and medical therapies to subjects by querying the database using criteria associated with the drugs, medical devices and medical therapies. Optionally, the system also automatically determines, in accordance with the registration and permission information, whether to provide the person with notice of a clinical study associated with a disease condition of interest to the person.

### Optimization of Recruiting Methodology

As the inventive system collects an ever-increasing amount of data regarding clinical investigators (and, in particular, the best performing clinical investigators), highly effective methods of recruiting clinical study subjects, who are clinically evaluable, may be identified by studying the methods employed by the best performing clinical investigators. Thus, the inventive system will allow for the identification of the clinical investigator recruiting techniques that result in the highest enrollment rates and number of clinically evaluable subjects.

Similarly, as the inventive system collects an ever-increasing amount of data regarding clinical subjects (and, in particular, those who become evaluable), highly effective methods of recruiting subjects, who are most likely to become evaluable, may be identified. Thus, the inventive system will allow for the identification of the clinical subject recruiting techniques that result in the highest enrollment rates and number of clinically evaluable subjects. Remaining

### Database Structures

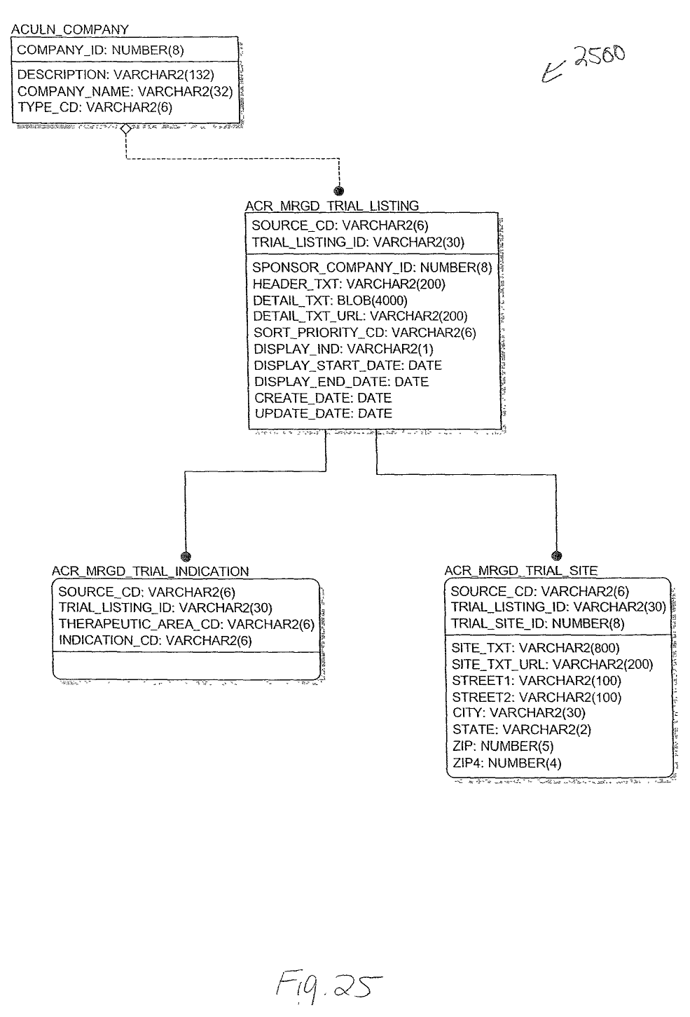

FIGS. 24A through 24D depict an exemplary data structure for implementing a subject database 2400. Again, it will be understood by those skilled in the art that the subject database of the present invention could be implemented using many different formats or structures, and that the particular structure shown in FIGS. 24A through 24D represents one example of such a data structure. In addition to storing information inputted by the subject as discussed with reference to FIGS. 2 through 6, database 2400 may store the criteria used by a potential clinical subject to search for a particular clinical study. The search criteria selected may be used to provide additional insight into the tendencies and/or interests of a potential clinical subject. FIG. 25 depicts an exemplary data structure for implementing a study database 2500. Again, it will be understood by those skilled in the art that the subject database of the present invention could be implemented using many different formats or structures, and that the particular structure shown in FIG. 25 represents one example of such a data structure.

While the description herein refers to the information existing in multiple databases, those of ordinary skill in the art will recognize and understand that all such information could be stored in a single database or n several databases structured differently than those described herein.

It will be appreciated by those skilled in the art that changes could be made to the embodiments described above without departing from the broad inventive concept thereof. It is understood, therefore, that this invention is not limited to the particular embodiments disclosed, but is intended to cover modifications within the spirit and scope of the present invention as defined in the appended claims.

What is claimed is:

1. A method for recruiting a person to participate as a subject in a clinical study, comprising the steps of:
(a) presenting one or more web pages that allow the person or a caregiver associated with the person to register with a database by submitting registration information to the database, wherein the registration information includes at least a geographic location of the person, at least one disease condition of interest to the person, contact information, and permission information indicating whether the person or caregiver wishes to receive notice of one or more clinical studies;
(b) automatically registering the person or caregiver with the database upon receipt of the registration and permission information;
(c) after step (b), automatically determining, in accordance with the permission information and the registration information, whether to provide the person or caregiver with notice of a given clinical study associated with a disease condition of interest to the person; and
(d) providing the person or caregiver notice of the given clinical study only if a determination is made in step (c) to provide such notice.

2. The method of claim 1, further comprising the steps of:
(e) automatically presenting a questionnaire associated with the given clinical study to the person or caregiver after step (d); and
(f) storing answers submitted by the person or caregiver in the database.

3. The method of claim 2, further comprising the step of:
(g) accessing the information stored along with other information in the database to determine whether the person qualifies to participate as a subject in a clinical study different from the given clinical study after step (f).

4. The method of claim 1, wherein the questionnaire includes criteria specified by a sponsor of the clinical study for determining whether the person is an eligible subject for the given clinical study.

5. The method of claim 1, wherein steps (a) and (b) are performed during a registration visit by the person or caregiver to a web site associated with the one or more web pages, and step (d) includes notifying the person or caregiver of the given clinical study during a current or subsequent visit of the person or caregiver to the web site.

6. The method of claim 5, wherein step (d) further includes providing a listing of information associated with the given clinical study in a personal library associated with the person or caregiver on the web site.

7. The method of claim 1, wherein the notice provided in step (d) is sent by electronic mail from a web site associated with the one or more web pages to an e-mail address of the person or caregiver.

8. The method of claim 1, wherein the notice provided in step (d) is sent by regular mail to the person or caregiver.

9. The method of claim 1, wherein the notice provided in step (d) is communicated by telephone to the person or caregiver.

10. The method of claim 1, wherein a determination is made to provide the person or caregiver with the notice in step (c) in accordance with a geographic location of the given clinical study.

11. The method of claim 1, wherein in step (c) a determination is made not to provide the person or caregiver with notice of the given clinical study.

12. The method of claim 1, wherein in step (a) the registration information includes a user id, a password, electronic mail address or telephone number, zip code, first name or preferred name, gender, date of birth, whether the person is interested in clinical study information, new medical therapies, or participating in clinical studies.

13. The method of claim 1, wherein a determination is made to provide the person or caregiver with the notice in step (c) in accordance with a geographic location of an investigator associated with the study.

14. The method of claim 2, wherein the answers submitted by the person or caregiver are provided by telephone, regular mail, facsimile, and other off-line sources.

15. The method of claim 1, wherein the step of automatically determining further includes reference to genetic sequence information associated with a person registered in the database.

16. A method for identifying subjects eligible to participate in a clinical study, comprising the steps of:
(a) accessing a computer database that stores information about a plurality of persons;
wherein for each of said plurality listed in the database, the database includes a geographic location of the person, an age and a gender of the person, and disease conditions of interest to the person;
(b) submitting a query to the database, wherein the query includes criteria that reflect eligibility characteristics for persons suitable for participation as subjects in the clinical study; and
(c) identifying de-identified data records of persons likely to be subjects eligible for the clinical study based on the query.

17. The method of claim 16, further comprising the steps of;
(d) evaluating a feasibility of the clinical study based on the result of step (c);
(e) exploring the feasibility of the clinical study by modifying the criteria and repeating steps (b)-(d) using the modified criteria.

18. The method of claim 16 or 17, wherein step (b) includes querying a therapeutic incidence area database.

19. The method of claim 16 or 17, wherein step (b) includes querying an investigator database.

20. The method of claim 16 or 17, wherein the accessed information was submitted by e-mail, regular mail, and personally.

21. The method of claim 16 or 17, wherein the database includes a user id, a password, electronic mail address or telephone number, zip code, first name or preferred name, whether the person is interested in clinical study information, whether the user is interested in new medical therapies, and whether the person is interested in participating in clinical studies.

22. The method of claim 16 or 17, wherein the criteria that reflect eligibility characteristics include medications taken by the person, the person's geographic location, disease conditions experienced by the person, and a geographic location of an investigator associated with the clinical study.

23. The method of claim 16 or 17, wherein the database is accessed by a user through a web site, wherein there is a first firewall between the web site and the user and a second firewall between the web site and the database.

24. The method of claim 16 or 17, wherein the database includes genetic sequence information for each of said plurality listed in the database.

25. The method of claim 16 or 17, wherein the criteria that reflect eligibility characteristics include inclusion/exclusion criteria for the clinical study.

26. An integrated on-line interactive forum that promotes exchange of information among clinical study sponsors, clinical study investigators, and potential clinical study subjects, comprising:
(a) an investigator database that contains information suitable for identification of qualified investigators for clinical studies sponsored by the sponsors;
(b) a subject database that contains information suitable for identification of eligible subjects for clinical studies sponsored by the sponsors; and
(c) an extranet coupled to the investigator database and the subject database that allows sponsors and investigators to securely exchange documents required to launch a clinical study.

27. The forum of claim 26, further comprising one or more web pages that provide information describing clinical studies to potential clinical study subjects and permit potential clinical study subjects to register for inclusion in the subject database.

28. The forum of claim 26 or 27, wherein privacy is protected by denying sponsors access to identifying information stored in the subject database.

29. The forum of claim 28, wherein the identifying information is provided to the qualified investigators for potential subjects in a clinical study.

30. The forum of claim 26 or 27, wherein a web server is used for identifying potential subjects for clinical studies.

31. The forum of claim 26 or 27, wherein a web server is used for identifying qualified investigators for clinical studies.

32. The forum of claim 26 or 27 further including a therapeutic incidence area database.

33. The forum of claim of 27 wherein the extranet and the one or more web pages are accessed using different URLs.

34. The forum of claim 26 further comprising a website coupled to the extranet that includes content available online for training clinical study investigators.

35. The forum of claim 27 further comprising a website coupled to the extranet that includes content available from online for training clinical study investigators.

36. The forum of claim 26 further comprising a link from the subject database to an electronic data capture company.

37. The forum of claim 27 further comprising a link from the subject database to an electronic data capture company.

38. The forum of claim 26 or 27 further comprising a link to the subject database from an electronic medical records company.

39. The forum of claim 26 or 27 further comprising a study listing database.

40. A method for identifying a qualified investigator to perform a clinical study, comprising the steps of:
(a) accessing a computer database that stores a geographic location of each of a plurality of investigators; wherein the database also stores an incidence or a prevalence of each of a plurality of disease conditions in each of a plurality of different geographic locations;
(b) submitting a query to the database, wherein the query includes information representing a selected disease condition associated with the clinical study; and
wherein the qualified investigator is identified from the database based on the query and in accordance with the incidence or prevalence of the selected disease condition in the geographic location of the qualified investigator.

41. A method for identifying a qualified investigator to perform a clinical study, comprising the steps of:
(a) accessing a computer database that stores a geographic location of each of a plurality of investigators; wherein the database also stores a geographic location of subjects for the study;
(b) submitting a query to the database, wherein the query includes information representing a selected disease condition associated with the clinical study; and wherein the qualified investigator is identified from the database based on the query and in accordance with the geographic location of subjects for the study.

42. The method of claim 41 wherein the database also stores an incidence or a prevalence of each of a plurality of disease conditions in each of a plurality of different geographic locations; and wherein the qualified investigator is identified from the database also based on the incidence or prevalence of the selected disease condition in the geographic location of the qualified investigator.

43. A method for identifying investigators qualified to perform a clinical study, comprising the steps of:
(a) accessing a computer database that stores information on a plurality of investigators;
wherein a data record is stored for each investigator listed in the database and includes information corresponding to the prescription writing history of the investigator with respect to a plurality of medications; and
wherein the database also stores information that associates each of the medications with one or more disease conditions;
(b) submitting a query to the database, wherein the query includes information representing a selected disease condition associated with the study; and
wherein a given investigator is identified from the database based on the query and in accordance with the given investigator's prescription writing history.

44. The method of claim 43 wherein the prescription writing history of the investigator is provided by the investigator to the database.

45. The method of claim 43 wherein the prescription writing history of the investigator is provided by a party other than the investigator to the data.

46. A method for identifying investigators qualified to perform a clinical study, comprising the steps of:
(a) accessing a computer database that stores information on a plurality of investigators;
wherein a data record is stored for each investigator listed in the database and includes information corresponding to a history of laboratory procedure requests made by the investigator; and
wherein the database also stores information that associates each of the historical laboratory procedure requests with one or more disease conditions;
(b) submitting a query to the database, wherein the query includes information representing a selected disease condition associated with the study; and wherein a given investigator is identified from the database based on the query and in accordance with the given investigator's historical laboratory request information.

47. The method of claim 46 wherein the investigator's historical laboratory procedure results are provided by the investigator to the database.

48. The method of claim 46 wherein the investigator's historical laboratory procedure results are provided by a party other the investigator to the database.

49. A method for identifying investigators qualified to perform a clinical study, comprising the steps of:
(a) accessing a computer database that stores information on a plurality of investigators;
wherein a data record is stored for each investigator listed in the database and includes information corresponding to past participation of the investigator in clinical studies;
(b) submitting a query to the database, wherein the query includes criteria corresponding to past clinical study experience suitable to qualify investigators for participating in a clinical study; and
(c) identifying qualified investigators from the database based on the query.

50. Th method of claim 49 wherein the past participation of the investigator' is provided by the investigator to the database.

51. The method of claim 49 wherein the past participation of the investigator is provided by a party other the investigator to the database.

52. A method for identifying investigators qualified to perform a clinical study, comprising the steps of.
(a) accessing a computer database that stores information on a plurality of investigators;
wherein a data record is stored for each investigator listed in the database and includes information corresponding to a medical specialty of the investigator; and
wherein the database also stores information that associates the medical specialty with one or more disease conditions;
(b) submitting a query to the database, wherein the query includes information representing a selected disease condition associated with the study; and
wherein a qualified investigator is identified from the database based on the query and in accordance with the given investigator's medical specialty.

53. The method of claim 52 wherein the investigator's medical specialty information is provided by the investigator to the database.

54. The method of claim 52 wherein the investigator's medical specialty is provided by a party other the investigator to the database.

55. A method for identifying investigators qualified to perform a clinical study, comprising the steps of:
(a) accessing a computer database that stores information on a plurality of investigators;
wherein a data record is stored for each investigator listed in the database and includes information corresponding to experience of a medical staff of the investigator; and
(b) submitting a query to the database, wherein the query includes information representing a selected disease condition associated with the study; and
wherein a qualified investigator is identified from the database based on the query and in accordance with the experience of the medical staff of the qualified investigator's medical specialty.

56. The method of claim 55 wherein the information regarding experience of the investigator's medical staff information is provided by the investigator to the database.

57. The method of claim 55 wherein the information regarding experience of the investigator's medical staff information is provided by a party other the investigator to the database.

58. A method for identifying investigators qualified to perform a clinical study, comprising the steps of:
(a) accessing a computer database that stores information on a plurality of investigators;
wherein a data record is stored for each investigator listed in the database and includes information corresponding to how many clinical studies have been performed by the investigator;
(b) submitting a query to the database, wherein the query includes information representing a selected disease condition associated with the study; and
wherein a qualified investigator is identified from the database based on the query and in accordance with how many clinical studies have been performed by the qualified investigator.

59. The method of claim 58 wherein the information corresponding to how many clinical studies have been performed by the investigator is provided by the investigator to the database.

60. The method of claim 59 wherein the information corresponding to how many clinical studies have been performed by the investigator is provided by a party other the investigator to the database.

61. A method for identifying investigators qualified to perform a clinical study, comprising the steps of:
(a) accessing a computer database that stores information on a plurality of investigators;
wherein a data record is stored for each investigator listed in the database and includes information corresponding to hospital affiliations of the investigator; and
(b) submitting a query to the database, wherein the query includes information representing a selected disease condition associated with the study; and
wherein a qualified investigator is identified from the database based on the query and in accordance with the qualified investigator's hospital affiliations.

62. The method of claim 61 wherein the investigator's hospital affiliations information is provided by the investigator to the database.

63. The method of claim 61 wherein the investigator's hospital affiliations is provided by a party other the investigator to the database.

64. A method for identifying investigators qualified to perform a clinical study, comprising the steps of:
(a) accessing a computer database that stores information on a plurality of investigators;
wherein a data record is stored for each investigator listed in the database and includes information corresponding to a number of beds in hospital affiliations of the investigator; and
(b) submitting a query to the database, wherein the query includes information representing a selected disease condition associated with the study; and
wherein a qualified investigator is identified from the database based on the query and in accordance with the number of beds in hospital affiliation of the qualified investigator.

65. The method of claim 64 wherein the number of beds in hospital affiliations of the investigator is provided by the investigator to the database.

66. The method of claim 64 wherein the number of beds in hospital affiliations of the investigator is provided by a party other the investigator to the database.

67. A method for identifying investigators qualified to perform a clinical study, comprising the steps of:
(a) accessing a computer database that stores information on a plurality of investigators;
wherein a data record is stored for each investigator listed in the database and includes information corresponding to insurance provider affiliations of the investigator; and
(b) submitting a query to the database, wherein the query includes information representing a selected disease condition associated with the study; and
wherein a qualified investigator is identified from the database based on the query and in accordance with the insurance provider affiliations of the qualified investigator.

68. The method of claim 67 wherein the insurance provider affiliations of the investigator is provided by the investigator to the database.

69. The method of claim 67 wherein the insurance provider affiliations of the investigator is provided by a party other the investigator to the database.

70. A method for identifying investigators qualified to perform a clinical study, comprising the steps of:
(a) accessing a computer database that stores information on a plurality of investigators;
wherein a data record is stored for each investigator listed in the database and includes information corresponding to mandated IRB relationships of the investigator; and
wherein the database also stores information that associates the mandated IRB relationships with one or more disease conditions;
(b) submitting a query to the database, wherein the query includes information representing a selected disease condition associated with the study; and
wherein a qualified investigator is identified from the database based on the query and in accordance with the mandated IRB relationships of qualified investigator.

71. The method of claim 70 wherein the mandated IRB relationships of the investigator is provided by the investigator to the database.

72. The method of claim 70 wherein the mandated IRB relationship of the investigator is provided by a party other the investigator to the database.

73. A method for identifying investigators qualified to perform a clinical study, comprising the steps of:
(a) accessing a computer database that stores information on a plurality of investigators;
wherein a data record is stored for each investigator listed in the database and includes information corresponding to regulatory agency audits of the investigator; and
(b) submitting a query to the database, wherein the query includes information representing a selected disease condition associated with the study; and wherein a qualified investigator is identified from the database based on the query and in accordance with the regulatory agency audits information of the qualified investigator.

74. The method of claim 73 wherein the information corresponding to regulatory agency audits of the investigator is provided by the investigator to the database.

75. The method of claim 73 wherein the information corresponding to regulatory agency audits of the investigator is provided by a party other the investigator to the database.

76. A method for identifying investigators qualified to perform a clinical study, comprising the steps of:
(a) accessing a computer database that stores information on a plurality of investigators;
wherein a data record is stored for each investigator listed in the database and includes information corresponding to PRF affiliations of the investigator; and
wherein the database also stores information that associates the PRF affiliations with one or more disease conditions;
(b) submitting a query to the database, wherein the query includes information representing a selected disease condition associated with the study; and
wherein a qualified investigator is identified from the database based on the query and in accordance with the qualified investigator's PRF affiliations.

77. The method of claim 76 wherein the investigator's PRF affiliations information is provided by the investigator to the database.

78. The method of claim 76 wherein the investigator's PRF affiliation information is provided by a party other the investigator to the database.

79. A method for identifying investigators qualified to perform a clinical study, comprising the steps of:
(a) accessing a computer database that stores information on a plurality of investigators;
wherein a data record is stored for each investigator listed in the database and includes information corresponding to equipment of the investigator; and
wherein the database also stores information that associates the equipment of the investigator with one or more disease conditions;
(b) submitting a query to the database, wherein the query includes information representing a selected disease condition associated with the study; and
wherein a qualified investigator is identified from the database based on the query and in accordance with the equipment of the qualified investigator.

80. The method of claim 79 wherein the investigator's equipment information is provided by the investigator to the database.

81. The method of claim 79 wherein the investigator's equipment information is provided by a party other the investigator to the database.

82. A method for identifying investigators qualified to perform a clinical study, comprising the steps of:
(a) accessing a computer database that stores information on a plurality of investigators;
wherein a data record is stored for each investigator listed in the database and includes information corresponding to the investigator's practice setting; and
(b) submitting a query to the database, wherein the query includes information representing a selected disease condition associated with the study; and
wherein a qualified investigator is identified from the database based on the query and in accordance with the qualified investigator's practice setting.

83. The method of claim 82 wherein the investigator's practice setting information is provided by the investigator to the database.

84. A method for identifying investigators qualified to perform a clinical study, comprising the steps of:
(a) accessing a computer database that stores information on a plurality of investigators;
wherein a data record is stored for each investigator listed in the database and includes information corresponding to the investigator's city and state of practice; and
wherein the database also stores information that associates the investigator's city and state of practice information with one or more disease conditions;
(b) submitting a query to the database, wherein the query includes information representing a selected disease condition associated with the study; and
wherein a qualified investigator is identified from the database based on the query and in accordance with the qualified investigator's city and state of practice information.

85. The method of claim 84 wherein the investigator's city and state of practice information is provided by the investigator to the database.

86. A method for identifying investigators qualified to perform a clinical study, comprising the steps of:
(a) accessing a computer database that stores information on a plurality of investigators;
wherein a data record is stored for each investigator listed in the database and includes information corresponding to the investigator's name;
(b) submitting a query to the database, wherein the query includes information representing a selected disease condition associated with the study; and
wherein a qualified investigator is identified from the database based on the query and in accordance with the qualified investigator's name.

87. The method of claim 86 wherein the investigator's medical specialty information is provided by the investigator to the database.

88. The method of claims 43, 44, or 45 wherein the query further includes search criteria selected from the group consisting of, information corresponding to a history of laboratory requests made by the investigator, information corresponding to past participation of the investigator in clinical studies, information corresponding to the medical specialty of the investigator, information corresponding to experience of a medical staff of the investigator, information corresponding to how many clinical studies have been performed by the investigator, information corresponding to hospital affiliations of the investigator, information corresponding to insurance provider affiliations of the investigator, information corresponding to mandated IRB relationships of the investigator, information corresponding to regulatory agency audits of the investigator, information corresponding to PRF affiliations of the investigator, information corresponding to equipment of the investigator, information corresponding to the investigator's practice setting, information corresponding to the investigator's city and state of practice, investigator information corresponding to services performed at the investigator hospital affiliates, information corresponding to investigator laboratory results, information corresponding to the geographic location of subjects of the investigators, information corresponding to the incidence or prevalence of each of a plurality of disease conditions in each of a plurality of types at geographic locations, and information corresponding to claims and information corresponding to the investigator's name.

89. The method of claims 46, 47, or 48 wherein the query further includes search criteria selected from the group consisting of the prescription writing history of the investigator with respect to a plurality of medications, information corresponding to past participation of the investigator in clinical studies, information corresponding to the medical specialty of the investigator, information corresponding to experience of a medical staff of the investigator, information corresponding to how many clinical studies have been performed by the investigator, information corresponding to hospital affiliations of the investigator, information corresponding to insurance provider affiliations of the investigator, information corresponding to mandated IRB relationships of the investigator, information corresponding to regulatory agency audits of the investigator, information corresponding to PRF affiliations of the investigator, information corresponding to equipment of the investigator, information corresponding to the investigator's practice setting, information corresponding to the investigator's city and state of practice, investigator information corresponding to services performed at the investigator hospital affiliates, information corresponding to investigator laboratory results, information corresponding to the geographic location of subjects of the investigators, information corresponding to the incidence or prevalence of each of a plurality of disease conditions in each of a plurality of types at geographic locations, and information corresponding to claims and information corresponding to the investigator's name.

90. The method of claims 49, 50, or 51 wherein the query further includes search criteria selected from the group consisting of the prescription writing history of the investigator with respect to a plurality of medications, information corresponding to a history of laboratory requests made by the investigator, information corresponding to the medical specialty of the investigator, information corresponding to experience of a medical staff of the investigator, information corresponding to how many clinical studies have been performed by the investigator, information corresponding to hospital affiliations of the investigator, information corresponding to insurance provider affiliations of the investigator, information corresponding to mandated IRB relationships of the investigator, information corresponding to regulatory agency audits of the investigator, information corresponding to PRF affiliations of the investigator, information corresponding to equipment of the investigator, information corresponding to the investigator's practice setting, information corresponding to the investigator's city and state of practice, investigator information corresponding to services performed at the investigator hospital affiliates, information corresponding to investigator laboratory results, information corresponding to the geographic location of subjects of the investigators, information corresponding to the incidence or prevalence of each of a plurality of disease conditions in each of a plurality of types at geographic locations, and information corresponding to claims and information corresponding to the investigator's name.

91. The method of claims 52, 53, or 54 wherein the query further includes search criteria selected from the group consisting of the prescription writing history of the investigator with respect to a plurality of medications, information corresponding to a history of laboratory requests made by the investigator, information corresponding to past participation of the investigator in clinical studies, information corresponding to experience of a medical staff of the investigator, information corresponding to how many clinical studies have been performed by the investigator, information corresponding to hospital affiliations of the investigator, information corresponding to insurance provider affiliations of the investigator, information corresponding to mandated IRB relationships of the investigator, information corresponding to regulatory agency audits of the investigator, information corresponding to PRF affiliations of the investigator, information corresponding to equipment of the investigator, information corresponding to the investigator's practice setting, information corresponding to the investigator's city and state of practice, investigator information corresponding to services performed at the investigator hospital affiliates, information corresponding to investigator laboratory results, information corresponding to the geographic location of subjects of the investigators, information corresponding to the incidence or prevalence of each of a plurality of disease conditions in each of a plurality of types at geographic locations, and information corresponding to claims and information corresponding to the investigator's name.

92. The method of claims 55, 56, or 57 wherein the query further includes search criteria selected from the group consisting of the prescription writing history of the investigator with respect to a plurality of medications, information corresponding to a history of laboratory requests made by the investigator, information corresponding to past participation of the investigator in clinical studies, information corresponding to experience of a medical staff of the investigator, information corresponding to how many clinical studies have been performed by the investigator, information corresponding to hospital affiliations of the investigator, information corresponding to insurance provider affiliations of the investigator, information corresponding to mandated IRB relationships of the investigator, information corresponding to regulatory agency audits of the investigator, information corresponding to PRF affiliations of the investigator, information corresponding to equipment of the investigator, information corresponding to the investigator's practice setting, information corresponding to the investigator's city and state of practice, investigator information corresponding to services performed at the investigator hospital affiliates, information corresponding to investigator laboratory results, information corresponding to the geographic location of subjects of the investigators, information corresponding to the incidence or prevalence of each of a plurality of disease conditions in each of a plurality of types at geographic locations, and information corresponding to claims and information corresponding to the investigator's name.

93. The method of claims 58, 59, or 60 wherein the query further includes search criteria selected from the group consisting of the prescription writing history of the investigator with respect to a plurality of medications, information corresponding to a history of laboratory requests made by the investigator, information corresponding to past participation of the investigator in clinical studies, information corresponding to experience of a medical staff of the investigator, information corresponding to experience of a medical staff of the investigator, information corresponding to hospital affiliations of the investigator, information corresponding to insurance provider affiliations of the investigator, information corresponding to mandated IRB relationships of the investigator, information corresponding to regulatory agency audits of the investigator, information corresponding to PRF affiliations of the investigator, information corresponding to equipment of the investigator, information corresponding to the investigator's practice setting, information corresponding to the investigator's city and state of practice, investigator information corresponding to services performed at the investigator hospital affiliates, information corresponding to investigator laboratory results, information corresponding to the geographic location of subjects of the investigators, information corresponding to the incidence or prevalence of each of a plurality of disease conditions in each of a plurality of types at geographic locations, and information corresponding to claims and information corresponding to the investigator's name.

94. The method of claims 61, 62, or 63 wherein the query further includes search criteria selected from the group consisting of the prescription writing history of the investigator with respect to a plurality of medications, information corresponding to a history of laboratory requests made by the investigator, information corresponding to past participation of the investigator in clinical studies, information corresponding to experience of a medical staff of the investigator, information corresponding to experience of a medical staff of the investigator, information corresponding to how many clinical studies have been performed by the investigator, information corresponding to insurance provider affiliations of the investigator, information corresponding to mandated IRB relationships of the investigator, information corresponding to regulatory agency audits of the investigator, information corresponding to PRF affiliations of the investigator, information corresponding to equipment of the investigator, information corresponding to the investigator's practice setting, information corresponding to the investigator's city and state of practice, investigator information corresponding to services performed at the investigator hospital affiliates, information corresponding to investigator laboratory results, information corresponding to the geographic location of subjects of the investigators, information corresponding to the incidence or prevalence of each of a plurality of disease conditions in each of a plurality of types at geographic locations, and information corresponding to claims and information corresponding to the investigator's name.

95. The method of claims 64, 65, or 66 wherein the query further includes search criteria selected from the group consisting of the prescription writing history of the investigator with respect to a plurality of medications, information corresponding to a history of laboratory requests made by the investigator, information corresponding to past participation of the investigator in clinical studies, information corresponding to experience of a medical staff of the investigator, information corresponding to experience of a medical staff of the investigator, information corresponding to how many clinical studies have been performed by the investigator, information corresponding to hospital affiliations of the investigator, information corresponding to insurance provider affiliations of the investigator, information corresponding to mandated IRB relationships of the investigator, information corresponding to regulatory agency audits of the investigator, information corresponding to PRF affiliations of the investigator, information corresponding to equipment of the investigator, information corresponding to the investigator's practice setting, information corresponding to the investigator's city and state of practice, investigator information corresponding to services performed at the investigator hospital affiliates, information corresponding to investigator laboratory results, information corresponding to the geographic location of subjects of the investigators, information corresponding to the incidence or prevalence of each of a plurality of disease conditions in each of a plurality of types at geographic locations, and information corresponding to claims and information corresponding to the investigator's name.

96. The method of claims 67, 68, or 69 wherein the query further includes search criteria selected from the group consisting of the prescription writing history of the investigator with respect to a plurality of medications, information corresponding to a history of laboratory requests made by the investigator, information corresponding to past participation of the investigator in clinical studies, information corresponding to experience of a medical staff of the investigator, information corresponding to experience of a medical staff of the investigator, information corresponding to how many clinical studies have been performed by the investigator, information corresponding to hospital affiliations of the investigator, information corresponding to mandated IRB relationships of the investigator, information corresponding to regulatory agency audits of the investigator, information corresponding to PRF affiliations of the investigator, information corresponding to equipment of the investigator, information corresponding to the investigator's practice setting, information corresponding to the investigator's city and state of practice, investigator information corresponding to services performed at the investigator hospital affiliates, information corresponding to investigator laboratory results, information corresponding to the geographic location of subjects of the investigators, information corresponding to the incidence or prevalence of each of a plurality of disease conditions in each of a plurality of types at geographic locations, and information corresponding to claims and information corresponding to the investigator's name.

97. The method of claims 70, 71, or 72 wherein the query further includes search criteria selected from the group consisting of the prescription writing history of the investigator with respect to a plurality of medications, information corresponding to a history of laboratory requests made by the investigator, information corresponding to past participation of the investigator in clinical studies, information corresponding to experience of a medical staff of the investigator, information corresponding to experience of a medical staff of the investigator, information corresponding to how many clinical studies have been performed by the investigator, information corresponding to hospital affiliations of the investigator, information corresponding to insurance provider affiliations of the investigator, information corresponding to regulatory agency audits of the investigator, information corresponding to PRF affiliations of the investigator, information corresponding to equipment of the investigator, information corresponding to the investigator's practice setting, information corresponding to the investigator's city and state of practice, investigator information corresponding to services performed at the investigator hospital affiliates, information corresponding to investigator laboratory results, information corresponding to the geographic location of subjects of the investigators, information corresponding to the incidence or prevalence of each of a plurality of disease conditions in each of a plurality of types at geographic locations, and information corresponding to claims and information corresponding to the investigator's name.

98. The method of claims 73, 74, or 75 wherein the query further includes search criteria selected from the group consisting of the prescription writing history of the investigator with respect to a plurality of medications, information corresponding to a history of laboratory requests made by the investigator, information corresponding to past participation of the investigator in clinical studies, information corresponding to experience of a medical staff of the investigator, information corresponding to experience of a medical staff of the investigator, information corresponding to how many clinical studies have been performed by the investigator, information corresponding to hospital affiliations of the investigator, information corresponding to insurance provider affiliations of the investigator, information corresponding to mandated IRB relationships of the investigator, information corresponding to PRF affiliations of the investigator, information corresponding to equipment of the investigator, information corresponding to the investigator's practice setting, information corresponding to the investigator's city and state of practice, investigator information corresponding to services performed at the investigator hospital affiliates, information corresponding to investigator laboratory results, information corresponding to the geographic location of subjects of the investigators, information corresponding to the incidence or prevalence of each of a plurality of disease conditions in each of a plurality of types at geographic locations, and information corresponding to claims and information corresponding to the investigator's name.

99. The method of claims 76, 77, or 78 wherein the query further includes search criteria selected from the group consisting of the prescription writing history of the investigator with respect to a plurality of medications, information corresponding to a history of laboratory requests made by the investigator, information corresponding to past participation of the investigator in clinical studies, information corresponding to experience of a medical staff of the investigator, information corresponding to experience of a medical staff of the investigator, information corresponding to how many clinical studies have been performed by the investigator, information corresponding to hospital affiliations of the investigator, information corresponding to insurance provider affiliations of the investigator, information corresponding to mandated IRB relationships of the investigator, information corresponding to regulatory agency audits of the investigator, information corresponding to equipment of the investigator, information corresponding to the investigator's practice setting, information corresponding to the investigator's city and state of practice, investigator information corresponding to services performed at the investigator hospital affiliates, information corresponding to investigator laboratory results, information corresponding to the geographic location of subjects of the investigators, information corresponding to the incidence or prevalence of each of a plurality of disease conditions in each of a plurality of types at geographic locations, and information corresponding to claims and information corresponding to the investigator's name.

100. The method of claims 79, 80, or 81 wherein the query further includes search criteria selected from the group consisting of the prescription writing history of the investigator with respect to a plurality of medications, information corresponding to a history of laboratory requests made by the investigator, information corresponding to past participation of the investigator in clinical studies, information corresponding to experience of a medical staff of the investigator, information corresponding to experience of a medical staff of the investigator, information corresponding to how many clinical studies have been performed by the investigator, information corresponding to hospital affiliations of the investigator, information corresponding to insurance provider affiliations of the investigator, information corresponding to mandated IRB relationships of the investigator, information corresponding to regulatory agency audits of the investigator, information corresponding to PRF affiliations of the investigator, information corresponding to the investigator's practice setting, information corresponding to the investigator's city and state of practice, investigator information corresponding to services performed at the investigator hospital affiliates, information corresponding to investigator laboratory results, information corresponding to the geographic location of subjects of the investigators, information corresponding to the incidence or prevalence of each of a plurality of disease conditions in each of a plurality of types at geographic locations, and information corresponding to claims and information corresponding to the investigator's name.

101. The method of claims 82 or 83 wherein the query further includes search criteria selected from the group consisting of the prescription writing history of the investigator with respect to a plurality of medications, information corresponding to a history of laboratory requests made by the investigator, information corresponding to past participation of the investigator in clinical studies, information corresponding to experience of a medical staff of the investigator, information corresponding to experience of a medical staff of the investigator, information corresponding to how many clinical studies have been performed by the investigator, information corresponding to hospital affiliations of the investigator, information corresponding to insurance provider affiliations of the investigator, information corresponding to mandated IRB relationships of the investigator, information corresponding to regulatory agency audits of the investigator, information corresponding to PRF affiliations of the investigator, information corresponding to equipment of the investigator, information corresponding to the investigator's city and state of practice, investigator information corresponding to services performed at the investigator hospital affiliates, information corresponding to investigator laboratory results, information corresponding to the geographic location of subjects of the investigators, information corresponding to the incidence or prevalence of each of a plurality of disease conditions in each of a plurality of types at geographic locations, and information corresponding to claims and information corresponding to the investigator's name.

102. The method of claims 84 or 85 wherein the query further includes search criteria selected from the group consisting of the prescription writing history of the investigator with respect to a plurality of medications, information corresponding to a history of laboratory requests made by the investigator, information corresponding to past participation of the investigator in clinical studies, information corresponding to experience of a medical staff of the investigator, information corresponding to experience of a medical staff of the investigator, information corresponding to how many clinical studies have been performed by the investigator, information corresponding to hospital affiliations of the investigator, information corresponding to insurance provider affiliations of the investigator, information corresponding to mandated IRB relationships of the investigator, information corresponding to regulatory agency audits of the investigator, information corresponding to PRF affiliations of the investigator, information corresponding to equipment of the investigator, information corresponding to the investigator's practice setting, investigator information corresponding to services performed at the investigator hospital affiliates, information corresponding to investigator laboratory results, information corresponding to the geographic location of subjects of the investigators, information corresponding to the incidence or prevalence of each of a plurality of disease conditions in each of a plurality of types at geographic locations, and information corresponding to claims and information corresponding to the investigator's name.

103. The method of claims 86 or 87 wherein the query further includes search criteria selected from the group consisting of the prescription writing history of the investigator with respect to a plurality of medications, information corresponding to a history of laboratory requests made by the investigator, information corresponding to past participation of the investigator in clinical studies, information corresponding to experience of a medical staff of the investigator, information corresponding to experience of a medical staff of the investigator, information corresponding to how many clinical studies have been performed by the investigator, information corresponding to hospital affiliations of the investigator, information corresponding to insurance provider affiliations of the investigator, information corresponding to mandated IRB relationships of the investigator, information corresponding to regulatory agency audits of the investigator, information corresponding to PRF affiliations of the investigator, information corresponding to equipment of the investigator, information corresponding to the investigator's practice setting, investigator information corresponding to services performed at the investigator hospital affiliates, information corresponding to investigator laboratory results, information corresponding to the geographic location of subjects of the investigators, information corresponding to the incidence or prevalence of each of a plurality of disease conditions in each of a plurality of types at geographic locations, and information corresponding to claims and information corresponding to the investigator's city and state of practice.

104. A method for developing a permission based online database, comprising the steps of:
(a) presenting one or more web pages that allow a person to register with a database by submitting registration information to the database, wherein the registration information includes name information and contact information and permission information indicating whether the person wishes to receive notice of one or more clinical studies;
(b) automatically registering the person with the database upon receipt of the registration and permission information;
(c) obtaining permission from the person to send information regarding drugs, medical devices or medical therapies;
(d) building the database by repeating steps (a) through (c); and
(e) generating a list for use in marketing drugs, medical devices and medical therapies to persons by querying the database using criteria associated with the drugs, medical devices or medical therapies.

105. The method of claim 104, further comprising the steps of:
(f) automatically determining, in accordance with the registration and permission information, whether to provide the person with notice of a clinical study associated with a disease condition of interest to the person;
(g) automatically presenting a questionnaire associated with the given clinical study to the person; and
(h) storing answers submitted by the person in the database.

106. The method of claim 104, further comprising the step of sending information to persons on the list regarding a drug, medical device and medical therapy.

107. A method of maintaining the confidentiality of clinical study information associated with each of a plurality of clinical study sponsors, comprising the steps of:
(a) receiving said clinical study information from said plurality of clinical study sponsors; and
(b) storing said clinical study information in a database;
wherein each sponsor is permitted full access to said clinical study information submitted by that sponsor and only aggregated access to information submitted by other sponsors.

108. The method of claim 107 wherein said clinical study information comprises at least one of investigator information, sponsor identification, protocol information, drug indication information, drug class information, clinical study enrollment goal information, actual clinical study enrollment information, and clinically evaluable subjects information.

109. The method of claim 108 wherein each sponsor is denied access to said protocol information, said drug class information and said sponsor identification information of other sponsors.

110. A method for ranking a clinical investigator, comprising the steps of:
(a) selecting at least two ranking criteria from the group consisting of investigator experience, professional certification, scientific leadership, regulatory audits and study coordinator experience; and
(b) determining the ranking for the clinical investigator by generating a composite ranking score from the at least two ranking criteria.

111. A method for identifying investigators qualified to perform a clinical study, comprising the steps of:
(a) accessing a computer database that stores information on a plurality of investigators;
wherein a data record is stored for each investigator listed in the database and includes information corresponding to a history of laboratory results of the investigator; and
wherein the database also stores information that associates each of the laboratory results with one or more disease conditions;
(b) submitting a query to the database, wherein the query includes information representing a selected disease condition associated with the study; and wherein a given investigator is identified from the database based on the query and in accordance with the given investigator's historical laboratory results information.

112. The method of claim 111 wherein the history of laboratory results of the investigator is provided by the investigator to the database.

113. The method of claim 111 wherein the history of laboratory results of the investigator is provided by a party other than the investigator to the database.

114. A method for identifying investigators qualified to perform a clinical study, comprising the steps of:
(a) accessing a computer database that stores information on a plurality of investigators;
wherein a data record is stored for each investigator listed in the database and includes information corresponding to services performed in hospital affiliations of the investigator; and
wherein the database also stores information that associates the services performed in hospital affiliations with one or more disease conditions;
(b) submitting a query to the database, wherein the query includes information representing a selected disease condition associated with the study; and
wherein a qualified investigator is identified from the database based on the query and in accordance with the services performed in hospital affiliations of the qualified investigator.

115. The method of claim 114 wherein the services performed in hospital affiliations of the investigator is provided by the investigator to the database.

116. The method of claim 114 wherein the services performed in hospital affiliations of the investigator is provided by a party other than the investigator to the database.

117. A method for identifying investigators qualified to perform a clinical study, comprising the steps of:
(a) accessing a computer database that stores information on a plurality of investigators;
wherein a data record is stored for each investigator listed in the database and includes information corresponding to claims information of the investigator; and
wherein the database also stores information that associates the claims information with one or more disease conditions;
(b) submitting a query to the database, wherein the query includes information representing a selected disease condition associated with the study; and
wherein a qualified investigator is identified from the database based on the query and in accordance with the claims information.

118. The method of claim 117 wherein the claims information of the investigator is provided by the investigator to the database.

119. The method of claim 117 wherein the claims information of the investigator is provided by a party other than the investigator to the database.

120. The method of claim 107 wherein the aggregated access provides a lesser degree of detail of said information.
